(19) United States
(12) Patent Application Publication
(10) Pub. No.: US 2010/0191552 A1
(43) Pub. Date: Jul. 29, 2010

(54) APPARATUS, METHOD AND ARTICLE TO FACILITATE PROPAGATION OF CURRENT APPOINTMENT AVAILABILITY IN A NETWORK ENVIRONMENT

(76) Inventors: Patrick Behrens, Seattle, WA (US); Christa Korol, Seattle, WA (US); William Lange, Seattle, WA (US); Greg Lauckhart, Seattle, WA (US)

Correspondence Address: SEED INTELLECTUAL PROPERTY LAW GROUP PLLC, 701 FIFTH AVE, SUITE 5400, SEATTLE, WA, 98104, US

(21) Appl. No.: 12/691,614

(22) Filed: Jan. 21, 2010

Related U.S. Application Data
(60) Provisional application No. 61/147,679, filed on Jan. 27, 2009.

(51) Int. Cl. G06Q 10/00; G06F 15/173; G06Q 30/00; G06F 17/30

(52) U.S. Cl. 705/5; 709/223; 705/14.58; 705/7; 707/705; 707/E17.014

(57) ABSTRACT

This disclosure generally relates to networked computing environments, and particularly to propagating current appointment availability of service providers to potential or existing clients of the service providers in a network environment. In some cases, currently available appointment availability of one or more service providers are provided in a manner that includes computer executable instructions that allow potential or existing clients to book one or more of the propagated appointments that are currently available.

### CROSS REFERENCE TO RELATED APPLICATIONS

This application claims benefit under 35 U.S.C. 119(e) of U.S. Provisional Patent Application Ser. No. 61/147,679, filed Jan. 27, 2009 and entitled “APPARATUS, METHOD AND ARTICLE TO FACILITATE PROPAGATION OF CURRENT APPOINTMENT AVAILABILITY IN A NETWORK ENVIRONMENT,” which is incorporated herein by reference in its entirety.

### BACKGROUND

1. Field

This disclosure generally relates to networked computing environments.

2. Description of the Related Art

Networked systems are ubiquitous and allow a variety of devices to communicatively exchange information. For example, traditional computing networks such as local area networks (LANs) or wide area networks (WANs), allow computing systems to exchange information, such as files and other data. Such computing networks include extranets, intranets, and/or the Internet or Worldwide Web (“the Web”). Traditional telecommunications networks allow various telecommunications devices (e.g., phones) to communicate via wired telephone networks or cellular networks.

Increasingly, various types of devices have the ability to communicate over multiple networks or to access information from other types of devices. For instance, cellular phones are often Internet or Web enabled, allowing such cellular phones to communicate via the Internet and or the Web. Many devices commonly referred to as personal digital assistances (e.g., iPHONE®, TREO®, BLACKBERRY®) are likewise Internet or Web enabled. Many of these devices may also communicate via other protocols, for instance wirelessly via the IEEE 802.11 protocol or BLUETOOTH® protocol. In addition, many television-based systems are network enabled, including set-top boxes, personal/digital video recorders, and interactive televisions.

Many people and businesses have come to rely on networks to exchange information and conduct business. For example, the Web has been populated with millions of Web sites that provide information about a virtually unlimited number of topics. In addition, many Web sites offer various types of online tools and services such as online office tools (e.g., word processors, spreadsheets), online calendars, online social planning services, etc.

As more and more people and business have come to rely on networks, networks have become a common medium for advertising. One of the more prevalent forms of network-based advertising is online advertising, which uses the Internet to transmit advertisements (ads) to potential customers. Common forms of online advertising include electronic advertisements provided via Web sites (e.g., banner ads, button ads, skyscraper ads, interstitial ads, pop-up ads, pop-under ads, rich media ads, embedded applications, and various others), Web feeds, email, and various ad-supported software, etc. Online advertising is often supported by the use of ad servers, which are computing systems that serve advertisements to various customers (e.g., via Web site, Web feeds, email, instant message, and so on), with the advertisements usually stored in one or more advertising inventories prior to serving (e.g., computer-readable media storage with various electronic advertisements). Mobile-based advertising techniques have also developed, such as to sent advertisements to telecommunication devices, for instance via Short Message Service (“SMS”) messages and Multimedia Messaging Service (“MMS”) messages.

### BRIEF SUMMARY

A method of operating at least one computing system in a networked computing environment including client computing systems and server computing systems may be summarized as including determining by at least one processor at least one locality characteristic for an intended recipient of a stored electronic file, each of the at least one locality characteristic indicative of a respective possible geographic location of the intended recipient; determining by at least one processor at least one service provider that services a geographic area, the geographic area encompassing at least one respective geographic location indicated by the processor determined at least one locality characteristic; determining by at least one processor at least one appointment availability that is designated as currently available for the processor determined at least one service provider; and creating by at least one processor at least one electronic file element with appointment availability information that includes at least one appointment availability indication for the processor determined at least one service provider that is indicative of the processor determined at least one appointment availability for the processor determined at least one service provider.

A computer-readable medium may be summarized as containing instructions that when executed by a computer system cause the computer system to provide appointment availability, by: determining at least one locality characteristic for an intended recipient of a stored electronic file, each of the at least one locality characteristic indicative of a respective possible geographic location of the intended recipient; determining at least one service provider that services a geographic area, the geographic area encompassing at least one respective geographic location indicated by the at least one locality characteristic; determining at least one appointment availability that is designated as currently available for the at least one service provider; and creating at least one electronic file element with appointment availability information that includes at least one appointment availability indication for the at least one service provider that is indicative of the at least one appointment availability for the at least one service provider.

A computer system may be summarized as including at least one processor and at least one computer-readable storage memory communicatively coupled to the at least one processor, the at least one computer-readable storage memory storing processor executable instructions that cause the at least one processor to: determine at least one locality characteristic for an intended recipient of a stored electronic file, each of the at least one locality characteristic indicative of a respective possible geographic location of the intended recipient; determine at least one service provider that services a geographic area, the geographic area encompassing at least one respective geographic location indicated by the at least one locality characteristic; determine multiple appointment availabilities that are designated as currently available for the at least one service provider; and create at least one electronic file element with appointment availability information that includes at least one appointment availability indication for the at least one service provider that is indicative of at least one of the multiple appointment availabilities for the at least one service provider.

A method of operating at least one computing system in a networked computing environment including client computing systems and server computing systems may be summarized as including providing by at least one processor at least a portion of a set of processor executable instructions executable by a processor of an end user device to display a set of available appointment opportunities that have been determined to be currently available for a set of service providers that have been determined to be local to a current or prospective client of the service providers; receiving by at least one processor at least one indication of a respective selection of at least one of the appointment opportunities from at least one of the current or prospective clients of the service providers, the selection indicative of a request by the at least one current or prospective client to book the respective appointment opportunity with the service provider; and updating by at least one processor an electronic schedule of the service provider indicated by the selection of the request by the current or prospective client of the request by the current or prospective client to book the respective appointment opportunity, such that the respective appointment opportunity is booked for the client based on the updating by at least one processor an electronic schedule of the service provider.

A computer-readable medium may be summarized as containing instructions that when executed by a computer system cause the computer system to provide appointment availability, by: providing by at least one processor at least a portion of a set of processor executable instructions executable by a processor of an end user device to display a set of available appointment opportunities that have been determined to be currently available for a set of service providers that have been determined to be local to a current or prospective client of the service providers; receiving by at least one processor at least one indication of a respective selection of at least one of the appointment opportunities from at least one of the current or prospective clients of the service providers, the selection indicative of a request by the at least one current or prospective client for the respective appointment opportunity with the service provider; and updating by at least one processor an electronic schedule of the service provider indicated by the selection of the request by the current or prospective client of the request by the current or prospective client for the respective appointment opportunity.

A computer system may be summarized as including at least one processor and at least one computer-readable storage memory communicatively coupled to the at least one processor, the at least one computer-readable storage memory storing processor executable instructions that cause the at least one processor to: provide at least a portion of a set of processor executable instructions executable by a processor of an end user device to display a set of available appointment opportunities that have been determined to be currently available for a set of service providers that have been determined to be local to a current or prospective client of the service providers; receive at least one indication of a respective selection of at least one of the appointment opportunities from at least one of the current or prospective clients of the service providers, the selection indicative of a request by the at least one current or prospective client to book the respective appointment opportunity with the service provider; and updating the service provider indicated by the selection of the request by the current or prospective client of the request by the current or prospective client to book the respective appointment opportunity.

A method of operating at least one computing system in a networked computing environment including client computing systems and server computing systems may be summarized as including determining at least one optimizing factor that is indicative of an increased likelihood of a currently available appointment opportunity of a service provider to be booked; determining by at least one processor at least one locality characteristic for an intended recipient of a stored electronic file, each of the at least one locality characteristic indicative of a respective possible geographic location of the intended recipient; determining by at least one processor at least one preferred appointment opportunity from a set of multiple currently available appointment opportunities for services from at least one service provider based at least in part on the at least one determined optimizing factor and the determined at least one locality characteristic for the intended recipient; and providing by at least one processor at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

A computer-readable medium may be summarized as containing instructions that when executed by a computer system cause the computer system to provide appointment availability, by: determining at least one optimizing factor that is indicative of an increased likelihood of a currently available appointment opportunity of a service provider to be booked; determining by at least one processor at least one locality characteristic for an intended recipient of a stored electronic file, each of the at least one locality characteristic indicative of a respective possible geographic location of the intended recipient; determining by at least one processor at least one preferred appointment opportunity from a set of multiple currently available appointment opportunities for services from at least one service provider based at least in part on the at least one determined optimizing factor and the determined at least one locality characteristic for the intended recipient; and providing by at least one processor at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

A computer system may be summarized as including at least one processor and at least one computer-readable storage memory communicatively coupled to the at least one processor, the at least one computer-readable storage memory storing processor executable instructions that cause the at least one processor to: determine at least one optimizing factor that is indicative of an increased likelihood of a currently available appointment opportunity of a service provider to be booked; determine at least one locality characteristic for an intended recipient of a stored electronic file, each of the at least one locality characteristic indicative of a respective possible geographic location of the intended recipient; determine at least one preferred appointment opportunity from a set of multiple currently available appointment opportunities for services from at least one service provider based at least in part on the at least one determined optimizing factor and the determined at least one locality characteristic for the intended recipient; and provide at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

A method of operating at least one computing system in a networked computing environment including client computing systems and server computing systems may be summarized as including determining by at least one processor at least one locality characteristic for a user, each of the at least one locality characteristic indicative of a respective possible geographic location of the user; determining by at least one processor a plurality of service providers that service a geographic area, the geographic area encompassing at least one respective geographic location indicated by the processor determined at least one locality characteristic; determining by at least one processor a group of multiple distinct appointment opportunities by determining, for each of at least some of the plurality of service providers, at least one appointment opportunity that is currently available for booking by the user for at least one service of the service provider; and providing by at least one processor at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

A computer-readable medium may be summarized as containing instructions that when executed by a computer system cause the computer system to provide appointment availability, by: determining by at least one processor at least one locality characteristic for a user, each of the at least one locality characteristic indicative of a respective possible geographic location of the user; determining by at least one processor a plurality of service providers that service a geographic area, the geographic area encompassing at least one respective geographic location indicated by the processor determined at least one locality characteristic; determining by at least one processor a group of multiple distinct appointment opportunities by determining, for each of at least some of the plurality of service providers, at least one appointment opportunity that is currently available for booking by the user for at least one service of the service provider; and providing by at least one processor at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

A computer system may be summarized as including at least one processor and at least one computer-readable storage memory communicatively coupled to the at least one processor, the at least one computer-readable storage memory storing processor executable instructions that cause the at least one processor to: determine at least one locality characteristic for a user, each of the at least one locality characteristic indicative of a respective possible geographic location of the user; determine a plurality of service providers that service a geographic area, the geographic area encompassing at least one respective geographic location indicated by the processor determined at least one locality characteristic; determine a group of multiple distinct appointment opportunities by determining, for each of at least some of the plurality of service providers, at least one appointment opportunity that is currently available for booking by the user for at least one service of the service provider; and provide at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

In particular, the above may enable service providers to advertise or otherwise publish their current appointment availability to existing and potential clients, in such a manner that the clients may easily perform online booking for the advertised or otherwise published current appointment availability.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment including a number of server computing systems and user computing systems communicatively coupled to one or more networks and an appointment availability service system, according to one illustrated embodiment.

FIGS. 2A and 2B are context diagrams that illustrate examples of various types of interactions to facilitate propagation of appointment availability in a networked computing environment, according to two illustrated embodiments.

FIG. 3 is a schematic diagram of an appointment availability service system and of various additional systems, according to one illustrated embodiment.

FIG. 4 is a workflow diagram illustrating an overview of propagating current appointment availability, according to one illustrated embodiment.

FIG. 5 is a workflow diagram illustrating a technique for providing real-time appointment availability data in placements, according to one illustrated embodiment.

FIG. 6 is a workflow diagram illustrating a technique for providing real-time appointment availability data in placements, according to another illustrated embodiment.

FIG. 7 is a workflow diagram illustrating a technique for in situ booking of appointment availability, according to one illustrated embodiment.

FIG. 8 is a workflow diagram illustrating a technique for redirected booking of appointment availability, according to one illustrated embodiment.

FIG. 9 is a workflow diagram illustrating a technique for optimizing appointment availability data provided in a placement, according to one illustrated embodiment.

FIG. 10 is a workflow diagram illustrating a technique for providing an appointment availability marketplace, according to one illustrated embodiment.

FIG. 11 is a screen print of a Web page with an example appointment availability placement, according to one illustrated embodiment.

FIG. 12 is a screen print of a Web page with an example appointment availability placement, according to another illustrated embodiment.

FIG. 13 is a screen print of a Web page with an example appointment availability placement, according to another illustrated embodiment.

FIG. 14 is a screen print of a Web page with an example appointment availability placement, according to another illustrated embodiment.

FIG. 15 is a screen print of a Web page with an example appointment availability marketplace, according to one illustrated embodiment.

FIG. 16 is a flow diagram showing a method of providing appointment availability in a placement, according to one embodiment.

FIG. 17 is a flow diagram showing a method of booking appointment availability via a provided placement, according to one embodiment.

FIG. 18 is a flow diagram showing a method of optimizing appointment availability provided in a placement, according to one embodiment.

FIG. 19 is a flow diagram showing a method of providing an appointment availability marketplace, according to one embodiment.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment”, “in an embodiment”, or “in one or more embodiments” in various places throughout this specification are not necessarily all referring to the same embodiment. Further more, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

Embodiments described herein provide enhanced computer- and network-assisted methods, techniques, and systems for facilitating propagation of appointment availability, such as to propagate current appointment availability information of one or more appointments that are available from a service provider to be booked by a potential or existing client of the service provider. As used herein, a service provider is a person or an entity that performs a service on behalf of a client at one or more times that are prearranged with the client, such as during one or more scheduled appointments. In general, as used herein, language referring to “appointment availability”, an “available appointment”, or the like, refers one or more times at which a service provider may be available to be scheduled (i.e., booked) to perform one or more services on behalf of a client. Services may include various types of services performed by a service provider on behalf of an individual client or a group of clients, such as, among other things, health services (e.g., diagnostics, treatment, therapy, training, massage), beauty services (e.g., cosmetology), professional services (e.g., legal, accounting), labor services, etc. Techniques described herein enable service providers to dynamically advertise or otherwise publish their real-time (i.e., current) appointment availability to potential and existing clients in such a manner that the clients may receive information identifying a currently available appointment of a service provider, and, in some cases, may easily book the identified currently available appointment.

Example embodiments provide an Appointment Availability Service, which is operable to dynamically provide information indicative of currently available appointments of service providers in placements which are propagated to potential or existing clients of the service providers in a network environment. Such placements are referred to herein in various embodiments as “appointment availability placements.” A service provider's current availability for booking may be dynamically determined at or near a time that the appointment availability information is provided in a placement, such that the appointment availability information provided in a placement may include one or more indications of an appointment for a service of the service provider determined at or near the time of the providing to be currently available for a client of the service provider to book. Such appointment availability information may include, for example, an indication of one or more times and/or dates that a currently available appointment may occur, an indication of a particular service provided during an appointment, an indication of a particular service provider that provides the appointment, an indication of a cost associated with the appointment, and/or other indications. In some embodiments, an appointment availability placement may include other information or indications, such as appointment details (e.g., descriptions of services, facilities, etc), images and messages (e.g., advertising images, ad copy), and/or other information.

In various embodiments, an appointment availability placement may be provided in various forms, such as a banner ad, a button ad, a skyscraper ad, a text ad, a Short Message Service (“SMS”) ad, a Multimedia Messaging Service (“MMS”) ad, rich media (e.g., flash, video), web or news feed (e.g., RSS; tickers), embedded application (e.g., widgets, gadgets), email, and various other forms. In at least some embodiments, placements with current appointment availability information may be served to users of Web sites or other services (e.g., Internet- or mobile-based applications) in the form of electronic advertisements that are served to the users as they interact with or otherwise use the Web sites or other online services. For example, in some such embodiments, a placement with current appointment availability information may appear as a Web ad included in a Web page of a Web site.

In some embodiments, the Appointment Availability Service may dynamically determine a service provider's current appointment availability based on current data (or other information) indicative of one or more times that a service provider may be available to perform one or more services. Such data may be obtained and/or received by the Appointment Availability Service in various ways. In some embodiments, the Appointment Availability Service may obtain or receive such data from electronic calendars or other scheduling software with which the service provider records and/or tracks appointments. For example, the Appointment Availability Service may include functionality for managing one or more service providers' appointment schedules, such that the one or more service providers (or other users) may interact with the Appointment Availability Service to designate one or more times that the service provider offers to perform one or more services and/or to indicate one or more times at which the service provider is booked or otherwise not available to perform the one or more services at one or more times. In other embodiments, the Appointment Availability Service may obtain or receive appointment availability information from other sources, such as from other schedule management software, other electronic calendars (e.g., desktop calendars; online calendar services, such as Google™ Calendar), and/or various other data sources, some of which may be provided by and/or hosted by third parties. In other embodiments, dynamically determining a service provider's current appointment availability may be performed in other ways.

In some embodiments, the appointment availability placements that are propagated to potential or existing clients of the service providers may include functionality that enables a recipient of the placement to interact with the placement in such a manner as to select or otherwise request an appointment for booking with a service provider. For example, a recipient of a placement may interact with one or more controls provided by the placement to cause an appointment for a service indicated as available for booking in the placement to be booked for the recipient. In some such embodiments, such interactions of a recipient may automatically cause a service provider's electronic calendar or other scheduling software to be updated to include information of a booking or a request for a booking of an appointment by a recipient of a placement, and/or may cause the service provider to otherwise be notified of the booking or request for booking (e.g., via email, voicemail, text message).

An embodiment of the Appointment Availability Service may include functionality to perform contextual or creative optimizations to potentially increase the effectiveness of advertised or otherwise published current appointment availability information (e.g., placements with appointment availability information), such as to potentially increase the likelihood that one or more currently available appointment opportunities will be booked by a recipient of the current appointment availability information. For example, such optimizations may be used to determine appointment availability information that may be relevant or otherwise of interest to the recipient, and/or to determine various ways to present such information in one or more ways that may be more effective. In particular, the Appointment Availability Service may optimize the appointment availability information included in appointment availability placements, such as by determining preferred or otherwise optimal availability information to include in appointment availability placements, based on one or more optimization factors.

For example, in various embodiments, such optimizations may include determining one or more preferred service providers from which to offer current appointment availability, one or more preferred services for which to offer current appointment availability, a preferred time that a currently available appointment opportunity is to occur, a preferred duration for a currently available appointment opportunity, a preferred price for a currently available appointment opportunity, etc. In addition, such optimizations may include determining a preferred number of appointment opportunities to include in a placement; determining preferred details to include in a placement, such as details related to an appointment (e.g., price, duration), service provider (e.g., name, certifications, experience), or service (e.g., description); and/or various other optimizations related to presentation and/or utility of a placement (e.g., color, size, aspect, font, graphics, user interactions). A non-exclusive list of optimization factors may include, for example: factors related to an intended recipient or group of recipients of a placement (e.g., user profiles, demographics, geographical location); context in which a placement is provided; a service provider (e.g., type, geographical location, service provider preferences or constraints); a service (e.g., type, duration, price); medium or format of the placement (e.g., graphics-based, text-based, rich media, video, audio); historical factors (e.g., a client's current or previous bookings, prior use or effectiveness of previously provided placements); NB or multivariate testing; etc.

In some embodiments, an Appointment Availability Service may be operable to provide an electronic marketplace for current appointment availability. Such a marketplace may simultaneously display or otherwise provide current appointment availability information of multiple service providers in such a manner that a user of the marketplace may selectively book at least one currently available appointment from at least one of the multiple service providers. For example, such a marketplace may allow a user to engage in comparison shopping for appointment availability from multiple service providers, such as based on price, services, location, etc. In some embodiments, the Appointment Availability Service may determine to display or otherwise provide the multiple service providers for an electronic marketplace based on the service providers being located in and/or otherwise serving a particular geographic area determined to be local to a user of the marketplace. In addition, the marketplace may use various contextual or creative optimizations (such as described above) to potentially increase the likelihood that appointment availability offered in the marketplace will be booked by a user of the marketplace.

In at least one embodiment, the Appointment Availability Service may be provided as part of an online scheduling service that provides functionality for a number of service providers (or their agents) to maintain and manage at least some portion of their appointment schedules in an electronic format online (e.g., network-based calendar or scheduling software). In some such embodiments, such services may also provide functionality for existing and/or potential clients to interact with the scheduling service to book and/or request bookings for one or more appointments available from one or more of the number of service providers.

For illustrative purposes, some embodiments are described below in which specific users, entities, and systems perform specific tasks and interactions in specific manners. These examples are provided for illustrative purposes and are simplified for the sake of brevity, and it will be appreciated that the inventive techniques may be used in a wide variety of other situations, some of which are described below.

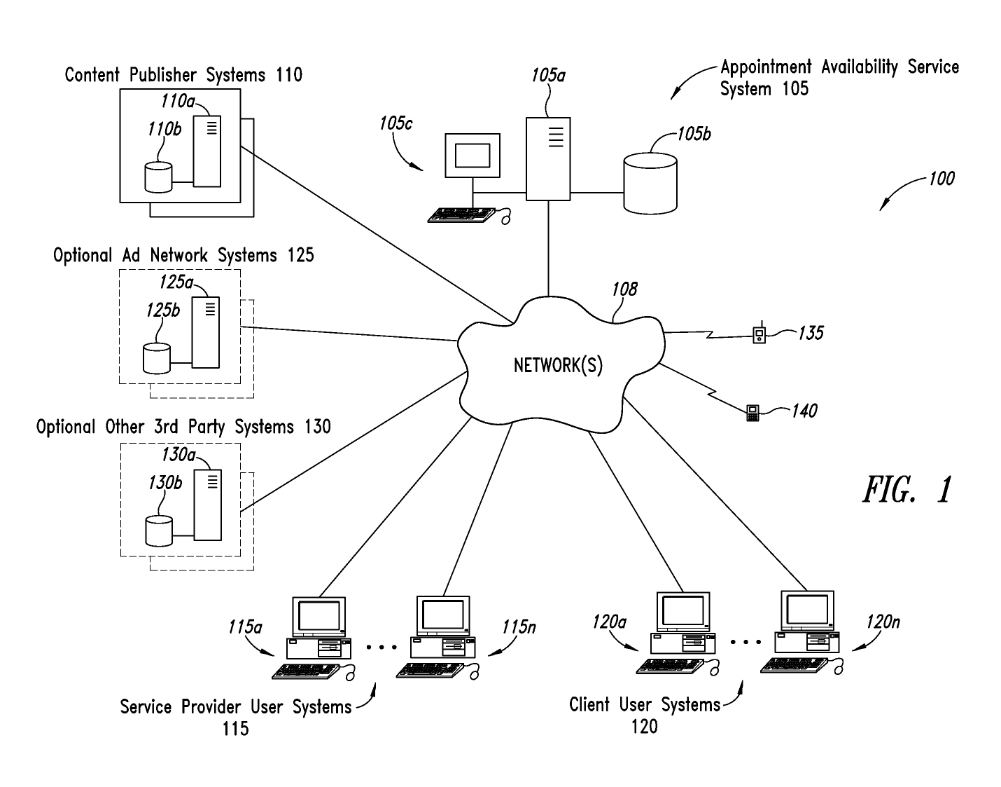

FIG. 1 shows a network environment 100, according to one illustrated embodiment. In particular, the illustrated embodiment of the network environment 100 includes an Appointment Availability Service System (“AASS”) 105 that provides an embodiment of an Appointment Availability Service to facilitate propagation of appointment availability. The Appointment Availability Service System 105 includes one or more appointment availability service server computers 105a, one or more databases 105b and/or other computer readable storage media (not shown), and an optional control terminal 105c. The one or more appointment availability service server computers 105a may execute instructions stored on computer-readable media (not shown) that cause the server computers 105a to facilitate dynamically providing current appointment availability information of one or more service providers to one or more current or potential clients of the one or more service providers in the network environment 100 via one or more communication networks 108.

The network environment 100 also includes a number of content publisher systems 110. The content publisher systems 110 include one or more server processors 110a that execute server instructions (i.e., server software) stored on computer-readable media to provide server functions in the network environment 100, such as via one or more communications networks 108. For example, the content publisher systems 110 may serve content such as files and/or other information stored in one or more databases or other computer-readable storage media 110a. The content publisher systems 110 may serve content such as Web pages (e.g., HTML, Flash) or other content formats (e.g., video streams, audio streams, data feeds) for access and/or use by one or more users, such as users (not shown) of service provider user systems 115a-115n (collectively 115) or of client user systems 120a-120n (collectively 120). In some embodiments, the content publisher systems 110 may provide content via Web sites, such as, among other things, Internet Yellow Pages; local and/or vertical online directories; news sites (e.g., online newspapers, magazines); searching sites; social networking sites; start pages or other personalized Web pages (e.g., iGoogle™, My Yahoo®); shopping sites; etc.; or via other online applications/services such as information distribution services (e.g., web feeds, news feeds, email services); electronic calendar applications (e.g., Google Calendar); instant messaging services; and other online and/or mobile applications/services.

In some embodiments, the content publisher systems 110 may also execute instructions to provide to users (or cause to be provided to users) appointment availability placements (and/or other types of placements) along with or in addition to the content provided by the content publisher. The appointment availability placements may include data and/or instructions that enable user computing systems (user computing systems 115 and 120) or other user devices to present information indicative of appointment availability in various ways (e.g., graphics, text, audio, video). For example, in some embodiments, one or more of the content publisher systems 110 may execute instructions to serve Web pages that include appointment availability placements (and/or other placements) for display on user computing systems (e.g., via a Web browser or other application executing on one or more user computing systems 115 and 120). In some embodiments, the appointment availability placements (and/or other placements) served by the content publisher systems 110 may be provided in various forms such as electronic advertisement placements, including banner ads, button ads, skyscraper ads, rich media ads, text ads, interstitial ads, pop-up ads, widget ads, gadget ads, SMS ads, email ads, or various other forms of online and/or mobile advertising placements.

The content publisher systems 110 may execute instructions to interact with the Appointment Availability Service System 105 to obtain and/or receive information (e.g., data and/or instructions) related to appointment availability placements, such that the content publisher systems 110 may serve to users (or cause to be provided to users) appointment availability placements with current appointment availability information. In some embodiments, at least some portions of such information may be stored in the databases or other computer-readable storage media 110a, so that the content publisher systems 110 may execute server instructions to determine a placement to serve to a user from the information stored at least in part in the databases or other computer-readable storage media 110a. For example, such information may be stored as part of an advertising inventory of the content publisher systems 110, and in some such embodiments, the content publisher may select and/or determine to serve appointment availability placements in a manner similar to that of traditional electronic advertising (e.g., rotational ads, ad targeting).

In some embodiments, a content publisher system 110 may execute functionality for determining or otherwise identifying a geographical location or area (e.g., country, region, state, province, city, neighborhood) of a user to which content is to be served, or may otherwise specifically cater to users in a particular geographical location or area. For example, a content publisher system 110 may include functionality for determining or otherwise identifying a geographical location or area of a user to which content is to be served, such as using various known geo-targeting techniques (e.g., based on user-provided location information, IP address identification, etc), such that the content publisher system may serve localized content and/or other types content of interest to the users located in the geographical location or area, including appointment availability placements that include services that are local to the users. The content publisher system 110 may also include functionality to facilitate other types of targeting, such as user demographics, user profiles, etc.

The network environment 100 may also include a number of optional advertising network systems 125. The optional advertising network systems 125 include one or more server processors 125a that execute server instructions stored on computer-readable media to provide ad serving functionality in the network environment 100. For example, the advertising network systems 125 may serve various types of advertisements, including appointment availability placements, from an advertising inventory stored in one or more databases or other computer-readable storage media 125a. The advertising network systems 125 may serve appointment availability placements and/or other electronic advertisements to users of at least some of the one or more content publisher systems 110 on behalf of those content publishers, such as to serve appointment availability placements and/or other ads to be included with content provided by those content publishers. In some embodiments, the optional advertising network systems 125 may execute instructions to interact with the Appointment Availability Service System 105 to obtain and/or receive instructions and/or data related to providing appointment availability placements with current appointment availability information, so that the optional advertising network systems 125 may provide to users via user operated devices (or cause to be provided) placements with current appointment availability information (e.g., appointment availability placements), such as with content provided by one or more content publisher systems 110. The optional advertising network systems 125 may also include functionality to facilitate targeting advertisements and/or appointment availability placements provided by the optional advertising network systems 125, such as based on geographical location of intended recipients (e.g., users of one or more of content publisher systems 110) or otherwise (e.g., user demographics, profiles).

The network environment 100 may also include a number of optional other third party computing systems 130 that include one or more server processors 130a that execute server instructions stored on computer readable media, such as 130b, to provide various optional server functions in the network environment 100. For example, in some embodiments, such optional other third party computing systems may provide online calendar services or other scheduling services for use by one or more service provider users (not shown) operating service provider user systems 115.

The network environment 100 includes a number of user computing systems, such as service provider user systems 115 operated by one or more service providers (not shown) and client user systems 120 operated by one or more existing or potential clients (not shown) of one or more of the service providers. The user computing systems 115 and 120 are selectively communicatively coupled to one or more of the appointment availability system 105, the content publisher system 110, the optional ad network system 125, and the optional other third party systems 130, via one or more communications networks 108. The user computing systems 115 and 120 include one or more processors that execute one or more sets of communications instructions (e.g., browser or other applications with network communication capabilities) stored on any of a variety of computer-readable storage media (not shown). The user computing systems 115 and 120 may take a variety of forms, for instance desktop or laptop personal computers, work stations, mini-computers, mainframe computers, television-based systems (e.g., set-top boxes, personal/digital video recorders, interactive televisions), or other computational devices with microprocessors or microcontrollers which are capable of network communications. The user computing systems 115 and 120 may be communicatively coupled to the rest of the network 108 via wired, wireless or a combination of wired and wireless communications channels.

The service provider user systems 115 may be operated by one or more users (not shown) who are service providers that provide various types of services on behalf of clients. A service provider user may operate one of the service provider user systems 115 to interact with an embodiment of the AASS 105, such as via a Web browser or other application executing on the service provider user system, to provide information and/or configure the AASS 105 in various ways, such as to facilitate providing current appointment availability information of the service provider to one or more existing or potential clients of the service provider in the network environment 100 (e.g., such as via one or more appointment availability placements and/or an appointment availability marketplace).

The client user systems 120 may be operated by one or more users (not shown) who are existing or potential clients of one or more of the service providers operating the service provider user systems 115. An existing or potential client user may interact with content publisher systems 110 via a Web browser or other application executing on at least one of the client user systems 120 to obtain content from the content publisher system, such that the content may be presented to the user on a client user system 120 (e.g., such as in on a display of the client user system). In addition, the existing or potential client user may interact with an embodiment of the AASS 105 via a Web browser or other application to book (or request a booking of) one or more appointments from one or more service providers, such as via one or more appointment availability placements provided to the client user and/or an appointment availability marketplace. The existing or potential client user may also operate one of the client user systems 120 to interact with other systems, such as optional other third party systems 130.

The network environment 100 may also include a number of telecommunications devices 135 (only one illustrated). Such telecommunications devices 135 may, for example, take the form of Internet or Web enabled cellular phones. The network environment 100 also includes a number of personal digital assistant (PDA) devices 140 (only one illustrated). Such PDA devices 140 may, for example, take the form of Internet or Web enabled PDAs (e.g., iPHONE®, TREO®, BLACKBERRY®), which may, for example, execute a set of browser instructions or program. The network environment 100 may include any number of a large variety of other devices that are capable of some type of networked communications, such as, pagers, electronic organizers, Internet appliances, television-based systems (e.g., set-top boxes, personal/digital video recorders, interactive televisions), etc. The telecommunications devices 135, PDA devices 140, as well as any other devices, may be communicatively coupled to the rest of the network 108 via wired, wireless or a combination of wired and wireless communications channels. The telecommunications devices 135 and PDA devices 140 may be variously operated one or more service providers (not shown) and/or potential or existing clients (not shown) of one or more of those service providers.

The one or more communications networks 108 may take a variety of forms. For instance, the communications networks 108 may include wired, wireless, optical, or a combination of wired, wireless and/or optical communications links. The one or more communications networks 108 may include public networks, private networks, unsecured networks, secured networks or combinations thereof. The one or more communications networks 108 may employ any one or more communications protocols, for example TCP/IP protocol, UDP protocols, IEEE 802.11 protocol, as well as other telecommunications or computer networking protocols. The one or more communications networks 108 may include what are traditionally referred to as computing networks and/or what are traditionally referred to as telecommunication networks or combinations thereof. In at least one embodiment, the one or more communications networks 108 includes the Internet, and in particular, the Worldwide Web or (referred to herein as “the Web”). Consequently, in at least one embodiment, one or more of the content publisher systems 110, the optional ad network system 125, and the optional other third party system 130 execute server software to provide Web pages or other Web-based services, and one or more user systems 115 and 120, telecommunications devices 135 and/or PDAs 140 execute browser software and/or other Web-enabled applications to request and display Web pages and/or otherwise interact with other Web-based applications.

As noted above, the one or more appointment availability service server computers 105a of the illustrated Appointment Availability Service System 105 may execute instructions stored on computer-readable media that cause the servers 105a to facilitate dynamically providing current appointment availability information of one or more service providers to one or more current or potential clients of the one or more service providers in the network environment 100.

As part of such facilitation, in some embodiments, the one or more appointment availability service server computers 105a may execute instructions to dynamically obtain or otherwise receive current appointment availability information regarding one or more service providers, such as based on a service provider's current schedule. Such instructions may include schedule management logic which obtains, receives, and/or maintains appointment availability information of one or more service providers, with such information being stored in one or more appointment availability service databases 105b. The schedule management logic may, for example, enable a service provider using a service provider user system 115 to interactively provide information of one or more times at which the service provider is available or otherwise unavailable to perform a service, such as by designating one or more times (or time slots) that the service provider is available and/or unavailable to perform various types of services. In addition, the logic may enable the service provider user to provide other information related to appointments, schedules, clients, etc. In one embodiment, the schedule management logic may be provided as part of a network-based electronic calendar or scheduling service of the Appointment Availability Service System 105 that provides network-based capabilities for remotely located service providers to manage and store at least a portion of their current schedules and/or appointments.

The schedule management logic may obtain or otherwise receive appointment availability information regarding one or more service providers in various additional or other ways. For example, one or more service provider users may manage appointments using various applications, such as electronic calendars or scheduling software, that execute locally on one or more service provider user systems 115 and/or, at least in part, remotely on one or more network-located systems (e.g., optional other third party system 130), and store information related to appointment availability of the one or more service providers on the one or more service provider user systems 115 and/or on the one or more network-located systems, with the appointment availability information being obtained and or received from such systems from time-to-time.

The schedule management logic may also enable an existing or prospective client of a service provider to book one or more available appointments from a service provider, such as existing or prospective clients operating client user systems 120. In various embodiments, such logic may record whether an appointment has been booked or requested for booking by a client, and/or may notify a service provider that an appointment has been booked or requested for booking by a client, etc. The schedule management logic may automatically update an electronic calendar or schedule of the service provider to indicate that an appointment has been booked or requested by a client, such as an electronic calendar or schedule located on the Appointment Availability Service System 105 (e.g., in appointment availability service database 105b or other memory), on a service provider user system 115, or on the optional other third party system 130 (e.g., in database 130b or other memory). The schedule management logic may similarly update a calendar or other schedule of the client user. The schedule management logic may also notify a service provider or a client in various other ways, such as via email, voice mail, text messages, instant messages, etc.

In some embodiments, a notification provided to the service provider of a booking and/or a request for booking may include instructions that enable a service provider user to interactively accept and/or reject the requested booking. For example, such a notification may include instructions such as Web hyperlinks (or other code) included in the notification that when selected (or otherwise executed) cause an electronic calendar or schedule of the service provider to be updated to include an indication that the appointment booking has been accepted or rejected, and in some such cases may notify the client of the acceptance or rejection in various ways, such as by email, voice mail, text message, updating an electronic calendar or schedule, etc. Various other functionality may be provided by the schedule management logic, such as logic to automatically remind a service provider user and/or a client user, respectively operating user systems 115 and 120, in various ways in various ways (e.g., email, voice mail, text message, updating an electronic calendar or schedule) of an approach of a date or time of an appointment that has been booked by the client user with the service provider.

In some embodiments, when the schedule management logic receives indications that a client has booked an appointment or requested a booking (e.g., from either the client or the service provider), the schedule management logic may automatically update the appointment availability information stored in one or more appointment availability service databases 105b to indicate that the appointment is no longer currently available for booking (and/or a service provider is no longer available to provide services during that time). For example, an appointment may no longer be available for booking when the appointment becomes full (e.g., a maximum number of clients have booked the appointment).

As part of facilitating dynamic providing of current appointment availability information, in some embodiments, the one or more appointment availability service server computers 105a may also execute appointment availability placement configuration logic instructions that allow service provider (or an agent of the service provider) to configure appointment availability placements that advertise and/or otherwise publish current appointment availability of one or more service providers. Information related to such configuration may be stored in one or more databases 105b.

In one embodiment, such appointment availability placement configuration logic may enable a service provider to specify one or more parameters to control various aspects of appointment availability and/or other information provided in placements. For example, a service provider user may specify which of one or more services to publish in appointment availability placements; which of one or more service providers to publish in appointment availability placements; etc. In some embodiments, the service provider user may designate one or more candidate times (e.g., dates, months, days of a week, times of the day, time slots, time periods) to limit what appointment availability may be published in an appointment availability placement, such that only appointments that are currently available at (or during) those one or more candidate times are published in an appointment availability placements. As one illustrative example, a service provider user may designate candidate times as occurring between certain hours of certain days, such as between the hours of 2 pm to 5 pm on Tuesdays and Thursdays, and only appointments that are available between those hours on those days may be published in appointment availability placements. The service provider may also configure other aspects related to appointment availability placements, such as one or more possible durations for various appointments, one or more possible prices for various appointments, etc.

In one embodiment, the placement configuration logic may enable a service provider user to configure price elasticity for one or more appointments, such that pricing for an appointment published in a placement may be dynamically determined by the AASS 105, such as at the time that the appointment availability for the appointment is published. For example, in some such embodiments, the service provider user may configure one or more business rules and/or parameters to control dynamic pricing for an appointment availability published in placements. For example, in some embodiments, such business rules or parameters may, among other things, dynamically discount prices for a short-notice appointment booking, or a first time client, etc.; adjust prices based on supply and demand; adjust prices based on competitor prices; up-sell to higher value services; cross-sell to a related services; etc.

The placement configuration logic may also enable a service provider user to specify various aspects of how and/or where appointment availability placements are to be provided. For example, the service provider user may specify a content publisher and/or advertising network from which to serve placements; a geographic location and/or area to target placements; a demographic of an intended target audience of the placements; a context in which to serve placements (e.g., subject matter of Web sites and/or other applications in which the placements are published); etc. In addition, the service provider user may also specify the types of placements (e.g., display ads, text ads, rich media ads, SMS ads, calendar ads); aspects related to display of placements (e.g., size, aspect, color, fonts, images, text, graphics); as well as other aspects including various customizations, such as custom messages (e.g., ad copy), images, etc. to include in placements.

After a service provider configures one or more appointment availability placements, the AASS 105 may store indications of the one or more configured AAPs in one or more databases 105b, such as for use in distributing/publishing AAPs on behalf of one or more service providers, as discussed elsewhere.

As part of facilitating dynamic providing of current appointment availability information, the one or more appointment availability service server computers 105a may execute appointment availability provisioning logic instructions to facilitate providing appointment availability placements that include current appointment availability information of one or more service providers to one or more existing or potential clients of the one or more service providers in the network environment 100.

The provisioning logic instructions may create (or assist in the creation of) appointment availability placements that include current appointment availability information that may be presented to one or more client users operating client user systems 120. As previously noted, an appointment availability placement may include a variety of information indicative of current appointment availability, such as one or more times and/or dates that a currently available appointment may occur (e.g., dates or days of availability, start times, end times, durations), a service provided during a currently available appointment (e.g., type or other details), a service provider that provides a currently available appointment (e.g., name, licensing, training, location, contact information, or other details), a cost associated with a currently available appointment, and/or other information. An appointment availability placement may also include various other information or indications, such as details associated with a currently available appointment (e.g., location, descriptions of service, facilities, etc), images and messages (e.g., advertising images, ad copy), etc.

An appointment availability placement may include data, code, references (e.g., Uniform Resource Identifiers “URI”), and/or other information that causes or enables one or more client user systems 120 that receive the appointment availability placement to present current appointment availability information associated with the appointment availability placement to users of the systems, such as to present current appointment availability information to the user of the client user system in an application executing on the client user system (e.g., Web browser or other application). As previously noted, in various embodiments, an appointment availability placement may be formatted in a variety of manners (e.g., Web ads, rich media, widgets, gadgets) for distribution to client user systems 120.

The appointment availability placement may include instructions and/or other data that enable a client user to whom the appointment availability placement is presented to interactively book at least one of the appointments indicated in the appointment availability placement (e.g., such as via user interface controls presented in the appointment availability placements). For example, the included instructions or data may enable a client user to interact with schedule management logic of the AASS 105 to book or request a booking for a currently available appointment presented in the appointment availability placement.

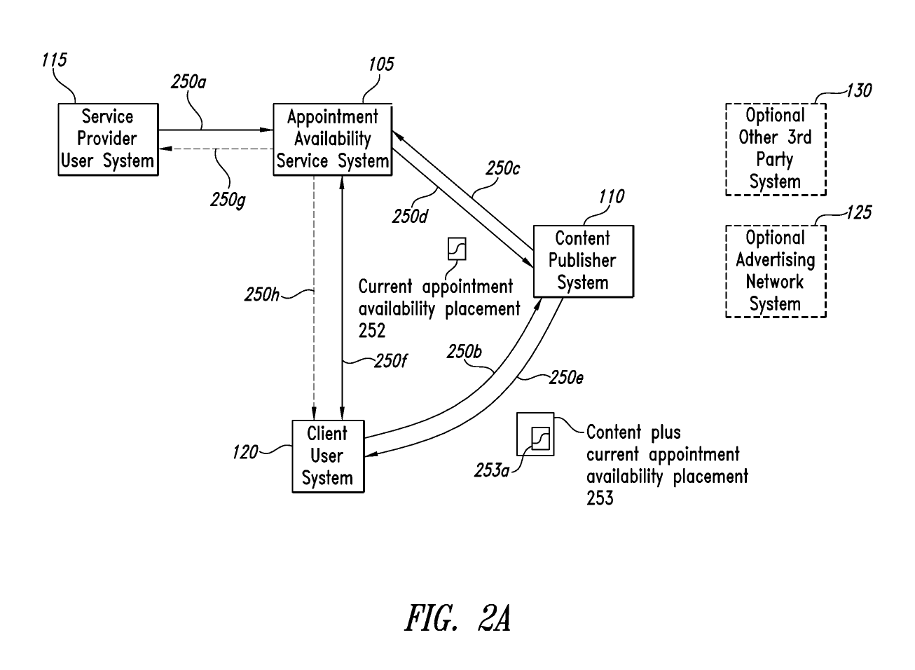

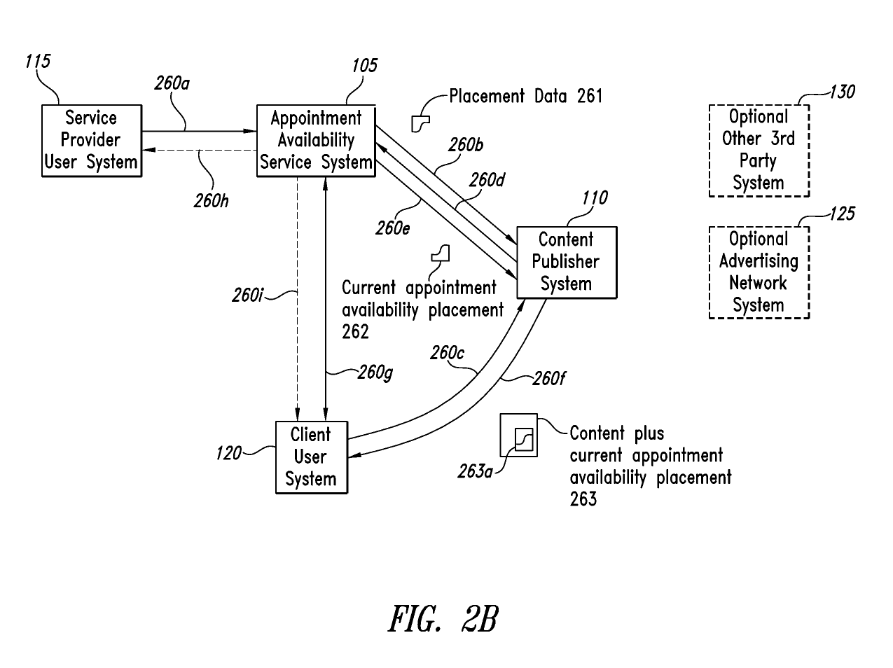

The appointment availability provisioning logic instructions may facilitate dynamic providing of appointment availability placements with current appointment availability information to potential or existing clients of one or more service providers in various ways in various embodiments, some of which are described with respect to FIGS. 2A and 2B (below).

As part of providing appointment availability placements with current appointment availability information, the appointment availability provisioning logic may dynamically determine current appointment availability (e.g., one or more appointments that are currently open for booking by a client) of one or more service providers. The appointment availability provisioning logic may determine current availability of one or more service providers based on schedule data or other information of the one or more service providers stored in appointment availability service databases 105b. For example, in some embodiments, the appointment availability provisioning logic may inspect or otherwise analyze the data to determine one or more times that a service provider is currently available to perform the service, such as one or more times that are not in the past or are not otherwise unavailable (such as due to current bookings, scheduling conflicts). In some embodiments, the appointment provisioning logic may also determine which service (from multiple services provided by the service provider) to provide corresponding appointment availability information for; which service provider (from multiple service providers) to provide corresponding appointment availability information for; and/or various other aspects related to appointment availability (e.g., duration of an appointment, price of an appointment); etc. In addition, in some embodiments, the Appointment Availability System may interact with various other systems (e.g., service provider user systems 115, optional other third party systems 130) to obtain current appointment availability information to provide in appointment availability placements, and in some such embodiments, those other systems may determine current appointment availability for one or more service providers in various ways.

As part of facilitating dynamic providing of current appointment availability information, the one or more appointment availability service server computers 105a may execute optimization logic instructions to perform contextual or creative optimizations to potentially increase the effectiveness of advertised or otherwise published current appointment availability information, such as to potentially increase the likelihood that one or more currently available appointment opportunities will be booked by an intended recipient of the appointment availability information. For example, the optimization logic instructions may determine appointment availability information that may be relevant or otherwise of interest to an intended recipient, and/or may determine one or more potentially effective ways to present such information.

In one embodiment, the optimization logic instructions may optimize appointment availability information that is included in an appointment availability placement. The logic may determine preferable (or otherwise optimal) availability information to include in an appointment availability placement (i.e., information that may potentially improve the effectiveness of the appointment availability placement), such as based on one or more optimization factors. In some embodiments, the optimization logic may determine, based on one or more of the optimization factors, one or more preferred service providers from which to offer current appointment availability, one or more preferred services for which to offer current appointment availability, a preferred time of availability for a currently available appointment opportunity, a preferred duration for a currently available appointment opportunity, a preferred price for a currently available appointment opportunity, etc.

In some embodiments, the optimization logic may determine appointment availability information that includes one or more appointment opportunities that are currently available at one or more preferred or optimal times (e.g., particular days of the week, particular times of the day), based on one or more optimization factors indicating that an intended recipient of the appointment availability placement may be more likely to book an appointment that is available at the one or more preferred or optimal times. For example, the optimization logic may determine to provide appointment availability for appointments that are currently available in the evening or on the weekend to an intended recipient who may be a person that works during the day (e.g., based on the intended recipients profile/demographics, prior booking habits) and, thus, may be more likely to book an appointment that occurs in the evening or on the weekend. In some situations, one or more intended recipients of an appointment availability placement may be more likely to book an appointment opportunity when given an appropriate amount of advanced notice between receipt of the placement and one or more times at which a currently available appointment offered in the placement is to occur (such as two days advanced notice, etc), and in such cases, the optimization logic may determine appointment availability information that includes opportunities that are currently available at one or more times that account for the optimal amount of notice.

In some embodiments, the optimization logic instructions may determine a preferred number of appointment opportunities to include in an appointment availability placement based on one or more optimization factors, such as to provide one or multiple opportunities based on the preferred number being more effective. In addition, in some embodiments, the logic may determine various aspects related to presentation of appointment availability information in an appointment availability placement based on optimization factors, such as to determine preferred details to include in an appointment availability placement, such as details related to an appointment (e.g., price, duration), service provider (e.g., name, certifications, experience), or service (e.g., description); and/or various other optimizations related to presentation and/or utility of a placement (e.g., color, size, aspect, font, graphics, user interactions).

As previously noted, the optimization factors may be based on various types of information that may be used to determine preferred or optimal appointment availability, such as including profiles/demographics of intended recipients, geographical location of intended recipients, context in which appointment availability placement is served, historical usage factors, A/B or multivariate testing, etc. At least some of such information may be provided to the AASS 105 by one or more other systems, such as at the time of a request for appointment availability information (e.g., geographical location of a content publisher or client user, client user profile/demographic, context). Some of the information may be stored/maintained by an embodiment of the AASS 105. For example, the AASS 105 may track usage history of one or more appointment availability placements (e.g., whether a placement results in bookings) and/or client users (e.g., track appointments booked by client), such as by storing such information in database 105b.

In some embodiments, the optimization logic may use historical information of one or more client users to determine preferences of one or more users (e.g., types of services that user books, locations of service providers that client user books, times of appointments that client user books, characteristics of placement that user interacts with), whether the user is available at a particular time (e.g., based on the user having current bookings of one or more appointments that have yet to occur), whether the client user may or may not be likely to book a certain appointment based on recently booked appointments by the user (e.g., client user may not be likely to book an appointment for a service that the client user recently booked; client user may be likely to book a service that is related to or a companion service to a service that was recently booked by the client user), etc.

In various embodiments, one or more intended recipients may be identified by the optimization logic in various ways. For example, the one or more intended recipients may be identified based on the type of content published by a publisher system 110 (e.g., audience profile the content publisher's users), IP address associated with a recipient, cookies or other information provided by an intended recipient's Web browser, location of the intended recipient, etc.

As part of facilitating dynamic providing of current appointment availability information, the one or more appointment availability service server computers 105a may execute appointment availability marketplace logic instructions to provide an electronic marketplace for current appointment availability.

The appointment availability marketplace logic instructions may determine appointment availability information for multiple service providers, such that the appointment availability of the multiple service providers may be provided to one or more existing or potential customers of the multiple service providers in an electronic marketplace format. The electronic marketplace format may simultaneously display indications of current appointment availability for multiple service providers. For example, such a marketplace may be provided to one or more client user systems 120 for display to client users via Web browsers or other applications executing on those systems. In some embodiments, such a marketplace may be provided to client users as an appointment availability placement that includes current appointment availability of multiple service providers.

The appointment availability marketplace logic may determine which of multiple service providers to include in a marketplace format based on various factors in various embodiments, such as, intra alia, based on geographical locality of the service providers, types of services provided by the service providers (e.g., service providers providing similar types of services), and/or based on one or more optimizations such as discussed above. In one embodiment, the multiple service providers may be determined based on the service providers being located in and/or otherwise serving a particular geographic area determined to be local to a client user to whom the marketplace is provided, such that the marketplace consists of current appointment availability of local service providers.

The appointment availability marketplace logic may dynamically determine appointment availability information for the multiple service providers provided in the marketplace, such as in a manner similar to that described with respect to appointment availability placements. In particular, the appointment availability marketplace logic may determine current appointment availability for the multiple service providers by analyzing schedule data or other information of the one or more service providers stored in appointment availability service databases 105b. The various constraints and optimizations described with respect to the appointment availability placements may be used as part of determine the appointment availability information to provide in the marketplace format.

Various aspects of the operation of the one or more appointment availability service server computers 105a and databases 105b to implement such are discussed in detail below.

FIGS. 2A and 2B each illustrate example interactions between multiple of the computing systems described in FIG. 1, with an embodiment of an Appointment Availability Service System to facilitate propagation of current appointment availability of service providers. Although not illustrated in FIGS. 2A and 2B, interactions between the various computing systems may be occurring via the communications networks 108 of FIG. 1. In particular, FIGS. 2A and 2B depicts a service provider user system 115 (operated by a service provider user (not shown)) interacting with an Appointment Availability Service System 105 to publish or otherwise advertise current appointment availability of the service provider user (not shown) in appointment availability placements that are served to users of content publisher system 110, such as client users (not shown) interacting with the content publisher system 110 via client user system 120 to obtain content.

In the illustrated example of FIG. 2A, service provider user system 115 initiates one or more interactions 250a with the Appointment Availability Service System 105 to specify or otherwise configure one or more appointment availability placements to dynamically advertise or otherwise publish current appointment availability of the service provider user. As part of such configuration, the service provider user may specify one or more configuration parameters to control various aspects of appointment availability placements. In addition, the service provider user may provide information indicative of the service provider's current appointment availability or schedule, which may be stored by the AASS 105 for later use in determining appointment availability. The service provider may also provide various other information related to one or more services offered by the service provider (or employees and/or affiliates of the service provider), including information related to one or more services provided (e.g., type, price), one or more service providers who provide the services (e.g., name, licensing, training, location), appointments (e.g., dates and times offered, duration), and/or other information related to the appointment availability placements (e.g., format, targeting, customizations), some of which may be stored by the AASS 105 for later use in providing appointment availability placements.

In addition, the service provider may also interact one or more times with the Appointment Availability Service System 105 in interaction 250a to update the service provider's current appointment availability or schedule (e.g., schedule changes, bookings) or, in some embodiments, otherwise manage the service provider's schedule (e.g., via an electronic calendar or scheduling service provided by the Appointment Availability Service System 105), such that the appointment availability or schedule information stored by the AASS 105 may be kept up-to-date with the service provider's actual appointment schedule and availability. In some embodiments, the AASS 105 may obtain at least some of the service provider's current appointment availability or schedule information from one or more other sources.

In the illustrated example of FIG. 2A, one or more of the appointment availability placements configured by the service provider user (not shown) are to be served by content publisher system 110, such that the one or more appointment availability placements are provided to users of the content publisher system 110 (e.g., client users operating client user systems 120). In some embodiments, as part of configuring one or more appointment availability placements, the service provider user may specify in one or more interactions 250a where to publish one or more appointment availability placements. For example, the service provider user may specifically designate one or more content publisher systems 110 (e.g., Web sites, application services) or advertising network systems 130 from which to serve one or more appointment availability placements, and/or may indicate one or more targeting parameters (e.g., contextual targeting, geographical targeting, audience profile or demographic targeting) which may be used by the Appointment Availability Service System 105 to facilitate automatic determination of where to publish the one or more appointment availability placements.

At some time after the service provider user performs one or more interactions 250a with the Appointment Availability Service System 105 to specify or otherwise configure one or more appointment availability placements, a client user (not shown) operating client user system 120 makes a request 250b to content publisher system 110 to obtain content provided by content publisher system 110. For example, in various embodiments, the content publisher system 110 may provide content publishing services, such as a Web site or other network-based service, with which a client system 120 executing a Web browser or other application may interact to obtain content (e.g., Web pages or other information). Here, the content publisher system 110 of this example may provide content that includes one or more appointment availability placements. In some embodiments, the content may also include one or more other types of placements, such as traditional electronic advertisements (e.g., Web and mobile ads).

In this illustrated example, after the request 250b, the content publisher system 110 determines to provide to the client user system 120 content that includes an appointment availability placement. As such, the content publisher system 110 makes a request 250c to obtain an appointment availability placement (or associated information) that includes current appointment availability information from the Appointment Availability Service System 105. The request 250c may include information provided by the content publisher system 110 (e.g., contextual information of the content being provided by content publisher system 110, user profiles or demographics, geographical location information), and in some embodiments may include information related to one or more appointment availability placements (e.g., an identifier for a placement, a requested format).

In various embodiments, the content publisher system 110 may determine to provide an appointment availability placement to a client user system 120 in various ways. For example, in some embodiments the content publisher system 110 may determine to provide an appointment availability placement to a client user system 120 based on an indication from a client user system 120 requesting such content (e.g., such as based on a current indication or previously indicated desire to receive such information). In addition, in one embodiment, the content publisher system 110 may determine to provide an appointment availability placement to a client user system 120 based on the appointment availability placement (or information indicative of such a placement) being part of advertising inventory of the content publisher system 110.

After the request 250c is received, the Appointment Availability Service System 105 identifies one or more appointment availability placements to provide to the content publisher system 110, determines current appointment availability information of one or more service providers to include in an identified one or more placements, and returns to the content publisher system 110, in interaction 250d, an appointment availability placement 252 that includes information indicative of at least some of the determined current appointment availability of one or more service providers. In particular, in this example, the Appointment Availability Service System 105 determines to provide an appointment availability placement on behalf of the service provider user (not shown) who previously configured the one or more appointment availability placements in interaction 250a, with the current appointment availability placement 252 including information indicative of the service provider user's determined current appointment availability.

In some embodiments, the AASS 105 may determine one or more appointment availability placements to provide to the publisher system 110 in various ways. For example, the AASS 105 may determine to provide an appointment availability placement for a service provider based at least in part on the service provider having specifically designated to publish one or more appointment availability placements to one or more users of content publisher system 110 (e.g., specifically designating a Web site or other network-based application provided by the content publisher system 110).

In addition, the AASS 105 may determine to provide an appointment availability placement for a service provider based at least in part on various targeting parameters specified by the service provider user. For example, the AASS 105 may determine to provide an appointment availability placement 252 on behalf of the service provider based at least in part on a geographical area in which the service provider user provides services. For example, the AASS 105 may identify a geographical location or area (e.g., country, region, state, province, city, neighborhood) of a client user to which the content publisher system 110 is serving an appointment availability placement, and may select to provide an appointment availability placement on behalf of the service provider based at least in part on the service provider providing services to clients located at that location or within that area. In various embodiments, the AASS 105 may indentify a geographical location or area of a client user in various ways, such as based on geographical location information provided in request 250c. In addition, the AASS 105 may determine to provide an appointment availability placement for a service provider based on various other targeting parameters (some of which may be specified by the service provider user, content publisher system), such as factors related to client profile or demographics, context in which the appointment availability placement is to be provided (e.g., subject matter of the content being provided by the content publisher system 110), etc.

The AASS 105 may also determine to provide an appointment availability placement 252 on behalf of a service provider user based on a request for appointment availability placement specifically identifying the placement or various aspects related to the placement (e.g., identifying a service provider, a service).

In one embodiment, the AASS 105 may also determine to provide an appointment availability placement for a service provider based on automatic optimizations preformed by the AASS 105 to potentially increase the likelihood that an appointment offered in an appointment availability placement will be booked, such as by providing an appointment availability placement that is determined to be potentially relevant or otherwise of interest to the client users of the content publisher system 110. The AASS 105 may determine whether one or more appointment availability placements is potentially relevant based on various optimization factors (e.g., client user profile/demographics, client bookings, content provided by the content publisher system, historical usage, NB testing, multivariate testing) that one or more appointment availability placement may be potentially relevant or of interest to the client users of the content publisher system.

After the AASS 105 determines one or more appointment availability placements to provide to the content publisher system 110, the AASS 105 may then determine current appointment availability of a service provider to perform services on behalf of an existing or potential client, such that the appointment availability placement includes information that is indicative of a service provider's current appointment availability. As part of determining current appointment availability of one or more service providers, the AASS 105 identifies one or more appointments (e.g., times that a service provider may be available for booking to perform one or more services on behalf of a client) that are currently available, such as by analyzing current appointment availability or schedule information stored on the AASS 105 to identify one or more appointments or times that a service provider may be available to perform one or more services. In other embodiments, the AASS 105 may determine the current appointment availability of service provider by interacting with one or more other systems, such as service provider user system 115 or optional other third party system 130, to obtain such information of current availability.

As part of identifying one or more appointments that are currently available from a service provider, the AASS 105 may determine the current appointment availability of a service provider in accordance with the various configuration parameters specified by that service provider. For example, the AASS may determine current appointment availability for appointments for one or more specific services indicated by the parameters, or may determine current appointment availability for appointments that are available at (or during) one or more candidate times indicated by the parameters, and/or may otherwise determine current appointment availability in accordance with various other configuration parameters (e.g., pricing, specials). In some embodiments, a service provider may indicate several affiliates or employees of the service provider user that may perform various services, and in such embodiments, the AASS 105 may determine current appointment availability for a service provider based at least in part on one or more of the affiliate's or employee's current availability to provide one or more services.

The AASS 105 may determine the current appointment availability of a service provider based on various automatic optimization preformed by the AASS 105 to potentially increase the likelihood that an appointment offered in an appointment availability placement will be booked. For example, such optimizations may be used to identify one or more services of a service provider that may be relevant or of interest to a potential recipient of an appointment availability placement, based on various optimizing factors (e.g., profile or demographics of the potential recipient). For example, such optimizations may include, intra alia: determining services that are related to the context in which the appointment availability placement is published (e.g., subject matter of Web site), determine services based on the intended recipient having booked similar services in the past (e.g., such bookings potentially being indicative of a recipients interest), determining services that are different than services that the recipient has recently or currently booked (e.g., a recipient may not be likely to need a service that has been recently or is currently booked), determining services that the recipient may be likely to need (e.g., such as offering seasonal services during that season, offering services if some amount of time has past since a recipient last booked a recurring service, etc), etc.

Such optimizations may also be used to identify or otherwise determine one or more other aspects of appointment availability based on one or more of various optimization factors. For example, the AASS 105 may determine a particular date or time (e.g., a day of the week, a time of the day) of availability for an appointment, a duration of an appointment, a price of an appointment, a particular individual or service provider who performs one or more services in an appointment, a location of an appointment (e.g., if multiple locations possible), etc. For example, the AASS 105 may determine to offer current appointment availability for appointments that are available at particular times at which the recipient may be more likely to book, such as based on the recipient displaying a pattern of booking appointments available at particular times, based on the recipient having likely availability at particular times (e.g., a recipient who works during week days may be more likely to book appointments available in evenings or on weekends), based on the recipient not already having an appointment booked at that time, etc.

In one embodiment, the optimizations may be used to determine a particular number of appointments to offer to a recipient of an appointment availability placement in the placement. For example, in some embodiments, the AASS 105 may determine to include multiple available appointments in an appointment availability placement (e.g., such as multiple appointments for the same service available at different times or from different individuals who perform the service; multiple appointments for different appointments; etc.) In some embodiments, such optimizations may be based on historical usage patterns of one or more recipients of appointment availability placements (e.g., based on what has been effective in the past) or various types of testing (e.g., NB or multivariate testing).

The various optimization factors used by an embodiment of the AASS 105 may include, factors related to an intended recipient or group of recipients of a placement (e.g., user profiles, demographics, geographical location); context in which a placement is provided; a service provider (e.g., type, geographical location, service provider preferences or constraints); a service (e.g., type, duration, price); medium or format of the placement (e.g., graphics-based, text-based, rich media, video, audio); historical factors (e.g., a client's current or previous bookings, prior use or effectiveness of previously provided placements); NB or multivariate testing; etc. Some of the optimization factors are based on information that may be provided to or obtained by the AASS 105 in various ways, such as discussed elsewhere.

In some embodiments, when the AASS 105 determines that there is no current appointment availability for an identified appointment availability placement of a service provider, the AASS 105 may identify other appointment availability placements of other service providers to provide in the current appointment availability placement 252 and determine current appointment availability for the other service providers. In other embodiments, the AASS 105 may instead provide general information related to the service provider (e.g., general advertising information) in the current appointment availability placement 252, etc.

After identifying one or more appointments that are currently available from a service provider, the AASS 105 may determine appointment availability information to include in the appointment availability placement 252. The information may include one or more indications of appointments that are currently available, such as indications of times and/or dates that an available appointment may occur, a service that is provided during an appointment (e.g., type), a service provider who provides the appointment (e.g., name), a price, and/or varying other information (e.g. related to services, appointments, service providers). In some embodiments, the AASS 105 determines which information to include in an appointment availability placement based in part on various configuration parameters specified by a service provider, such as in interactions 250a. In other embodiments, various optimizations may be used to determine what information to include in an appointment availability placement, such as whether or not to include information indicative of a price, or include various other details related to an available appointment, such as based on historical usage and/or usage testing. The appointment availability information may be combined with optional other information to include in an appointment availability placement 252, such as images, ad copy, contact information, etc. (some which may have been specified by a service provider).

In various embodiments, the appointment availability placement 252 includes information indicative of current appointment availability of one or more service providers, and may be one or more files or other grouping of information generated by the AASS 105. The appointment availability placement may include data, code, references (e.g., Uniform Resource Identifiers “URI”), and/or other information. In some embodiments, the appointment availability placement 252 may be formatted in various ways, such as using one or more markup languages (e.g., HTML, XML) or other formats (e.g., text, images, rich media, widgets, gadgets, executable code) as appropriate for providing to the content publisher system 110. In some embodiments, the formatting may be dictated by various configuration parameters set by a service provider user and/or may be determined based on various other factors, such as optimization factors, and may include various aspects related to the presentation and/or interactivity of a placement (e.g., layout, color, size, aspect, font, graphics, calls to action, user controls). As one illustrative example, the appointment availability placement 252 may be formatted as an HTML file that includes various text, graphics, and user controls (e.g., hyperlinks, buttons, form fields).

In addition, in some embodiments, the appointment availability placement 252 may include instructions and/or other data that enable a recipient of the appointment availability placement 252 to interactively book one of the appointments indicated in the appointment availability placement, as described elsewhere. In still other embodiments, the current appointment availability placement 252 may include references, code, or other data that cause or allow a client user system 120 to obtain at least some of the appointment availability information presented by the appointment availability placement (e.g. executable code, URIs).

In the illustrative example of FIG. 2A, the current appointment availability placement 252 generated by the AASS 105 includes information indicative of one or more appointments that were determined by the AASS 105 to be currently available from the service provider user (not shown) who configured the one or more placements in interactions 250a.

After the content publisher system 110 receives the current appointment availability placement 252 in interaction 250d, the current appointment availability placement 252 may be incorporated into content 253 provided by the content publisher system 110 (incorporated placement indicated as 253a). In some embodiments, the appointment availability placement 252 may include information (e.g., data, text, code, images, references) that may be incorporated directly into content provided by the content publisher system. In one embodiment, the current appointment availability placement 252 may include HTML code that may be incorporated directly into an HTML file of the content publisher system 110 (e.g., content 253). In some embodiments, the content publisher system 110 may format (or reformat) the current appointment availability placement 252 received in interaction 250d for inclusion in content 253. In other embodiments, the content publisher system 110 may provide the current appointment availability placement 252 directly to the client user system without incorporating such data into other content provided by the content publisher system 110.

In interaction 250e, the content publisher system 110 provides to the client user system 120 content 253 that includes an appointment availability placement 253a with current appointment availability information of a service provider. After the content 253 has been received by the client user system 120, the content 253 with placement 253a may be presented to a client user (not shown) of the system 120. For example, in some embodiments, the content 253 may include instructions or other data that enables or causes the client user system 120 to display content 253 to the client user, such as in a user interface of a Web browser or other application executing on the client user system 120.

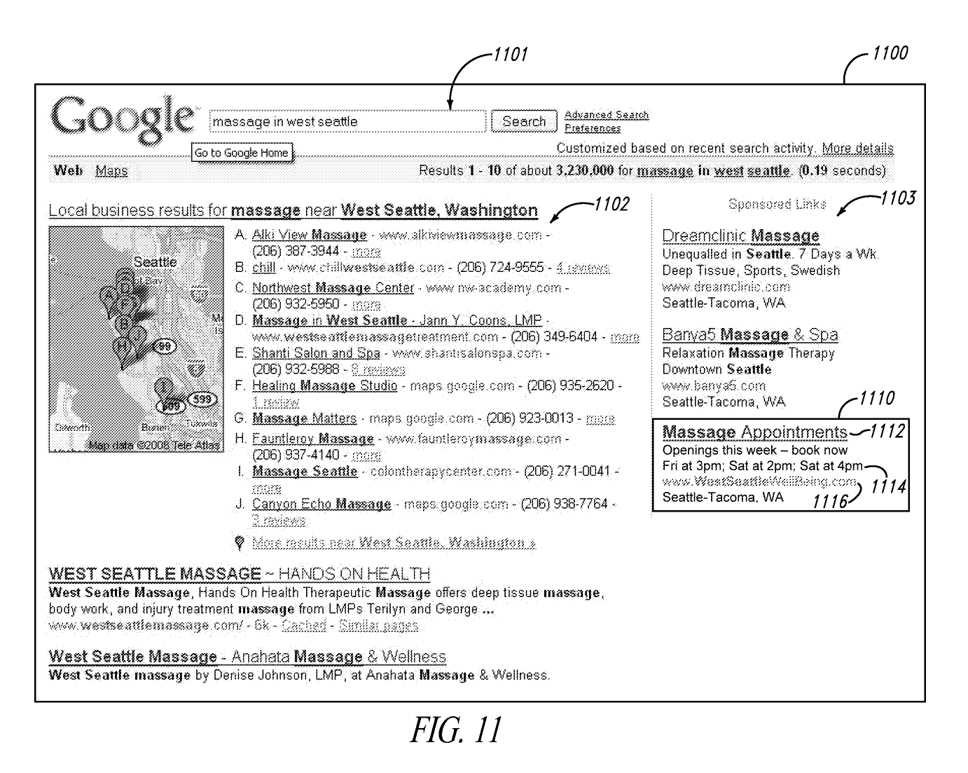

As one illustrative example, the content 253 may display a Web page of a Web site that includes the appointment availability placement 253a as a Web advertisement (e.g., banner ad, button ad, skyscraper ad, rich media, text ad, widget, gadget), such as illustrated in various embodiments of FIGS. 11-14. As another illustrative example, the content 253 may be provided as part of an online Web-based calendar service (e.g., Google™ Calendar, Yahoo! Calendar), which may allow users to record dates and/or times of one or more events in an electronic calendar, with the appointment availability placement 253a being displayed within the context of the calendar service. For example, in some such embodiments, the appointment availability placement 253a may be displayed corresponding to a particular date (or a particular time) presented by the calendar that corresponds to a time that an appointment indicated by the placement may be available (e.g., if an appointment indicated by the appointment availability placement is available on January 3rd, the appointment availability placement may be displayed corresponding to January 3rd on the calendar), or may otherwise appear as a (potential) event or opportunity within the context of the calendar service. In other embodiments, the content may be presented to the client user in various other ways, such as an audio playback, etc.

As previously noted, an appointment availability placement may include instructions and/or other data that enables a recipient of the appointment availability placement to interactively book one of the appointments indicated in the appointment availability placement. For example, the appointment availability placement 253a may include various user controls (e.g., hyperlinks, buttons, forms) with which the client user (not shown) operating client user system 120 may interact to book or request a booking for one of the currently available appointments. In this illustrated example of FIG. 2A, the client user (not shown) interacts one or more times with such controls to select a currently available appointment from the appointment availability placement 253a to book (or request a booking), with indications of such selection sent to the AASS 105 in interaction 250f (e.g., by sending information indicative of the a selected appointment, etc). In some embodiments, the client user (not shown) may interact one or more times with the AASS 105 in interaction 250f to complete a booking. In the example of FIG. 2, the client user (not shown) has selected to book a currently available appointment form the service provider user (not shown) operating service provider user system 115.

After the AASS 105 receives an indication of the client user's selection, the AASS 105 may update appointment availability or schedule data of the service provider user that may be stored by the AASS 105, such as to indicate that the client user has booked (or requested a booking) for a particular appointment of the service provider user. Of note, in some cases, if the appointment booked by the client user is now full as a result of the client user's booking (e.g., if the appointment is only for a single client), then the AASS 105 may update the appointment availability or schedule data in such a manner that indicates that the appointment is no longer available for booking by others, and as such will not be published in future appointment availability placements (unless the appointment becomes available again). The AASS 105 may also perform various other actions as a result of the booking, such as updating historical usage tracking (e.g., for future use in optimizing appointment availability placement distribution), etc.

The AASS 105 may also optionally notify the service provider user (not shown) operating service provider user system 115 of the booking in optional interaction 250g, such as by updating a calendar or schedule of the service provider stored on service provider user system 115 (or optional other third party system 130, although not illustrated here) and/or sending an email, text message, SMS message, or other information indicative of the booking. In addition, at some time after the appointment has been successfully booked by the client user, the AASS 105 may optionally remind the service provider user, in interaction 250g, and the client user, in interaction 250h, of the upcoming appointment (e.g., via electronic calendars of the various users, email, text message, SMS).

In other embodiments, appointment availability placements may be published by the optional advertising network system 125, instead or in addition to content publisher system 110. In such an embodiment, the content publisher system 110 may interact with the optional advertising network system 125 to obtain appointment availability placements to provide to the client user system 120, and the optional advertising network system 125 may interact with the AASS 105 in a manner similar to those of interactions 250c and 250d to obtain current appointment availability data. In addition, in other embodiments, various of the described functionality of the AASS 105 and content publisher system 110 (and/or optional advertising network system 125) may be part of a single system. For example, the AASS 105 may also include functionality to provide content publishing services to one or more client users (operating client user system 120), and may include appointment availability placements with current appointment availability information with the provided content.

In addition, in some embodiments, the content publisher system 110 may provide data or instructions to the client user system 120 that enables or instructs the client user system 120 to obtain current appointment availability placements directly from that AASS 105. For example, the content publisher system 110 may provide a URI or a URL (Uniform Resources Locator) to the client user system that enables a Web browser or other application of the client user system to interact with the AASS 105 to obtain current appointment availability placements.

FIG. 2B illustrates interactions between the same systems of FIG. 2A. In interaction 260a, the service provider user (not shown) operating the server provider user system 115 initiates one or more interactions with the AASS 105 to specify or otherwise configure one or more appointment availability placements for the service provider user and/or to provide information indicative of the service provider users current appointment availability, such as in a manner similar to that described with respect to interaction 250a (FIG. 2A).

After the service provider user configures one or more appointment availability placements, an indication of the one or more appointment availability placements, such as placement data 261, is sent to the content publisher system 110 in interaction 260b, such that the placement data 261 may be used by the content publisher system 110 to serve one or more appointment availability placements on behalf of the service provider user (not shown). In some embodiment, the placement data 261 may be sent to the content publisher system 110 based on the service provider user having specifically designated the content publisher system 110 to serve appointment availability placements, and/or based on various targeting parameters specified by the service provider user (e.g., geographical location). In other embodiments, the service provider user may provide the placement data 261 to the content publisher system 110 directly, such as via interactions (not shown) between the service provider user system 115 and the content publisher system 110.

The placement data 261 may include various indications, such as identifiers, instructions, and/or other data, that may be used by the content publisher system 110 to serve appointment availability placements on behalf of the service provider user. After the content publisher system receives placement data 261, the content publisher system may store the data for later use. For example, in some embodiments, the placement data 261 may be stored as advertisement inventory of the content publisher system 110, such that the content publisher may from time-to-time determine to provide an appointment availability placement on behalf of the service provider user as an advertisement (e.g., such as an advertisement accompanying content of the content publisher service 110).

The placement data 261 may include various information related to one or more appointment availability placements of the service provider user. For example, in some embodiments, the placement data 261 may contain identifiers, instructions, or other data that may be used by the content publisher system 110 to dynamically obtain current appointment availability information of the service provider user (not shown), such as at the time that the appointment availability placement is served to a user of the content publisher system 110. The placement data 261 may also include various other information related to the one or more appointment availability placements of the service provider, such as information to be included in one or more appointment availability placements (e.g., text, instructions, images), formatting or layout information, targeting information (e.g., geographical targeting, user profiling/demographics), etc.

At some time after interaction 260b, a client user (not shown) operating client user system 120 makes a request 260c to content publisher system 110 to obtain content provided by content publisher system 110, such as in a manner similar to interaction 250b (FIG. 2A). In response to the request, the content publisher system 110 determines to provide content that includes an appointment availability placement indicated by placement data 261 to the client user (not shown) operating client user system 120. For example, the content publisher system 110 may determine to provide an appointment availability placement associated with placement data 261 by processing an advertisement inventory of the content publisher system and selecting the appointment availability placement associated with the placement data 261 (e.g., such on an advertisement rotation, contextual targeting, geographical targeting).

After the content publisher system 110 determines to provide an appointment availability placement related to placement data 261, the content publisher system 110 makes a request 260d to obtain from the AASS 105 current appointment availability data associated with the one or more appointment availability placements corresponding to the placement data 261, such as to obtain current appointment availability information of the service provider user. In the request 260d, the content publisher system 110 may include various information. For example, the request may include one or more identifiers that may be used by the AASS 105 to obtain current appointment availability associated with placement data 261, and/or other information from placement data 261. The request may also include various other information, such as contextual information of the content being provided by content publisher system 110, user profiles or demographics, geographical location information, etc.

After the request 250d is received, the AASS 105 determines to provide current appointment availability information corresponding to the one or more appointment availability placements corresponding to the placement data 261, such as based on information provided with the request 250d. The AASS 105 then determines current appointment availability information of the service provider user (identified by the request) to include in one or more appointment availability placements, such as described elsewhere. In interaction 250e, the AASS 105 returns to the content publisher system 110, current appointment availability data 262 which includes appointment availability information indicative of at least some of the determined current appointment availability of the service provider user.

The current appointment availability data 262 may include data, code, references (e.g., Uniform Resource Identifiers “URI”), and/or other information, some of which is indicative of current appointment availability of the service provider user, such as similar to current appointment availability placement 252 (FIG. 2A). The current appointment availability data 262 may be incorporated into content provided by the content publisher system, such as content 263 with current appointment availability placement 263a, and returned to the client user system 120. In some embodiments, the placement data 261 may include formatting or layout information (or instructions) that may be used by the content publisher system 110 to generate the appointment availability placement 263a with current appointment availability data 262 for inclusion in content 263. In addition, in some embodiments, at least some of the placement data 261 may also be incorporated into the appointment availability placement 263a, such as for example information that is relatively static or changes infrequently (e.g., a service provider name, location, contact information, ad copy, images).

In interaction 260f, the content publisher system 110 provides to the client user system 120 content 263 that includes an appointment availability placement 263a with current appointment availability information of the service provider user (not shown). After the content 263 has been received by the client user system 120, the content 263 may be presented to a client user (not shown) of the system 120, such as in a user interface of a Web browser or other application executing on the client user system 120. The client user (not shown) may interactively book an appointment from the appointment availability placement 263a presented to the user, with interactions 260g, 260h, and 260i occurring in a manner similar to as described with respect to interactions 250f (FIG. 2A), 250g (FIG. 2A), and 250i (FIG. 2A), respectively.

In an alternative embodiment, the AASS 120 may from time-to-time provide current appointment availability information, such as the current appointment availability data 262, to the content publisher system 110. The content publisher system may store the provided current appointment availability data 262 for later use in providing appointment availability placements. For example, in some such embodiments, the content publisher system 110 may access the stored current appointment availability data 262, rather than interact with the AASS 105, when serving an appointment availability placement. For example, in some such embodiments, the current appointment availability data 262 may be periodically provided to the content publisher system 110, such as hourly, daily, etc., with the currentness of the data being dependent upon the frequency of the providing.

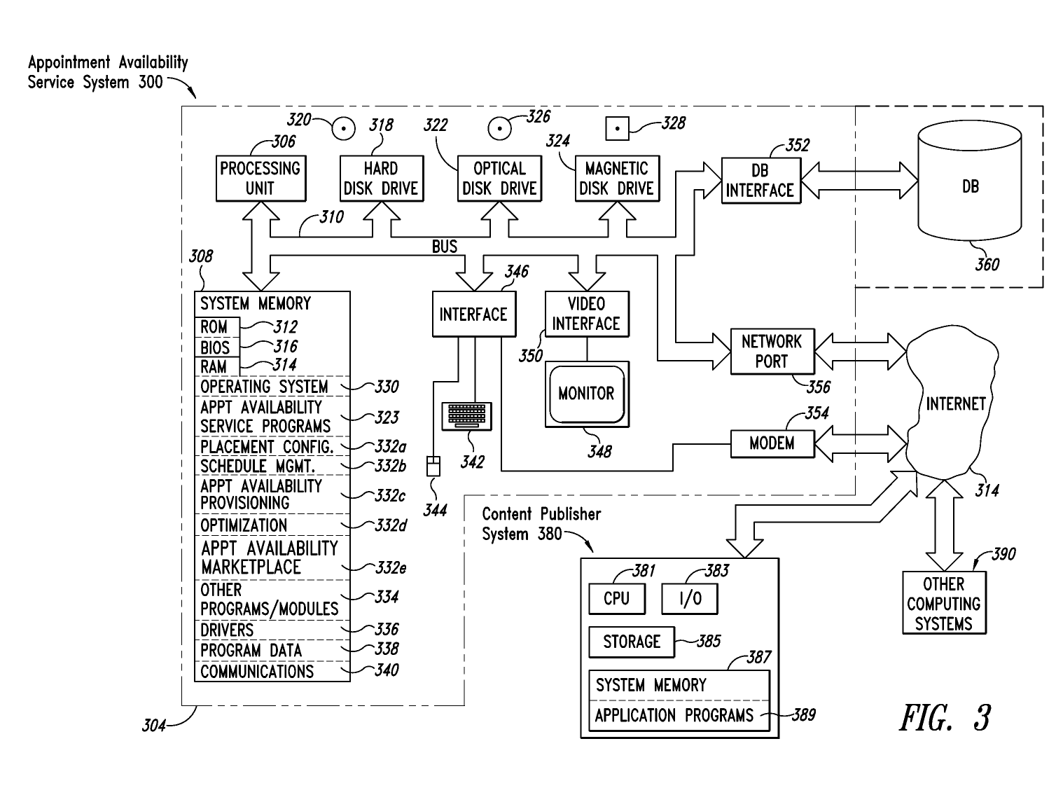

FIG. 3 and the following discussion provide a brief, general description of suitable systems in which the various illustrated embodiments can be implemented, such as appointment availability service system 300, content publisher system 380, and various other computing systems 390. The Appointment Availability Service System 300 may, for example, implement the various functions and operations discussed above in reference to the Appointment Availability Service System 105 of FIG. 1 and FIGS. 2A-2B. The content publisher service system 380 may, for example, implement the various functions and operations discussed above in reference to the content publisher systems 110 of FIG. 1 and FIGS. 2A-2B, and the other computing systems 390 may, for example, implement the various functions and operations of one or more other systems discussed above (e.g., user computing systems 115 and 120, optional advertising network systems 125, and optional other third party systems 130 of FIG. 1).

Although not required, some portion of the embodiments will be described in the general context of computer-executable instructions or logic, such as program application modules, objects, or macros being executed by a computer. Those skilled in the relevant art will appreciate that the illustrated embodiments as well as other embodiments can be practiced with other computing system configurations, including handheld devices for instance Web enabled cellular phones or PDAs, multiprocessor systems, microprocessor-based or programmable consumer electronics, personal computers (“PCs”), network PCs, minicomputers, mainframe computers, television-based systems (e.g., set-top boxes, personal/digital video recorders, interactive televisions), and the like. The embodiments can be practiced in distributed computing environments where tasks or modules are performed by remote processing devices, which are linked through a communications network. In a distributed computing environment, program modules may be located in both local and remote memory storage devices.

The Appointment Availability Service System 300 may include one or more appointment availability service server computing systems 304 (only one illustrated in FIG. 3). The appointment availability service server computing systems 304 may take the form of a conventional PC or server executing instructions. The appointment availability service server computing system 304 includes a processing unit 306, a system memory 308 and a system bus 310 that couples various system components including the system memory 308 to the processing unit 306. The appointment availability service server computing system 304 will at times be referred to in the singular herein, but this is not intended to limit the embodiments to a single system, since in certain embodiments, there will be more than one system or other networked computing device involved. Non-limiting examples of commercially available systems include, but are not limited to, an 80×86 or Pentium series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 306 may be any logic processing unit, such as one or more central processing units (CPUs), microprocessors, digital signal processors (DSPs), application-specific integrated circuits (ASICs), field programmable gate arrays (FPGAs), etc. Unless described otherwise, the construction and operation of the various blocks shown in FIG. 3 are of conventional design. As a result, such blocks need not be described in further detail herein, as they will be understood by those skilled in the relevant art.

The system bus 310 can employ any known bus structures or architectures, including a memory bus with memory controller, a peripheral bus, and a local bus. The system memory 308 includes read-only memory (“ROM”) 312 and random access memory (“RAM”) 314. A basic input/output system (“BIOS”) 316, which can form part of the ROM 312, contains basic routines that help transfer information between elements within the appointment availability service server computing system 304, such as during start-up. Some embodiments may employ separate buses for data, instructions and power.

The appointment availability service server computing system 304 also includes a hard disk drive 318 for reading from and writing to a hard disk 320, and an optical disk drive 322 and a magnetic disk drive 324 for reading from and writing to removable optical disks 326 and magnetic disks 328, respectively. The optical disk 326 can be a CD or a DVD, while the magnetic disk 328 can be a magnetic floppy disk or diskette. The hard disk drive 318, optical disk drive 322 and magnetic disk drive 324 communicate with the processing unit 306 via the system bus 310. The hard disk drive 318, optical disk drive 322 and magnetic disk drive 324 may include interfaces or controllers (not shown) coupled between such drives and the system bus 310, as is known by those skilled in the relevant art. The drives 318, 322, 324, and their associated computer-readable media 320, 326, 328, provide nonvolatile storage of computer-readable instructions, data structures, program modules and other data for the appointment availability service server computing system 204. Although the appointment availability service server computing system 304 employs hard disk 320, optical disk 326 and magnetic disk 328, those skilled in the relevant art will appreciate that other types of computer-readable media that can store data accessible by a computer may be employed, such as magnetic cassettes, flash memory cards, Bernoulli cartridges, RAMs, ROMs, smart cards, etc.

Program modules can be stored in the system memory 308, such as an operating system 330, one or more Appointment Availability Service programs 332, other programs or modules 334, drivers 336 and program data 338.

The Appointment Availability Service programs 332 may, for example, include appointment availability placement configuration logic 332a, schedule management logic 332b, appointment availability provisioning logic 332c, optimization logic 332d, and appointment availability marketplace logic 332e, such as discussed in detail with respect to FIGS. 1 and 2. The logic 332a-332e may, for example, be stored as one or more executable instructions. Such logic 332 may execute the methods or processes set out in the various flowcharts discussed elsewhere.

The system memory 308 may also include communications programs 340, for example a server program and/or a Web client or browser program that permit the appointment availability service server computing system 304 to access and exchange data with other systems or components, such as other computing systems 390 (e.g., content publisher systems 110, user systems 115 and 120, optional advertising network systems 125, optional other third party systems 130, telecommunications devices 135 and/or PDAs 140 of FIG. 1) as described below.

While shown in FIG. 3 as being stored in the system memory 308, the operating system 330, Appointment Availability Service programs 332, other programs/modules 334, drivers 336, program data 338 and communications programs 340 can be stored on the hard disk 320 of the hard disk drive 318, the optical disk 326 of the optical disk drive 322 and/or the magnetic disk 328 of the magnetic disk drive 324. A user may enter commands and information into the appointment availability service server computing system 304 through input devices such as a touch screen or keyboard 342 and/or a pointing device such as a mouse 344. Other input devices can include a microphone, joystick, game pad, tablet, scanner, biometric scanning device, etc. These and other input devices are connected to the processing unit 306 through an interface 346 such as a universal serial bus (“USB”) interface that couples to the system bus 310, although other interfaces such as a parallel port, a game port or a wireless interface or a serial port may be used. A monitor 348 or other display device is coupled to the system bus 310 via a video interface 350, such as a video adapter. Although not shown, the appointment availability service server computing system 304 can include other output devices, such as speakers, printers, etc.

The appointment availability service server computing system 304 operates in a networked environment 100 (FIG. 1) using one or more of the logical connections to communicate with one or more remote computers, servers and/or devices via one or more communications channels, for example, one or more networks, for example the Internet and/or Web 314. These logical connections may facilitate any known method of permitting computers to communicate, such as through one or more LANs and/or WANs, such as the Internet. Such networking environments are well known in wired and wireless enterprise-wide computer networks, intranets, extranets, and the Internet. Other embodiments include other types of communication networks including telecommunications networks, cellular networks, paging networks, and other mobile networks.

When used in a WAN networking environment, the appointment availability service server computing system 304 may include a modem 354 for establishing communications over the WAN, for instance the Internet or Web 314. The modem 354 is shown in FIG. 3 as communicatively linked between the interface 346 and the Internet or Web 314. Additionally or alternatively, another device, such as a network port 356, that is communicatively linked to the system bus 310, may be used for establishing communications over the Internet or Web 314. Further, one or more network interfaces 352, that are communicatively linked to the system bus 310, may be used for establishing communications over a LAN. In particular, a database interface 352 may provide communications with one or more databases stored on one or more computer-readable media 360.

In a networked environment 100 (FIG. 1), program modules, application programs, or data, or portions thereof, can be stored and/or executed in other server computing systems, such as in a distributed manner. Those skilled in the relevant art will recognize that the network connections shown in FIG. 3 are only some examples of ways of establishing communications between computers, and other connections may be used, including wirelessly. In some embodiments, program modules, application programs, or data, or portions thereof, can even be stored in one of the user systems 115 and 120 (FIG. 1) or devices 135, 140, for example as a “cookie” stored on a computer-readable storage medium of the client computing system or device, etc.

For convenience, the processing unit 306, system memory 308, network port 356 and interfaces 346, 352 are illustrated as communicatively coupled to each other via the system bus 310, thereby providing connectivity between the above-described components. In alternative embodiments of the appointment availability service server computing system 304, the above-described components may be communicatively coupled in a different manner than illustrated in FIG. 3. For example, one or more of the above-described components may be directly coupled to other components, or may be coupled to each other, via intermediary components (not shown). In some embodiments, system bus 310 is omitted and the components are coupled directly to each other using suitable connections.

In the illustrated embodiment, the content publisher system 380 has components that include a CPU 381 (or other processing unit), various I/O components 383, storage 385, and memory 387. The I/O components may include a display, a network connection, a computer-readable media drive, and/or other I/O devices (e.g., a mouse, keyboard, speakers). The various components of the content publisher system 380 may be similar to one or more of the components discussed with respect to the Appointment Availability Service System 300. The content publisher system 380 may also include various other components, such as similar to one or more components described with respect to the Appointment Availability Service System 300, but are not illustrated for the sake of brevity. Program modules can be stored in the system memory 387, such as one or more application programs 389. The application programs 389 may, for example, include application logic to provide various services and functionality of a content publisher system, such as discussed in FIG. 1. The application logic may, for example, be stored as one or more executable instructions and may execute the methods or processes set out in the various flow charts discussed elsewhere.

The various other computing systems 390 may include components such as a CPU or other processing unit, various I/O components, storage, and memory, which are not illustrated for the sake of brevity.

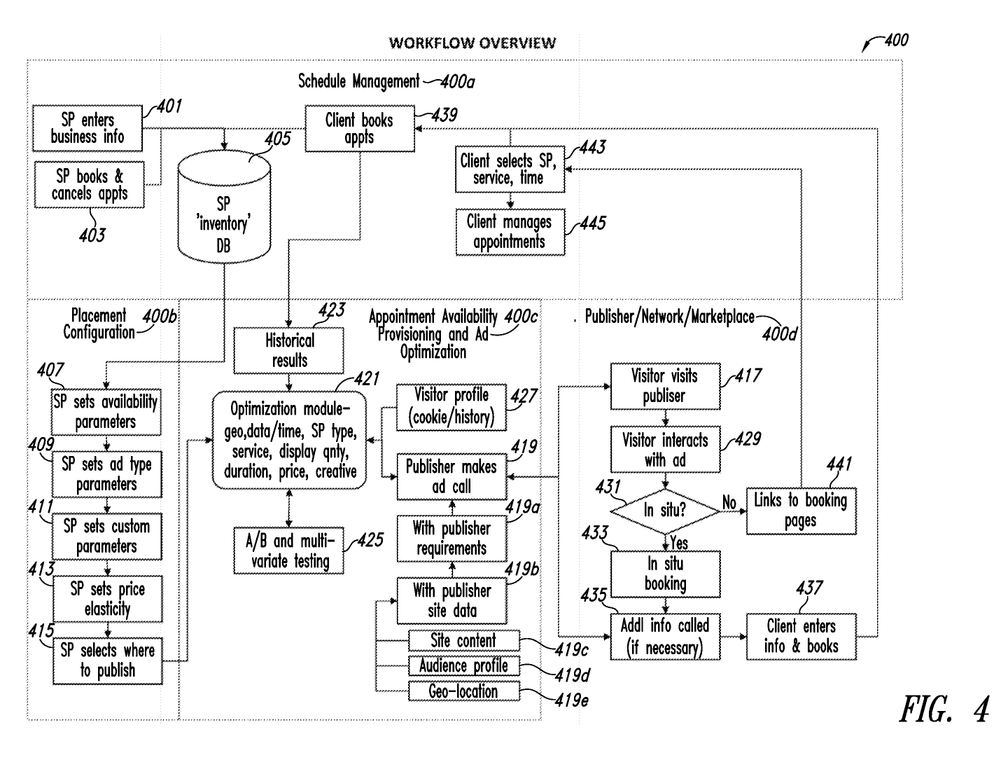

FIG. 4 is a workflow diagram 400 that illustrates an overview of propagating current appointment availability, according to one illustrated embodiment.

The workflow diagram 400 illustrates various sequences, operations, and interactions that may occur as part of propagating current appointment availability of service providers, according to one illustrated embodiment. An embodiment of the Appointment Availability Service System 105 (FIGS. 1 and 2A-2B) may execute an Appointment Availability Service that provides functionality that includes schedule management 400a, placement configuration 400b, and appointment availability provisioning and ad optimization 400c, although various of the functionality may be provided by one or more other systems, such as one or more of the other systems described in FIGS. 1 and 2. Content publisher, advertising network, and/or appointment availability marketplace 400d may include functionality provided by the content publisher systems 110 (FIGS. 1 and -2B), the optional advertising network systems 125 (FIGS. 1 and 2A-2B), and the optional other third party systems 130 (FIGS. 1 and 2A-2B), although various of the functionality may be provided by one or more other systems, including and embodiment of the Appointment Availability Service System. Service providers may interact with various of the systems via one or more of the service provider user systems 115 (FIGS. 1 and 2A-2B), and existing or potential clients of service providers (referred to variously as “visitors” and/or “clients” in some embodiments described below) may interact with various of the systems via one or more of the client user systems 120 (FIGS. 1 and 2A-2B).

At 401, a service provider interacts one or more times with the schedule management functionality 400a to enter business information and appointment availability information of the service provider. For example, the service provider may interact at 401 to designate one or more services offered by the service provider and one or more times that the service provider offers to perform the one or more services (e.g., appointment times). In some embodiments, the service provider may also specify one or more individuals who may perform services provided by the service provider (e.g., such as affiliates and/or employees of the service provider), as well as other information described elsewhere. The business information entered by the service provider may include various other information such as a geographical location/area where the service provider performs services, business name, contact information (e.g., address, phone number, email address, Web site address), etc. At 403, the service provider interacts one or more times with the schedule management functionality 400a to manage current appointment availability information of the service provider, such as to indicate when appointments of the service provider are booked, cancelled, etc.

After a service provider interacts one or more times at 401 and 403, at least some of information provided by the service provider may be stored in a service provider inventory database 405, such as to maintain data or other information indicative of a service provider's current appointment availability to perform one or more services for existing or potential clients. In the illustrated example, a client of a service provider may also interact one or more times with the schedule management functionality 400a to book or cancel appointments with one or more service providers (e.g., at 439, discussed below), with information indicative of such bookings/cancellations being stored in the service provider inventory database 405. Such interactions at 401, 403 and 439 (discussed below) help maintain the currentness of a service provider's appointment availability.

At 407 to 415, a service provider may interact one or more times with the placement configuration functionality 400b to set (or otherwise specify) various parameters that configure one or more appointment availability placements to dynamically advertise or otherwise publish current appointment availability of the service provider. In some embodiments, at least some of such configuration parameters may also be used to configure one or more aspects regarding how a service provider's appointment availability may be provided in an appointment availability marketplace.

At 407, the service provider may set one or more appointment availability parameters that specify or otherwise control what appointment availability information may be published in appointment availability placements. For example, such parameters may specify one or more services that may be published in appointment availability placements; one or more service providers that may be published in appointment availability placements; one or more candidate appointment times that may be published in an appointment availability placement; durations of various appointments to publish; etc.

At 409, the service provider may set one or more parameters to specify one or more types of appointment availability placements that the service provider wishes to provide (e.g., a banner ad, a button ad, a skyscraper ad, a text ad, a SMS ad, rich media, web feed, widget, gadget). In some embodiments, the service provider may specify that current appointment availability information of the service provider may be provided in an appointment availability marketplace.

At 411, the service provider may set one or more of various custom parameters for one more appointment availability placements. For example, the service provider may customize various aspects of how an appointment availability placement may appear (e.g., size, color, font, images). The service provider may also specify various other custom information, such as ad copy (e.g., slogans), etc.

At 413, the service provider may set one or more parameters to configure price elasticity for one or more appointment availability placements, such that pricing for one or more appointments published in appointment availability placements may be dynamically determined according to such parameters, such as dynamically determined at or near the time that the appointment availability for the appointment is served to a recipient of the appointment availability placement. For example, in some embodiments, such parameters may be used to dynamically adjust prices of appointments (e.g. raise or lower prices) offered in appointment availability placements based on various factors, such as supply and demand; competitor prices; appointment times; service types, demographic or profile of an existing or potential client, etc.

At 415, the service provider may select where to publish appointment availability placements. For example, the service provider may select one or more content publishers (e.g., Websites or other network-based application services) and/or advertising networks, such that the content publisher and/or advertising networks may serve appointment availability placements to one or more users. In some embodiments, a service provider may specify one or more targeting parameters, such that appointment availability placements may be targeted to one or more intended recipients in various situations. For example, the targeting parameters may specify or otherwise indicate a context in which appointment availability placements are to be served (e.g., subject matter of content with which appointment availability placements are to be provided), a geographical area of intended recipients (e.g., national, regional, city, neighborhood), a type of intended recipients (e.g., demographic, profile), etc.

After a service provider configures or otherwise selects where to publish one or more appointment availability placements, the appointment availability provisioning and ad optimization functionality 400c may dynamically provide the one or more configured appointment availability placements with current appointment availability information to existing or potential clients of the service provider in various ways.

At 417, a visitor (e.g., a client user) “visits” a content publisher 400c that serves appointment availability placements to users of the publisher. For example, the visitor may be interacting with a content publisher that provides a Web site that includes appointment availability placements as Web advertisements (e.g., such as banner ads), or interacting with another type of service provided by the content publisher that includes providing appointment availability placements as advertisements.

At some time while the visitor “visits” the content publisher at 417, the content publisher makes an “ad call” at 419 to obtain an appointment availability placement with current appointment availability data, such as from a service that provides appointment availability provisioning and ad optimization functionality 400c (e.g., such as the AASS 105). As part of the “ad call” at 419, the publisher may provide various information, such as, publisher requirements 419a (e.g., such as formatting requirements) and publisher site data 419b. The publisher site data 419b may include site content 419c (e.g., contextual information related to the site), audience profile 419d (e.g., profile/demographic of users/visitors of the publisher site), and geographical location data 419e (e.g., such as a geographical location to which the publisher caters to and/or a location of a user/visitor who is visiting the publisher at 417).

In response to the “ad call” at 419, the optimization module 421 may determine current appointment availability information to provide in an appointment availability placement, such as based on one or more of the configuration parameters specified by the service provider at 407 to 415, the publisher requirements 419a, the publisher site data 419b, historical results 423, A/B and multivariate testing 425, and/or a visitor profile 427 (e.g., based on a cookie provided by an application of the visitor). Using such information, the optimization module 421 may determine from the service provider availability information stored in the service provider inventory database 405 one or more appointments of one or more service providers that are currently available for booking, such that the appointments may be provided in the appointment availability placement. As part of determining one or more currently available appointments, the optimization module may determine or otherwise choose various aspects of the appointments, such as the geographical location of a currently available appointment to provide, a date/time of a currently available appointment to provide, a type of service or service provider of a currently available appointment to provide, a number of currently available appointments to provide, a duration of a currently available appointment to provide, a price of a currently available appointment to provide (e.g., price elasticity), and/or various creative aspects of an appointment placement (e.g., formatting, details, color, aspect).

After the optimization module 421 determines current appointment availability information to include in a placement, the optimization module returns the current appointment availability information to the content publisher at 419. The content publisher then provides an appointment availability placement with current appointment availability information to the visitor at 417. For example, the content publisher may incorporate the appointment availability placement into other content of the content publisher (e.g., a Web page) and provide to the visitor at 417.

At 429, the visitor interacts with the appointment availability placement to select a currently available appointment to book from appointment availability placement. For example, the visitor may interact with one or more user interface controls included in the placement (e.g., hyperlinks, buttons, form fields). If the appointment availability placement is in situ 431, such as if the appointment availability placement has functionality that allows a visitor to interactively complete a booking process for one or more of the currently available appointments within the context of the content publisher's site (e.g., an embedded application or mini-application, such as a widget or gadget), then the user performs such interactive booking at 433. If additional information is required during the in situ booking process at 435, then such information may be obtained from the optimization module 421. For example, if the visitor selects an appointment that has since become unavailable (e.g., if it was booked by another after it was determined to originally be currently available), additional or alternative current appointment availability may be obtained from the optimization module (e.g., such as to recommend another appointment time for the same service). In addition, in some embodiments, the client user may indicate a desire to see other current appointment availability in the placement (e.g., such as by selecting a button), with such information being obtained from the optimization module.

At 437, the visitor/client interacts one or more times with the in situ placement to selectively book an appointment and optionally enter additional information that may be required for booking (e.g., contact information, billing information). After 437, the in situ appointment availability placement sends information indicative of the booking to the schedule management functionality 400a at 439. The service provider inventory database 405 is updated accordingly to reflect the client booking (e.g., to indicate that an appointment has been booked with a particular service provider), as are historical results 423 (e.g., to track use of an appointment availability placement and/or actions of the client). In some cases, a booking by the client may cause an appointment to no longer be available for other clients to book, or may cause a service provider to no longer be available at the time that the appointment to perform services for other clients, etc.

If instead at 431 the appointment availability placement is not an in situ placement, the visitors interactions with the appointment availability placement at 429 may cause the visitor to be redirected to a Web site provided by the schedule management logic 400a at 441. In such a case, the visitor/client interactively selects a currently available appointment to book at 443, and completes the booking at 439, which may update the service provider inventory database 405 and the historical results 423 accordingly. In some embodiments, the client may also manage booked appointments in various ways at 445, such as to cancel an appointment and/or book other appointments, etc.

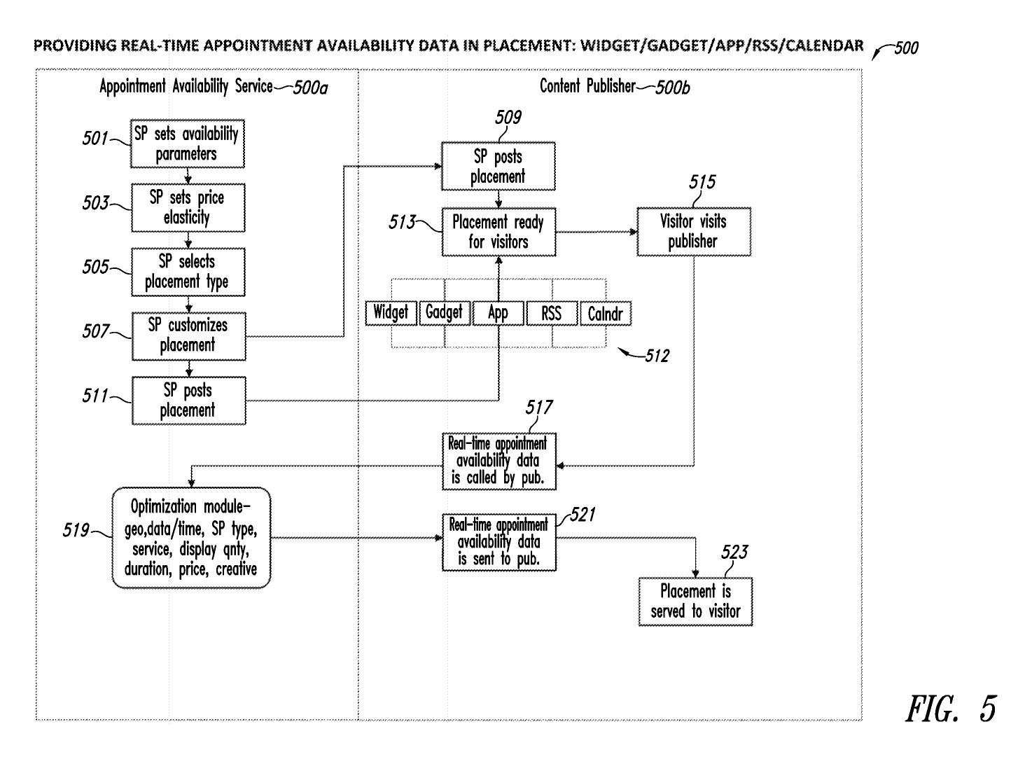

FIG. 5 is a workflow diagram 500 that illustrates a technique for providing real-time appointment availability data in appointment availability placements, according to one illustrated embodiment.

The workflow diagram 500 illustrates various sequences, operations, and interactions that may occur as part of providing real-time/current appointment availability of service providers to clients (existing or potential), according to one illustrated embodiment. An embodiment of the Appointment Availability Service System 105 (FIGS. 1 and 2A-2B) may provide the appointment availability service functionality 500a. An embodiment of the content publisher systems 110 (FIGS. 1 and 2A-2B) may provide the content publisher functionality 500b. Other embodiments are possible, such as the appointment availability service functionality and content publisher functionality may be provided by a single system or additional systems.

At 501 to 511, a service provider may interact one or more times with the appointment availability service functionality 500a to set (or otherwise specify) various parameters to configure one or more appointment availability placements to dynamically advertise or otherwise publish current appointment availability of the service provider.

At 501, the service provider may set one or more appointment availability parameters to specify or otherwise control what appointment availability information may be published in appointment availability placements.

At 503, the service provider sets one or more parameters to configure price elasticity for one or more appointment availability placements.

At 505, the service provider may set one or more parameters to specify one or more types of appointment availability placements to provide.

At 507, the service provider may set one or more of various custom parameters for one more appointment availability placements.

In some cases, after the service provider sets one or more customization parameters at 507, the service provider may interact with the content publisher 500b to post information indicative of the one or more configured appointment availability placements at 509, so that the content publisher may use the information to provide appointment availability placements with current appointment availability information to one or more users of the content publisher. In other cases, such as at 511, the service provider may interact with the appointment availability service 500a to post an appointment availability placement, such as by configuring one or more parameters designating one or more content publishers to serve appointment availability placements (e.g., explicitly designating one or more content publishers, specifying one or more targeting parameters). The information indicative of the one or more configured appointment availability placements may be posted to the content publisher 500a based on the one or more parameters, such that the one or more placements may be provided to users/visitors of that content publisher.

Appointment availability placements may be served by the content publisher in one or more of a variety of manners, some of which are illustrated at 512, such as, widgets, gadgets, applications, RSS feeds, electronic calendars, etc. In some embodiments, at least some of the posted information may be preformatted by the appointment availability service, such as into an appropriate format for serving by the content publisher. In some embodiments, the information may include indications of the manner in which the appointment availability placement is to be served (e.g., such as indications of one or more of 512), so that the content publisher may identify the manner in which the appointment availability placement is to be served.

At 513, the one or more configured appointment availability placements are ready to be served by the content publisher to visitors of the content publisher.

At 515, a visitor “visits” the content publisher 500b, and the content publisher may determine to provide one or more of the appointment availability placements to the visitor (e.g., based on a request by the client for such a placement, based on the placement being part of an advertising inventory of the content publisher).

At 517, the content publisher may request real-time (current) appointment availability data associated with one or more of the configured appointment availability placements. In some cases, the content publisher may use the information posted at 509 or 511 to obtain current appointment availability information for one or more of the configured placements (e.g., such as identifiers associated with the one or more configured appointment availability placements).

At 519, the optimization module may determine current appointment availability information to provide in one or more of the configured appointment availability placements, such as described elsewhere.

At 521, the determined current appointment availability information is returned to the content publisher.

At 523, the content publisher serves an appointment availability placement with at least some of the determined current appointment availability information to the visitor, such that the appointment availability placement is presented to the visitor on a computing system (or other device) operated by the visitor to interact with the content publisher.

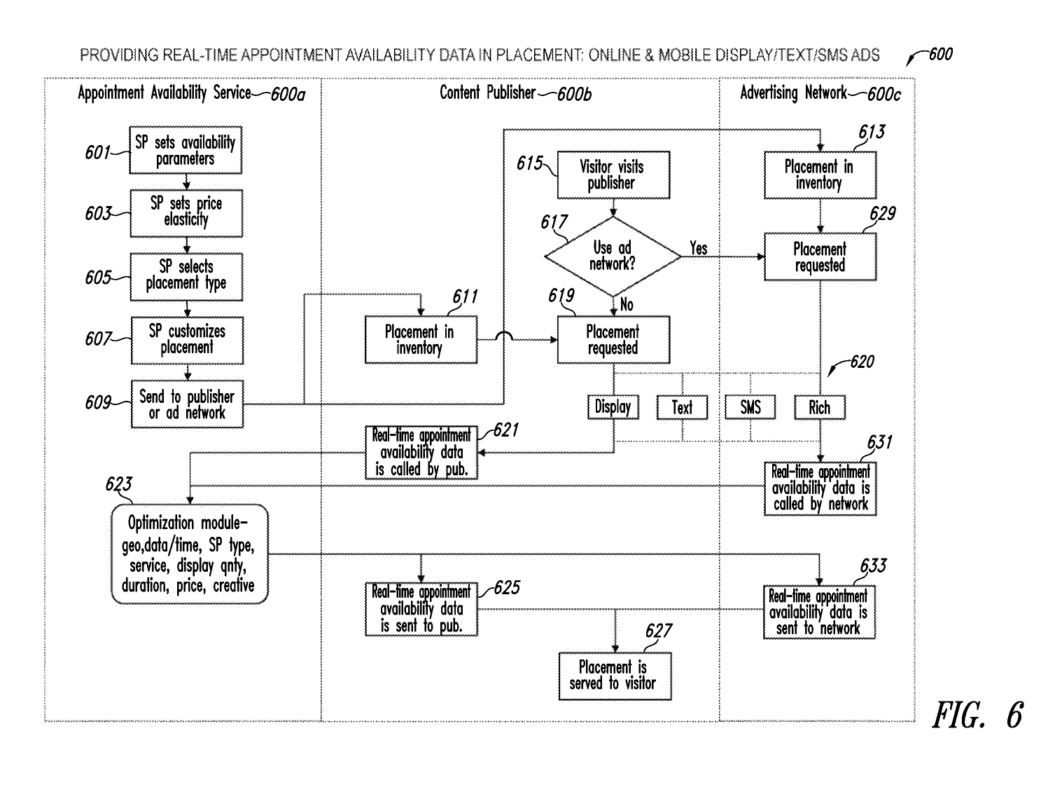

FIG. 6 is a workflow diagram 600 that illustrates a technique for providing real-time appointment availability data in appointment availability placements, according to one illustrated embodiment.

The workflow diagram 600 illustrates various sequences, operations, and interactions that may occur as part of providing real-time/current appointment availability of service providers to clients (existing or potential), according to one illustrated embodiment. An embodiment of the Appointment Availability Service System 105 (FIGS. 1 and 2A-2B) may provide the appointment availability service functionality 600a. An embodiment of the content publisher systems 110 (FIGS. 1 and 2A-2B) may provide the content publisher functionality 600b. An embodiment of the optional advertising network system 125 (FIGS. 1 and 2A-2B) may provide the advertising network functionality 600c. Other embodiments are possible, with various of the functionality being provided by a single or additional systems.

At 601 to 609, a service provider may interact one or more times with the appointment availability service functionality 600a to set (or otherwise specify) various parameters to configure one or more appointment availability placements to dynamically advertise or otherwise publish current appointment availability of the service provider.

At 601, the service provider may set one or more appointment availability parameters to specify or otherwise control what appointment availability information may be published in appointment availability placements.

At 603, the service provider sets one or more parameters to configure price elasticity for one or more appointment availability placements.

At 605, the service provider may set one or more parameters to specify one or more types of appointment availability placements to provide.

At 607, the service provider may set one or more of various custom parameters for one more appointment availability placements.

At 609, one or more of the configured placements (or information indicative of such placements) are sent to a content publisher and/or an advertising network, such as based on the service provider user designating the content publisher and/or advertising network (e.g., explicitly, targeting parameters), and/or based on the service provider interacting with one or more of the content publisher and/or an advertising network to provide such information.

At 611, the one or more configured placements (or information indicative of the placements) may be added to the content publisher's placement inventory (e.g., an inventory of appointment availability placements or an advertisement inventory), such that the content publisher may provide one or more appointment availability placements on behalf of a service provider to clients or existing clients of the service provider.

At 613, the one or more configured placements (or information indicative of the placements) may be added to the advertising network's placement inventory (e.g., an inventory of appointment availability placements or an advertisement inventory), such that the advertising network may provide one or more appointment availability placements on behalf of a service provider.

At 615, a visitor “visits” the content publisher 600b, and the content publisher may determine to provide one or more of the appointment availability placements to the visitor. For example the content publisher may serve advertisements to visitors as part of the visitor using the service of the content publisher. In some cases, the content publisher may itself serve placements (e.g., appointment availability placements and/or other types of placements), such as from a local inventory 611, or may use another service such as an advertising network to serve placements, such as indicated at 617.

At 619, in the case where the content publisher serves placements itself, the content publisher may request an appointment availability placement to serve to the visitor, which may be returned from the placement inventory. The appointment availability placement may be served in a variety of forms, some of which are illustrated at 620, such as display placements (e.g., banner ads, button ads, skyscraper ads), text placements, SMS placements, rich media placements, etc.

At 621, the content publisher may request real-time (current) appointment availability data associated with one or more of the configured appointment availability placements. In some cases, the content publisher may use the information obtained from the placement inventory to obtain current appointment availability information for one or more of the configured placements (e.g., using identifiers associated with the one or more configured appointment availability placements that are included in the information).

At 623, the optimization module may determine current appointment availability information to provide in one or more of the configured appointment availability placements.

At 625, the determined current appointment availability information is returned to the content publisher.

At 627, the content publisher serves an appointment availability placement with at least some of the determined current appointment availability information to the visitor, such that the appointment availability placement is presented to the visitor on a computing system (or other device) operated by the visitor to interact with the content publisher.

If instead at 617, the content publisher uses an advertising network to serve placements, the content publisher requests a placement from the advertising network at 629. At 629, the advertising network may determine to serve one of the one or more configured appointment availability placements that was added to the placement inventory at 613, which may be served in a variety of formats, some of which are illustrated at 620

At 631, the advertising network may request real-time (current) appointment availability data associated with one or more of the configured appointment availability placements.

At 623, the optimization module may determine current appointment availability information to provide in one or more of the configured appointment availability placements.

At 633, the determined current appointment availability information is returned to the advertising network, and the advertising network provides an appointment availability placement with at least some of the determined current appointment availability information to the content publisher.

At 627, the appointment availability placement obtained from the advertising network is served to the visitor, such that the appointment availability placement is presented to the visitor on a computing system (or other device) used by the visitor to interact with the content publisher.

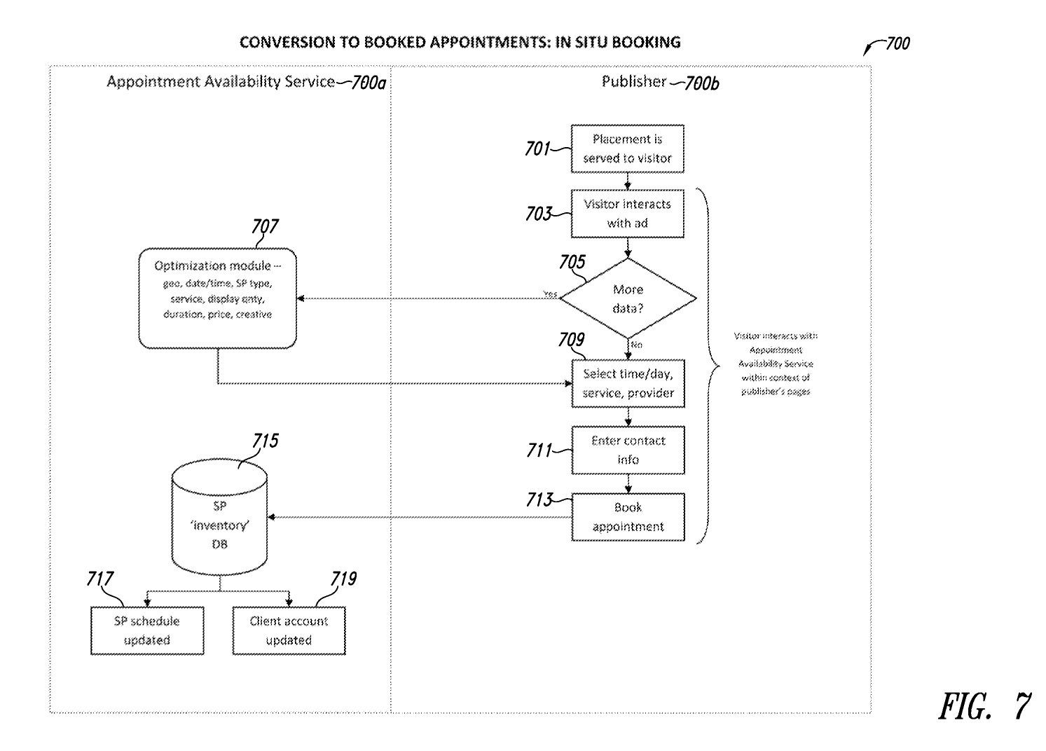

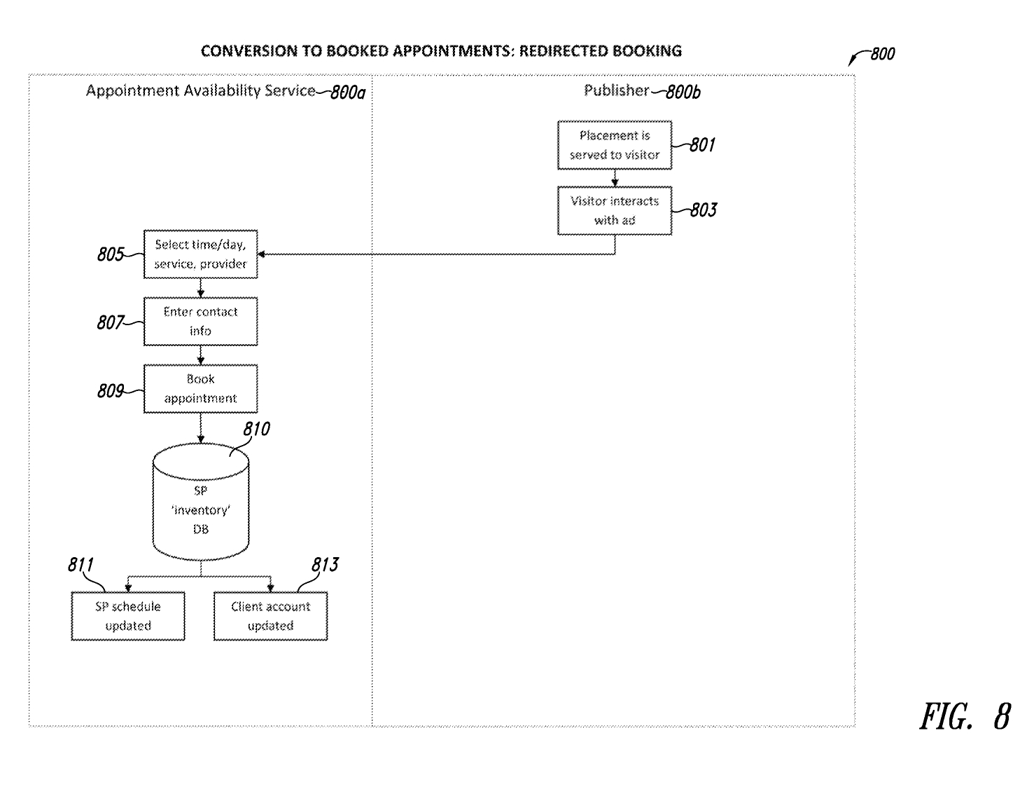

FIGS. 7 and 8 are workflow diagrams that illustrate embodiments of various sequences, operations, and interactions that may occur as part of booking appointment availability from an appointment availability placement, such as an appointment availability placement provided to the visitor in FIG. 5 at 523 and/or in FIG. 6 at 627. An embodiment of the Appointment Availability Service System 105 (FIGS. 1 and 2A-2B) may provide the appointment availability service functionality 700a (FIG. 7) and 800a (FIG. 8). An embodiment of the content publisher systems 110 (FIGS. 1 and 2A-2B) may provide the content publisher functionality 700b (FIG. 7) and 800b (FIG. 8). Other embodiments are possible, with various of the functionality being provided by a single or additional systems

The workflow diagram 700 of FIG. 7 illustrates a technique for in situ booking of appointment availability, according to one illustrated embodiment.

At 701, an appointment availability placement is served to a visitor, such as from a content publisher at 523 (FIG. 5) and/or at 627 (FIG. 6). The appointment availability placement may be presented to the visitor, such as via a Web browser or other application executing on a computing system (or other device) used by the visitor to interact with the content publisher.

In this example, the appointment availability information is presented to the user within the context of one or more Web pages provided by the content publisher. In addition, in this example, the appointment availability placement provides functionality that allows a visitor to interactively complete a booking process (or request a booking) for one or more of the currently available appointments within the context of the content publisher's Web pages. For example, in some embodiments the appointment availability placement may be displayed in a Web page of the content publisher along with other content provided by the content publisher. In such an example embodiment, the visitor may interact with the appointment availability placement that provides in situ booking to book an application without leaving the context of the content publisher's Web page.

At 703, the visitor interacts with the appointment availability placement in various ways. For example, the visitor may interact with one or more user interface controls included in the placement (e.g., hyperlinks, buttons, and/or other controls), such as by interactively selecting a control (e.g., clicking on one or more of the controls with a mouse pointer or otherwise interacting with the user interface in an appropriate manner to indicate selections) and/or performing other user actions.

At 705, the appointment availability placement determines whether more current appointment availability information is needed, and if so, interacts with the optimization module at 707 to obtain additional current appointment availability information. For example, in one embodiment, the visitor may indicate a desire to see other current appointment availability (e.g., such as by selecting a button or other control to indicate such a desire), with such other current appointment availability being obtained from the optimization module. In addition, in some embodiments, as the visitor interacts with the appointment availability placement in one or more ways to select an offered currently available appointment, more appointment availability data may be acquired from the appointment availability service, such as if an appointment selected by the visitor has already by booked (and is not longer available).

At 709, the visitor may interact with the appointment availability placement to select an offered currently available appointment to book from the appointment availability placement, such as by interactively selecting one or more controls, etc. As part of such selection, the visitor may select a time/day, service, and/or provider of a currently available appointment; and/or may optionally enter contact information at 711.

At 713, an indication of the visitor's selected appointment booking is provided to the appointment availability service functionality 700a.

After the visitor books an appointment at 713, the service provider inventory database may be updated accordingly to reflect the selected booking at 715. At 717, a schedule (e.g., scheduling software, electronic calendar) of the service provider who is providing the appointment may be updated to include an indication of the booked appointment. At 719, an account of the visitor/client may be optionally updated to reflect the booking. For example, in some embodiments, a client may use services of the appointment availability service to book appointments (e.g., such as an online scheduling service) and/or maintain a calendar/schedule of the client, and in some such embodiments, the client's account information may be updated to reflect that the client booked the appointment.

The workflow diagram 800 of FIG. 8 illustrates a technique for redirected booking of appointment availability, according to one illustrated embodiment.

At 801, an appointment availability placement is served to a visitor, such as from a content publisher at 523 (FIG. 5) and/or at 627 (FIG. 6). The appointment availability placement may be presented to the visitor, such as via a Web browser or other application executing on a computing system (or other device) used by the visitor to interact with the content publisher.

In this example, similar to FIG. 8, the appointment availability information may be presented to the user within the context of one or more Web pages provided by the content publisher; but rather than book an appointment offered in the placement within the context of the content publisher's Web pages, the visitor is redirected outside of the context of the content publisher to one or more other Web pages (or services) to book an appointment, such as Web pages provided by the appointment availability service.

At 803, the visitor interacts with the appointment availability placement to select an offered currently available appointment to book. For example, the visitor may interact with one or more user interface controls included in the placement (e.g., hyperlinks, buttons, and/or other controls) to select an appointment included in the appointment availability placement. In some embodiments, the visitor may interact with the appointment availability placement by selecting a Web hyperlink associated with the placement (e.g., such as by clicking on the placement displayed to the user in a Web browser, and/or another provided hyperlink).

After the user interacts at 803, the visitor is redirected to a Web page provided by the appointment availability service (e.g., the new Web page may be loaded into a window of the browser), where the visitor may interact by optionally selecting a time/day, service, and/or provider of one of the currently available appointments at 805; entering contact information of the visitor at 807; and/or indicating a desire to book a particular currently available appointment at 809.

After the visitor books an appointment at 809, the service provider inventory database may be updated accordingly to reflect the booking at 810, a schedule of the service provider who is providing the appointment may be updated to include an indication of the booked appointment at 811, and/or an account of the visitor/client may be optionally updated to reflect the booking at 813.

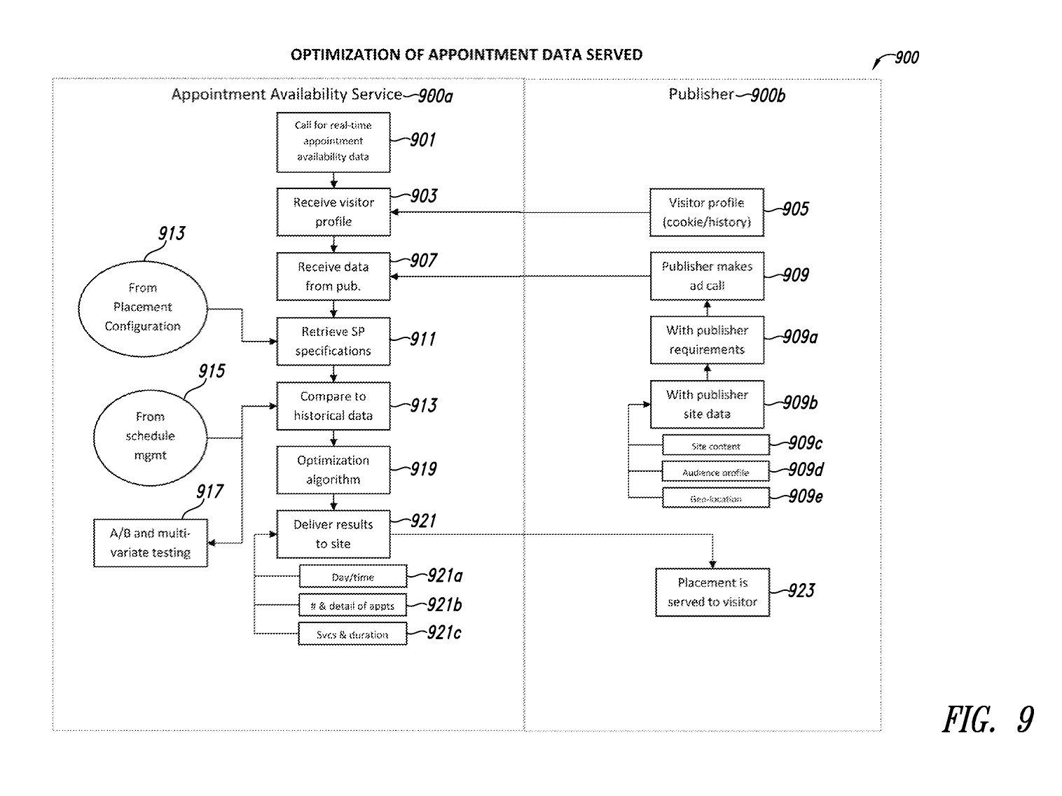

FIG. 9 is a workflow diagram 900 that illustrates a technique for optimizing appointment availability data provided in a placement, according to one illustrated embodiment.

The workflow diagram 900 illustrates various sequences, operations, and interactions that may occur as part of providing and optimizing real-time/current appointment availability, such as for use in appointment availability placements, according to one illustrated embodiment. An embodiment of the Appointment Availability Service System 105 (FIGS. 1 and 2A-2B) may provide the appointment availability service functionality 900a. An embodiment of the content publisher systems 110 (FIGS. 1 and 2A-2B) may provide the content publisher functionality 900b. Other embodiments are possible, with various of the functionality being provided by a single or additional systems. For example, an embodiment of the optional advertising network system 125 (FIGS. 1 and 2A-2B) may provide at least some of the content publisher functionality 900b.

At 901, the appointment availability service functionality 900a receives a request for real-time (current) appointment availability information, such as for use in an appointment availability placement, such as the calls from the content publisher at 517 (FIG. 5) and/or at 621 (FIG. 6).

At 903, the appointment availability service functionality 900a may receive a visitor profile, such as from a cookie provided by an application of the visitor (e.g., a Web cookie) or other history information of the visitor (e.g., provided by the visitor's computing system or the content publisher) at 905.

At 907, the appointment availability service functionality 900a may receive various data from the content publisher, such as data provided with the request for current appointment availability information, indicated at 909. Such data may include publisher requirements 909a (e.g., formatting requirements) and publisher site data 909b. The publisher site data 909b may include site content 909c (e.g., contextual information related to the site), audience profile 909d (e.g., profile/demographic of users/visitors of the publisher site), and geographical location data 909e (e.g., geographical location to which the publisher caters to and/or a location of a visitor to whom the appointment availability information is to be served).

At 911, the appointment availability service functionality 900a may retrieve information related to one or more service provider's specifications, such as from appointment availability placement configurations at 913 (e.g., configuration parameters specified by the service provider).

At 913, the appointment availability service functionality 900a may compare or otherwise analyze at least some of the provided information (e.g. received at 903, 907, and 911) with respect to historical data. The historical data may be based on one or more previous bookings of appointments by one or more visitors/clients (e.g., such as tracked by an embodiment of the scheduling management functionality discussed in FIG. 5 and elsewhere), indicated at 915, and/or may be based on NB or multivariate testing 917 of prior provided appointment availability information or placements.

At 919, based at least in part on such a comparison/analysis at 913 and/or various of the information received at 903, 907, and 911, an optimization algorithm may be executed by the appointment availability service functionality 900a to determine one or more optimal/preferred currently available appointments of one or more service providers to offer to an intended or potential recipient of the appointment availability information, such as appointments that may be of particular relevance and/or interest to an intended or potential recipient of the information (e.g., the visitor/client), or may otherwise potentially increase the likelihood that an offered appointment included in the appointment availability data will be booked by an intended or potential recipient of the information, such as described elsewhere. For example, the optimization algorithm may execute to determine one or more of an optimal/preferred day or time for an appointment to offer (921a); an optimal/preferred number of appointments to include and/or amount of details related to those appointments (921b); an optimal/preferred service to offer appointments for and/or optimal/preferred durations of those appointments; etc.

At 921, the appointment availability service functionality 900a returns information indicative of the one or more optimal/preferred currently available appointments to the content publisher, such that the publisher may provide an appointment availability placement with the optimal/preferred currently available appointments to the visitor at 923.

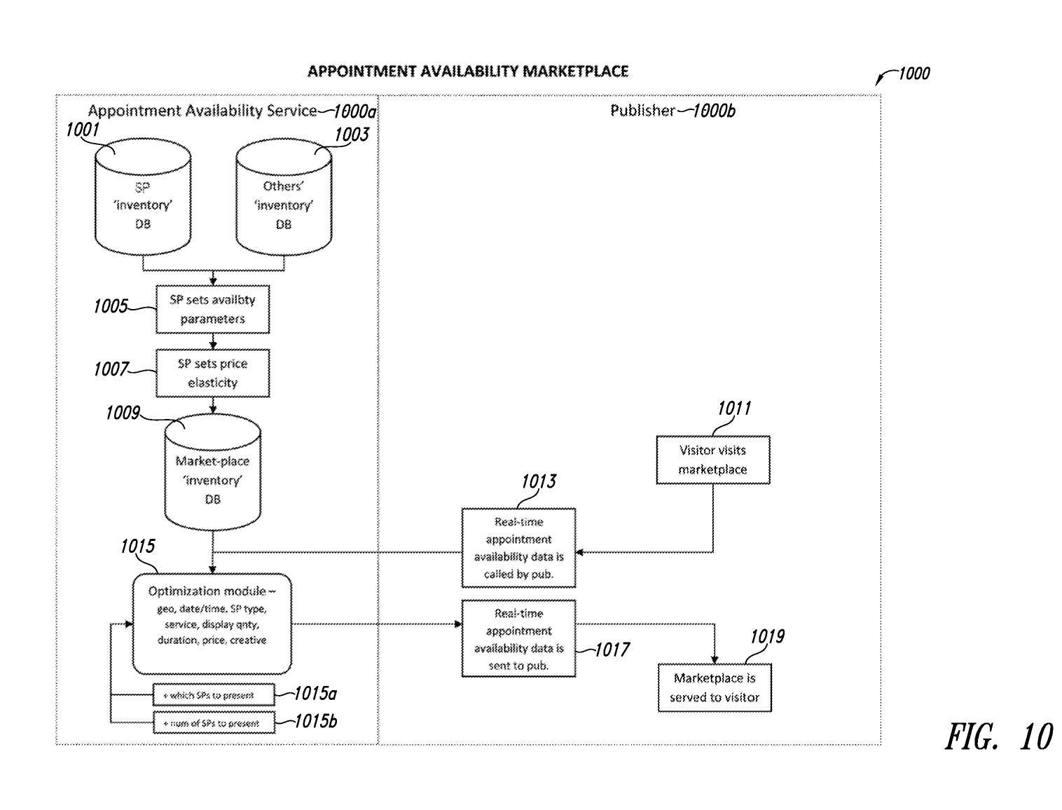

FIG. 10 is a workflow diagram 1000 that illustrates a technique for providing an appointment availability marketplace, according to one illustrated embodiment.

The workflow diagram 1000 illustrates various sequences, operations, and interactions that may occur as part of providing an appointment availability marketplace to advertise or otherwise publish current appointment availability of multiple service providers, according to one illustrated embodiment. An embodiment of the Appointment Availability Service System 105 (FIGS. 1 and 2A-2B) may provide the appointment availability service functionality 1000a. An embodiment of the content publisher systems 110 (FIGS. 1 and 2A-2B) may provide the content publisher functionality 1000b. Other embodiments are possible, with various of the functionality being provided by a single or additional systems. For example, in one embodiment, the Appointment Availability Service System 105 may provide at least some of the content publisher functionality 1000b. In addition, in some embodiments, the optional other database discussed at 1003 (below) may be provided by an embodiment of a service provider user system 115 (FIGS. 1 and 2A-2B) and/or an embodiment of one or more of the optional other third party systems 130 (FIGS. 1 and 2A-2B).

The appointment availability service functionality 1000a facilitates provision of an appointment availability marketplace, such as to provide current appointment availability of multiple service providers to one or more visitors/users of the marketplace. As part of such facilitation, the appointment availability service functionality 1000a may maintain a marketplace inventory database (e.g., at 1009) that may include data that is indicative of current appointment availability for multiple service providers, such as for use in providing an appointment availability marketplace. The information stored in the marketplace inventory database may be obtained from a service provider inventory database at 1001 that may also be maintained by appointment availability service functionality 1000a (e.g., such as the service provider database discussed at 405, 715, and 810 of FIGS. 4, 7, and 8, respectively), and/or from optional other sources such as other inventory database at 1003 (e.g., stored on a system of the service provider, or other third party system). The databases at 1001 and 1003 include data that is indicative of one or more service provider's current appointment availability.

At 1005 and 1007, a service provider may interact one or more times with the appointment availability service functionality 1000a to set (or otherwise specify) various parameters to configure one or more aspects regarding how a service provider's appointment availability may be provided in an appointment availability marketplace.

At 1005, the service provider may set one or more appointment availability parameters that specify or otherwise control what appointment availability information may be published in an appointment availability marketplace. For example, such parameters may specify one or more services that may be published; one or more service providers that may be published; one or more candidate appointment times that may be published; durations of various appointments to publish; etc. In addition, the service provider may also indicate one or more sources of appointment availability data to use in determining current appointment availability of the service provider, such as service provider database 1001 or other inventory database 1003. In addition, the service provider may also provide various information such as, the geographical location of the service provider (and/or an area served by the service provider), and/or various targeting parameters to target particular types of visitors/users of an appointment availability marketplace.

At 1007, the service provider may set one or more parameters to configure price elasticity for one or more appointments that may appear in an appointment availability marketplace, so that pricing for one or more appointments published in a marketplace may be dynamically determined according to such parameters at or near the time that the appointment availability provided to a visitor/user of the marketplace (e.g., similar to as described elsewhere).

At 1009, after one or more service providers set various configuration parameters, at least some of the configuration parameters may be stored in the marketplace inventory database. In addition, data that is indicative of one or more service providers' current appointment availability may be added to the marketplace inventory database, such as data that conforms to one or more of the configuration parameters of the service providers. The data in the marketplace inventory database may be updated from time-to-time such that it reflects the current state of one or more services provider's current appointment availability at the time of the update (e.g., such as based on data stored in the service provider inventory database 1001 and/or the other inventory database 1003).

At 1011, a visitor/user interacts with an embodiment of an appointment availability marketplace, such as by accessing a Web site or other network-based application that provides such a marketplace, such as via a Web browser or other application executing on a computing system of the visitor. The appointment availability marketplace simultaneously displays current appointment availability of multiple service providers to the visitor. In some embodiments, the marketplace may provide various controls that allow the visitor to search and/or browse current appointment availability of multiple service providers in various ways (e.g., by service type, service provider location). In at least one embodiment, the marketplace operates to provide a marketplace for currently available appointments offered from local service providers (e.g., service providers determined to provide services that are local to the visitor).

At 1013, as the user visits the marketplace, real-time (current) appointment availability data is obtained from the appointment availability service functionality 1000a. At 1015, the optimization module determines current appointment availability for multiple service providers to provide to the visitor, such as from data stored in the marketplace inventory database. As part of such determination, the appointment availability service functionality 1000a determines which service providers to provide the user at 1015a and a number of service providers to presents to the user at 1015b. The determination may be based on various optimization factors, as discussed elsewhere, such as to increase the likelihood that one or more appointments presented in the marketplace will be booked, such as by determining optimal/preferred appointment times, services, prices, etc. In addition, the determination of which service providers to provide may be based on determining that the service providers are local to the visitor, such that the visitor may be provided with current appointment availability of multiple local service providers.

After the current appointment availability information is determined, it is returned to the content publisher at 1017. The content publisher may then display at least some amount of the return data in a manner such that appointment availability for multiple service providers is displayed to the visitors at 1019.

FIGS. 11 to 14 show screen prints of Web pages that include example embodiments of an appointment availability placement. The illustrated Web pages may each be presented to a client user on a display of a client user system 120 (FIGS. 1 and 2A-2B) operating by the client user, such as via a Web browser executing on the client user system, and/or may also be displayed on client telecommunications device 135 or client PDA 140 (FIG. 1). The Web pages of FIGS. 11-14 may be provided to the client user system by a content publisher system 110 (FIGS. 1 and 2A-2B), with an embodiment of an AASS 105 (FIGS. 1 and 2A-2B) to facilitate providing appointment availability placements with current appointment availability information, such as in a manner describe elsewhere. For example, the content publisher systems of the illustrated Web pages may interact with an embodiment of an AASS in one or more manners described elsewhere, such that the content providers may serve the illustrated appointment availability placements with current appointment availability information to a client user. In addition, one or more service providers (or their agents) may have configured various of the illustrated appointment availability placements, such as in a manner described elsewhere, and/or provided information related to their actual availability. Furthermore, it will be appreciated that the example embodiments of the illustrated appointment availability placements described in FIGS. 11-14 are merely illustrative, and other embodiments may include different and/or additional information, controls, formatting, etc. (some of which have been described elsewhere).

In FIG. 11, a browser screen 1100 displays a Web page from an Internet search Web site. The content of the Web page may include text, character strings of alpha, numeric or other symbols, pictures, user selectable icons or menus, as well as various active content.

In this illustrated example, a client user (not shown) has interacted with the Internet search Web site to conduct a search 1101 for “massage in west seattle”. The results 1102 of a search 1101 are displayed along with various advertisements 1103 (e.g., “Sponsored Links”), with one of the displayed advertisements 1103 being an appointment availability placement 1110 with current appointment availability information pertaining to a service provider.

In this example, the displayed advertisements 1103 may be served by the content publisher (the provider of the Internet search Web site) on the basis of one or more keywords of the search 1101, such that the displayed advertisements may be related to the context of the content included in the Web page. In some such embodiments, the content publisher may pass information related to the context of the Web page (such as one or more of the keywords) to the AASS (in addition to other information), so that the AASS may determine appointment availability information to provide in the appointment availability placement 1110 based at least in part on the context. Furthermore, the AASS may have determined the currently available appointments (e.g., times, location, service providers, type of services) based at least in part on various configurations provided by the service providers and/or one or more optimizing factors discussed elsewhere.

The appointment availability placement 1110 includes various information related to multiple appointments that are determined (by an AASS 105) to be currently available for booking from a service provider. In particular, the illustrated placement 1110 includes textual information indicating a type of service 1112 (e.g., “Massage Appointments”) that has current appointment availability for booking, three appointment times that are currently available 1114 (e.g., three appointments are indicated as currently available “this week,” on Friday at 3:00 PM and on Saturday at 2:00 PM and 4:00 PM), and the service provider 1116 (in this illustration indicated as a URL of a Web page of the service provider).

In addition, in this illustrated embodiment, the appointment availability placement 1110 includes a hyperlink 1112 that may be selected by the user (e.g., with a mouse pointer) to initiate a booking process for one or more of the currently displayed appointments (e.g., redirected booking).

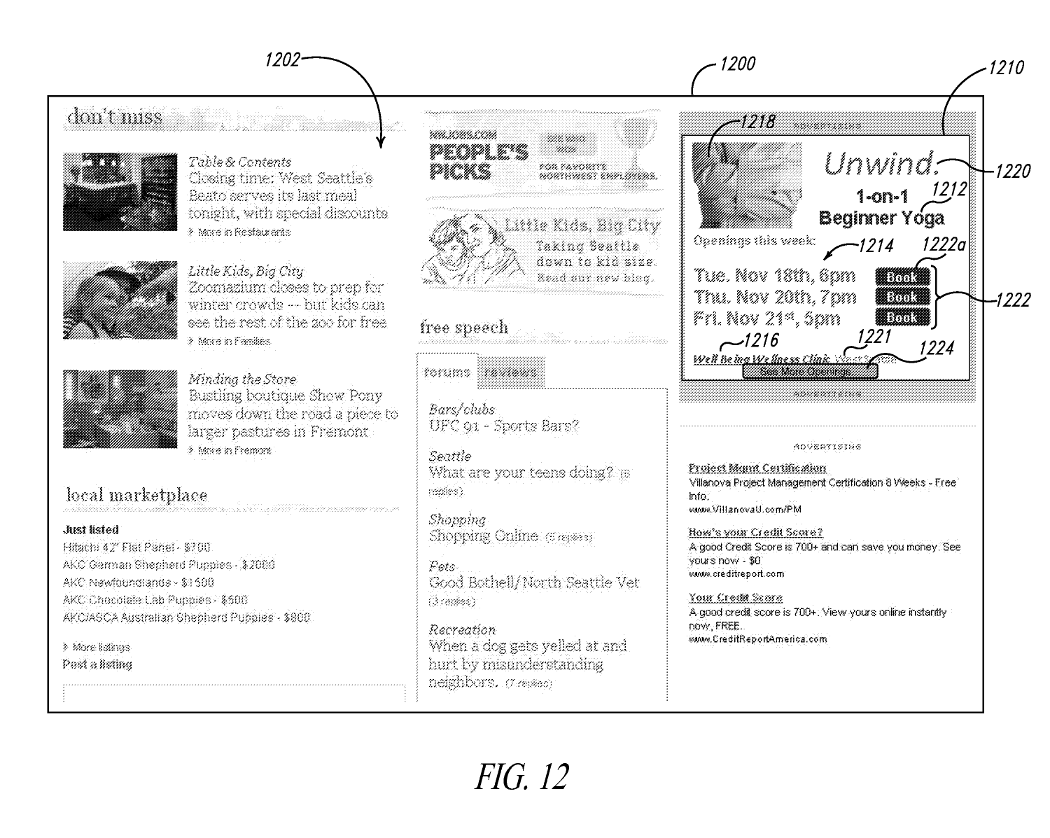

In FIG. 12, a browser screen 1200 displays a Web page from a Web site. The content 1202 of the Web page presented in browser screen 1200 includes various information, such as reviews, articles, etc., that are related to topics that may be of interest to users of the Web site who are located in the Northwestern United States (and/or, in particular, to users located in Seattle, Wash.). The content 1202 also includes an illustrated appointment availability placement 1210 with current appointment availability for a service provider located in a neighborhood of Seattle (e.g., West Seattle). In this example, a service provider user may have explicitly designated that the appointment availability placement 1210 be served on the Web site, and/or specified various parameters to target the appointment availability placement 1210 to clients who are located in the Northwest (e.g., in the region, and/or more particularly in Washington, Seattle, or West Seattle), as described elsewhere.

The appointment availability placement 1210 includes various information related to multiple appointments that are determined (by an AASS 105) to be currently available for booking from a service provider. In particular, the illustrated placement 1210 includes an indication of a type of service 1212 (e.g., “1-on-1 Beginner Yoga”) that has current appointment availability for booking, three appointment times that are currently available 1214 (e.g., Tuesday, November 18 at 6:00 PM, Thursday, November 20 at 7:00 PM, and Friday November 21 at 5:00 PM), and the service provider 1216 (“Well Being Wellness Clinic”). The appointment availability placement 1210 also includes various other information, including an image 1218 and text 1220, such as may have been specified by the service provider during configuration the appointment availability placement 1210, and an indication of a location of the service provider 1221 (e.g., “West Seattle”).

The appointment availability placement 1210 illustrates one possible example embodiment of an appointment availability placement that includes functionality for in situ booking. Of note, in this example embodiment, the appointment availability placement 1210 includes various user interface controls, such as “book” buttons 1222 and “See More Openings” button 1224, that may be interacted with by the client user (e.g., selected with a mouse pointers).

The “book” buttons 1222 may be used by the client user to book (or request a booking for) one of the offered appointments. For example, the client user may select to book (or request a booking for) the appointment that is available on Tuesday, November 18th at 6:00 PM by selecting “book” button 1222a. After such a selection, an indication of the selection may be sent to an embodiment of an AASS, such that the AASS may update appointment availability for the service provider and/or otherwise notify a service provider of the booking, although other interactions are possible. The “See More Openings” button 1224 may be used by the client user to obtain other current appointment availability that may be displayed in the appointment availability placement 1210 and/or subsequently booked by the client user.

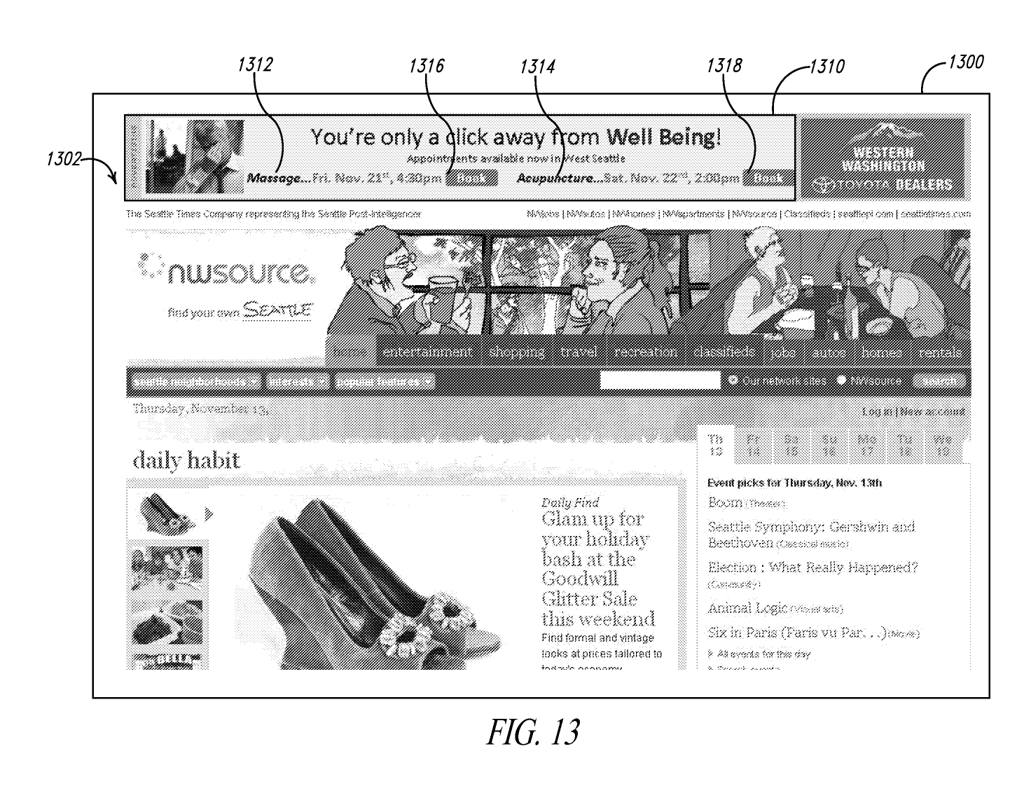

In FIG. 13, a browser screen 1300 displays a portion of another Web page from the Web site described with respect to FIG. 12. The content 1302 of the Web page includes an illustrated appointment availability placement 1310, here presented as a banner ad.

The appointment availability placement 1310 includes various information related to multiple appointments that are determined (by an AASS 105) to be currently available for booking from a service provider. In particular, two currently available appointments 1312 and 1314 are offered for booking, with the appointments in this example being for different services (e.g., massage and acupuncture, respectively). In addition, a “book” button is presented next to each of the appointments, with which the client user may interact to book the corresponding appointment. For example, the client user may book the massage appointment 1312 by selecting “book” button 1316, or may book the acupuncture appointment 1314 by selecting “book” button 1320.

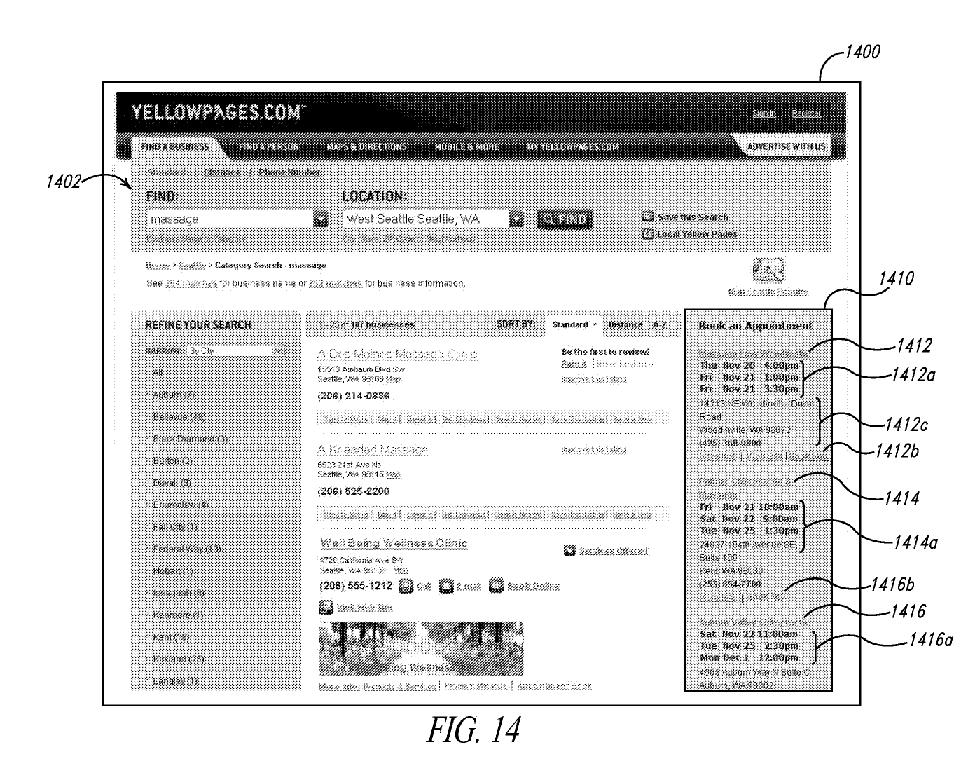

In FIG. 14, a browser screen 1400 displays a Web page from an Internet Yellow Pages Web site. The content 1402 of the Web page may include various information, such as related to business listings. The content 1402 also includes an illustrated appointment availability placement 1410.

In this illustrated example, the appointment availability placement 1410 includes current appointment availability of several service providers, such as determined to by an AASS 105. In particular, the illustrated appointment availability placement 1410, includes indications of three service providers 1412 (“Massage Envy Woodinville”), 1414 (“Palmer Chiropractic & Massage”), and 1416 (“Auburn Valley Chiropractic”), as well indications of current appointment availability for each of the three service providers, such as appointments 1412a, appointments 1414a, and appointments 1416a, respectively. The appointment availability placement 1410 also includes various other information, such as contact and geographical location information 1412c related to the service provider 1412.

In addition, in this illustrated embodiment, the appointment availability placement 1410 includes controls that allow the client user to book various of the indicated currently available appointments from the indicated service providers. For example, the client user may interact with a “Book Now” control 1412b to initiate a booking process for currently available appointments from service provider 1412, or may interact with a “Book Now” control 1414b to initiating booking of currently available appointments from service provider 1414. In some embodiments, a selection by the client user of either of the illustrated “Book Now” controls may result in a redirected booking process, while in other embodiments, such selection may result in an in situ booking process (e.g., upon selection of either the controls, the appointment availability placement 1410 may present other controls to allow the client user to book one or more of the available appointments).

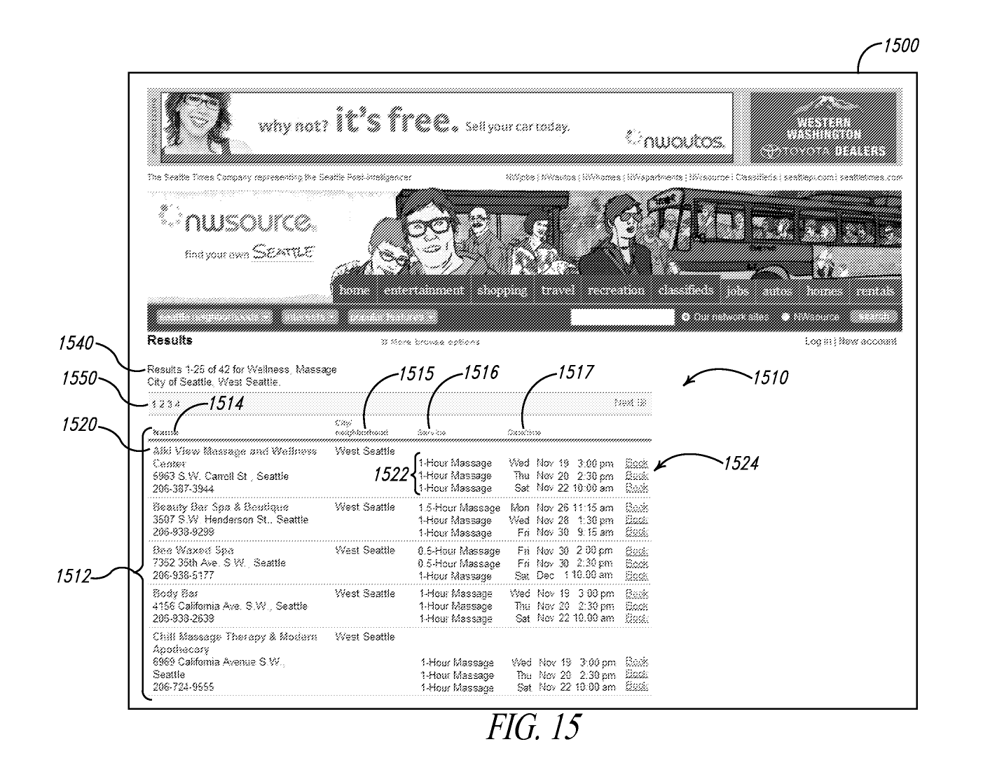

FIG. 15 shows a screen print of a Web page with an example appointment availability marketplace, according to one illustrated embodiment. The illustrated Web page may be presented to a client user on a display of a client user system 120 (FIGS. 1 and 2A-2B) operated by the client user, such as via a Web browser executing on the client user system, and/or may also be displayed on client telecommunications device 135 or client PDA 140 (FIG. 1). The Web page of FIG. 15 may be provided to the client user system by one or more of the content publisher systems 110 (FIGS. 1 and 2A-2B), with an embodiment of an AASS 105 (FIGS. 1 and 2A-2B) to facilitate providing current appointment availability for the appointment availability marketplace, such as in a manner describe elsewhere. The content publisher of the illustrated appointment availability marketplace may interact with an embodiment of an AASS in one or more manners described elsewhere, so that the content publisher may serve the illustrated appointment availability marketplace with current appointment availability information to one or more client users. Furthermore, it will be appreciated that the example embodiment of the illustrated appointment availability marketplace described in FIG. 15 is merely illustrative, and other embodiments may include different and/or additional information, controls, formatting, etc. (some of which have been described elsewhere).

In FIG. 15, a browser screen 1500 displays a Web page that includes an example embodiment of an appointment availability marketplace 1510. In particular, the appointment availability marketplace 1510 displays current appointment availability of several service providers 1512. The appointment availability marketplace 1510 includes various information related to each service provider, including a name of the service provider 1514, a location 1515, various services corresponding to available appointments 1516, and a date/time of availability for the services 1517. For example, a service provider 1520 (“Alki View Massage and Wellness Center”) is indicated as located in West Seattle, with three listed massage appointments 1522 that are currently available (note that the listing also includes an indication of durations of the various appointments 1522). In addition, each of the available appointments 1522 have corresponding “book” controls 1524 that allow a client user of the appointment availability marketplace to book the appointments, such as in a manner describe elsewhere.

The appointment availability marketplace 1510 of this illustrated example may include various controls (not shown) for searching for appointment availability within the marketplace. For example, indications of such a search are shown at 1540, with the results of the search being the current appointment availability of several service providers displayed at least in part at 1512. In addition, the appointment availability marketplace 1510 of this illustrated example also includes browsing controls 1550, such as to enable a user to view current appointment availability for other service providers (e.g., such as by selecting one of the numbers “1 2 3 4” or the “Next” arrow), such as to see availability for other service providers that resulted from the search.

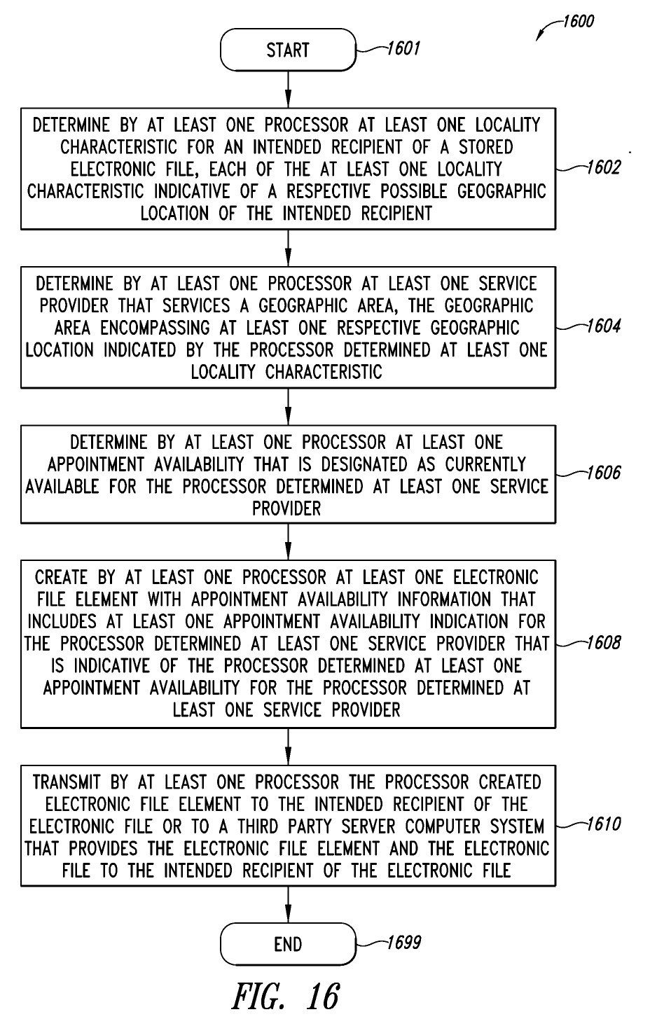

FIG. 16 shows a method 1600 of providing appointment availability in a placement, according to one illustrated embodiment. The method 1600 may be implemented, for example, by the AASS 105 shown in FIGS. 1 and 2A-2B and 300 shown in FIG. 3.

The method 1600 starts at 1601. For example, the method 1600 may start in response to a request for appointment availability information of one or more service providers.

At 1602, the AASS determines at least one locality characteristic for an intended recipient of a stored electronic file, each of the at least one locality characteristic indicative of a respective possible geographic location of the intended recipient.

At 1604, the AASS determines at least one service provider that services a geographic area encompassing at least one respective geographic location indicated by the processor determined at least one locality characteristic.

At 1606, the AASS determines at least one appointment availability that is designated as currently available for the at least one service provider.

At 1608, the AASS creates at least one electronic file element with appointment availability information that includes at least one appointment availability indication for the at least one service provider that is indicative of the determined at least one appointment availability for the at least one service provider.

At 1610, the AASS transmits the electronic file element to the intended recipient of the electronic file or to a third party server computer system that provides the electronic file element and the electronic file to the intended recipient of the electronic file.

The method 1600 terminates at 1699. The method 1600 may terminate, for example, in completion of transmitting the electronic file element. Alternatively, the method 1600 may repeat for example returning to 1602. In some embodiments, the method 1600 may be executed as a multi-threaded process, or may be executed as separate threads on one or more processors.

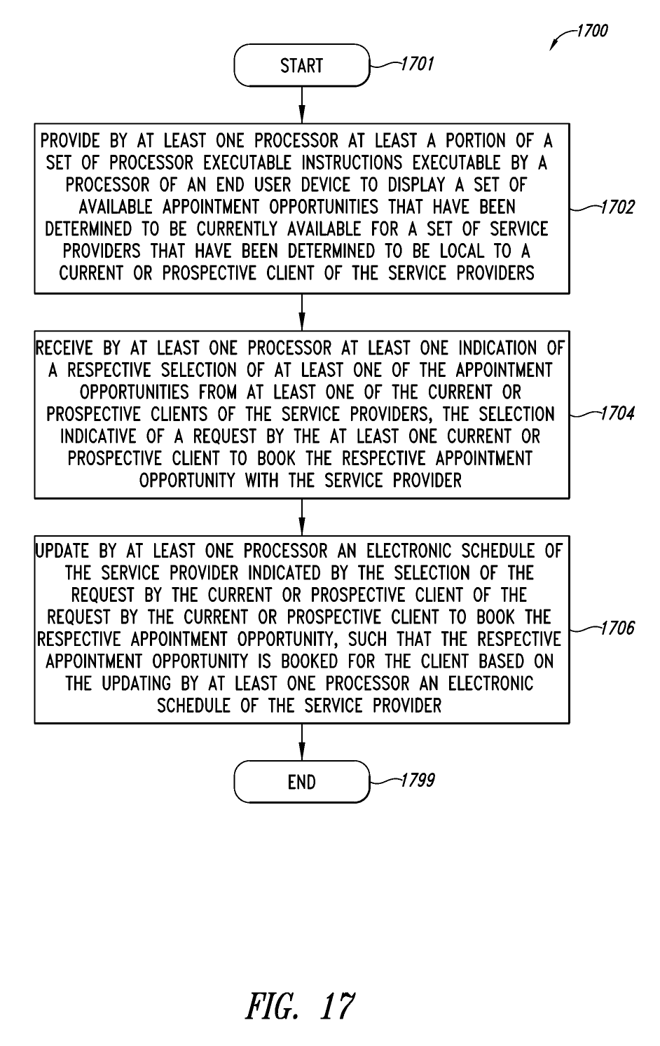

FIG. 17 shows a method 1700 of booking appointment availability via a provided placement, according to one embodiment. The method 1700 may be implemented, for example, by the AASS 105 shown in FIGS. 1 and 2A-2B and 300 shown in FIG. 3.

The method 1700 starts at 1701, such as after receiving a request for an appointment availability placement.

At 1702, the AASS provides at least a portion of a set of instructions that are executable by a processor of an end user device to display a set of available appointment opportunities that have been determined to be currently available for a set of service providers that are local to a current or prospective client of the service providers, such as an appointment availability placement.

At 1704, the AASS receives at least one indication of a respective selection of at least one of the appointment opportunities from at least one of the current or prospective clients of the service providers, the selection indicative of a request by the at least one current or prospective client to book the respective appointment opportunity with the service provider.

At 1706, the AASS updates an electronic schedule of the service provider indicated by the selection of the request by the current or prospective client of the request by the current or prospective client to book the respective appointment opportunity, such that the respective appointment opportunity is booked for the client based on the updating an electronic schedule of the service provider. For example, in some embodiments, an electronic calendar or other schedule of the service provider may be updated to include an indication of the booking by the current or prospective client.

The method 1700 terminates at 1799. The method 1700 may terminate, for example, in completion of updating. Alternatively, the method 1700 may repeat for example returning to 1702. In some embodiments, the method 1700 may be executed as a multi-threaded process, or may be executed as separate threads on one or more processors.

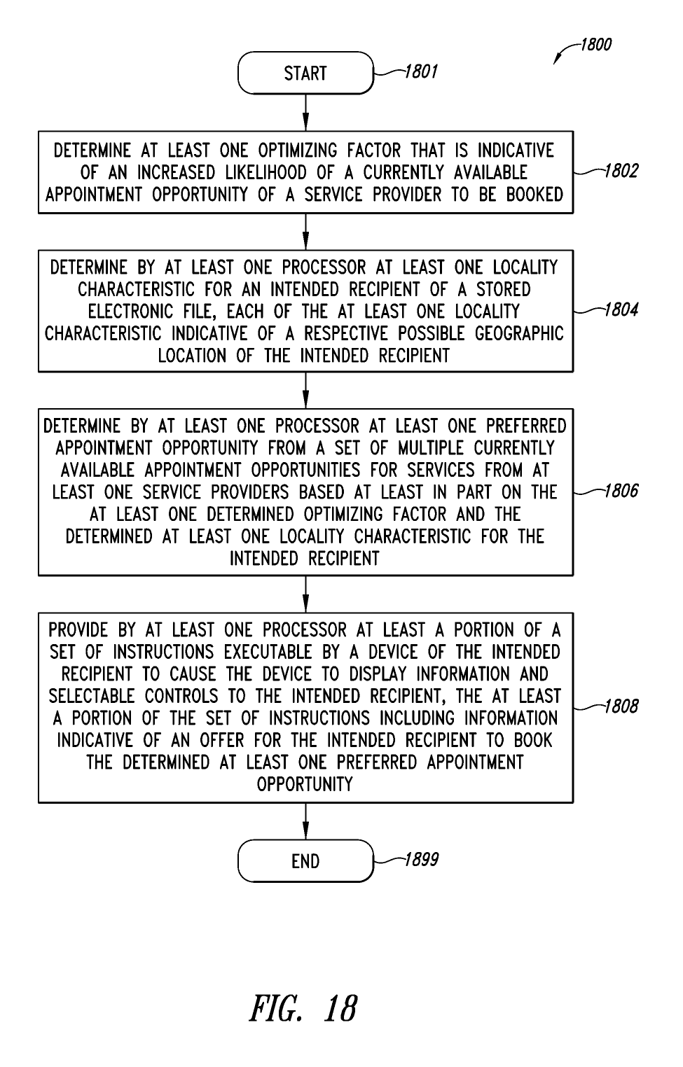

FIG. 18 shows a method 1800 of optimizing appointment availability provided in a placement, according to one embodiment. The method 1800 may be implemented, for example, by the AASS 105 shown in FIGS. 1 and 2A-2B and 300 shown in FIG. 3.

The method 1800 starts at 1801, such as based on a request for appointment availability information for inclusion in an appointment availability placement.

At 1802, the AASS determines at least one optimizing factor that is indicative of an increased likelihood of a currently available appointment opportunity of a service provider to be booked.

At 1804, the AASS determines at least one locality characteristic for an intended recipient of a stored electronic file, each of the at least one locality characteristic indicative of a respective possible geographic location of the intended recipient.

At 1806, the AASS determines at least one preferred appointment opportunity from a set of multiple currently available appointment opportunities for services from at least one service provider based at least in part on the at least one determined optimizing factor and the determined at least one locality characteristic for the intended recipient.

At 1808, the AASS provides at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

The method 1800 terminates at 1899. The method 1800 may terminate, for example, in provides at least a portion of a set of instructions. Alternatively, the method 1800 may repeat for example returning to 1802. In some embodiments, the method 1800 may be executed as a multi-threaded process, or may be executed as separate threads on one or more processors.

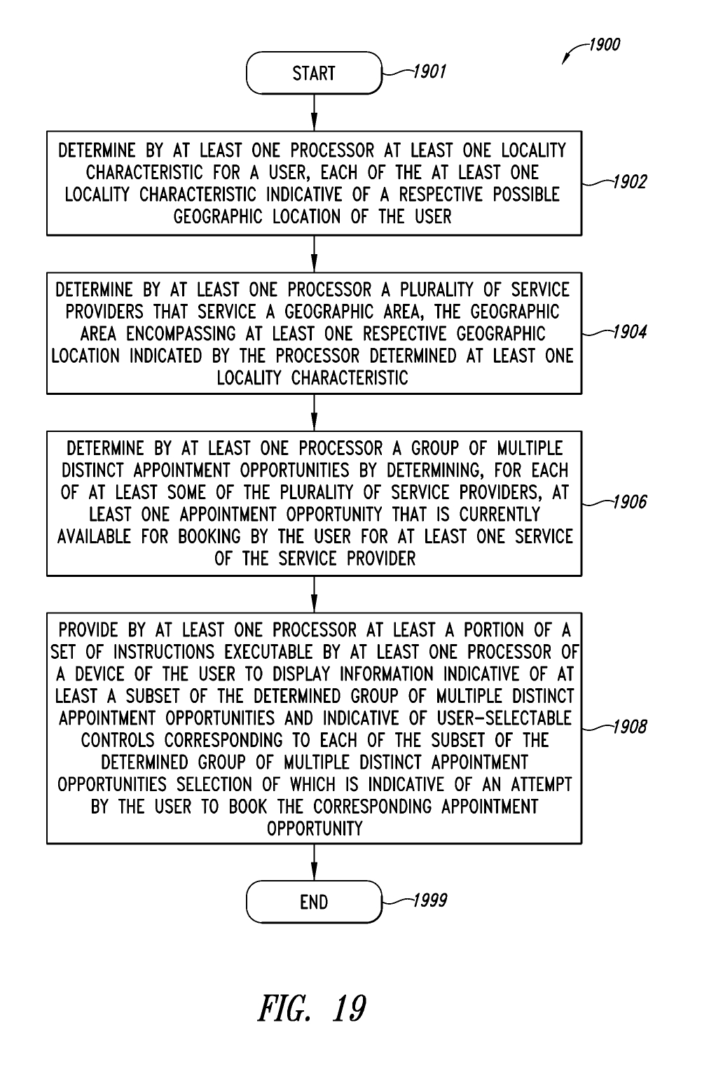

FIG. 19 shows a method 1900 of providing an appointment availability marketplace, according to one embodiment. The method 1900 may be implemented, for example, by the AASS 105 shown in FIGS. 1 and 2A-2B and 300 shown in FIG. 3.

The method 1900 starts at 1901, such as in response to a request for current appointment availability information to provide in an appointment availability marketplace.

At 1902, the AASS determines at least one locality characteristic for a user, each of the at least one locality characteristic indicative of a respective possible geographic location of the user.

At 1904, the AASS determines a plurality of service providers that service a geographic area, the geographic area encompassing at least one respective geographic location indicated by the at least one locality characteristic.

At 1902, the AASS determines a group of multiple distinct appointment opportunities by determining, for each of at least some of the plurality of service providers, at least one appointment opportunity that is currently available for booking by the user for at least one service of the service provider.

At 1902, the AASS provides at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

The method 1900 terminates at 1999. The method 1900 may terminate, for example, in provides at least a portion of a set of instructions. Alternatively, the method 1900 may repeat for example returning to 1902. In some embodiments, the method 1900 may be executed as a multi-threaded process, or may be executed as separate threads on one or more processors.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary Appointment Availability Service System generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating at least one computing system in a networked computing environment including client computing systems and server computing systems, the method comprising:
determining by at least one processor at least one locality characteristic for an intended recipient of a stored electronic file, each of the at least one locality characteristic indicative of a respective possible geographic location of the intended recipient;
determining by at least one processor at least one service provider that services a geographic area, the geographic area encompassing at least one respective geographic location indicated by the processor determined at least one locality characteristic;
determining by at least one processor at least one appointment availability that is designated as currently available for the processor determined at least one service provider; and
creating by at least one processor at least one electronic file element with appointment availability information that includes at least one appointment availability indication for the processor determined at least one service provider that is indicative of the processor determined at least one appointment availability for the processor determined at least one service provider.

2. The method of claim 1 wherein determining by at least one processor at least one appointment availability that is designated as currently available for the processor determined at least one service provider includes transmitting a query by a server computer system to a service provider computer system and receiving a response at the server computer system from the service provider computer system, where the server computer system is operated by a different entity than an entity that operates the service provider computer system.

3. The method of claim 1 wherein determining by at least one processor at least one appointment availability that is designated as currently available for the processor determined at least one service provider includes querying a database maintained by a server computer system, and further comprising:
providing appointment availability selection information to a service provider computer system, the appointment availability selection information indicative of a selection of one of the processor determined at least one appointment availability by a client or a prospective client of the service provider.

4. The method of claim 1 wherein determining by at least one processor at least one appointment availability that is designated as currently available for the processor determined at least one service provider includes determining a start date and time of the at least one appointment availability, an end date and time of the at least one appointment availability, and wherein creating by at least one processor an electronic file element with appointment availability information that includes at least one appointment availability indication for the processor determined at least one service provider that is indicative of the processor determined at least one appointment availability for the processor determined at least one service provider includes creating the electronic file element with the appointment availability information that is indicative of the start date and time and the end date and time for the respective processor determined appointment availability.

5. The method of claim 1 wherein creating by at least one processor an electronic file element with appointment availability information further comprises creating the electronic file element with the appointment availability information that is indicative of a cost associated with the processor determined appointment availability.

6. The method of claim 1 wherein creating by at least one processor an electronic file element with appointment availability information further comprises creating the electronic file element with the appointment availability information that is indicative of a particular service provided by the processor determined at least one service provider associated with the processor determined appointment availability.

7. The method of claim 1 wherein creating by at least one processor at least one electronic file element with appointment availability information includes incorporating the at least one appointment availability into a stored advertisement message file to be transmitted and displayed on an end user device.

8. The method of claim 7 wherein incorporating the at least one appointment availability into a stored advertisement message file to be transmitted and displayed on an end user device includes incorporating instructions into the stored advertisement message file that cause a processor of the end user device to display at least one user selectable book appointment control, selection of which is indicative of an attempt to book the respective appointment availability by an end user of the end user device and which instructions cause the processor of the end user device to transmit an electronic message indicative of selection of the respective user selectable book appointment control.

9. The method of claim 8 wherein incorporating instructions into the stored advertisement message file that cause a processor of the end user device to display at least one user selectable book appointment control includes incorporating instructions into the stored advertisement message file that cause the processor of the end user device to display at least one user selectable book appointment control that includes an indication of at least one of a start or an end of the appointment availability.

10. The method of claim 1 wherein determining at least one appointment availability for a service provider that is designated as currently available includes determining at least two appointment availabilities for a single one of the at least one processor determined service providers which appointment availabilities are each designated as currently available and wherein creating at least one electronic file element with appointment availability information includes creating the at least one electronic file element with appointment availability information that includes a respective appointment availability indication for each of the processor determined at least two appointment availabilities for the single one of the processor determined at least one service provider.

11. The method of claim 1 wherein determining at least one appointment availability for a service provider that is designated as currently available includes determining at least one respective appointment availability for each of at least two of the at least one processor determined service providers which appointment availabilities are each designated as currently available and wherein creating at least one electronic file element with appointment availability information includes creating the at least one electronic file element with appointment availability information that includes a respective appointment availability indication for each of the processor determined at least two service providers.

12. The method of claim 1, further comprising:
transmitting by at least one processor the processor created electronic file element to the intended recipient of the electronic file.

13. The method of claim 1, further comprising:
transmitting by at least one processor the processor created electronic file element to a third party server computer system that forwards the electronic file element and the electronic file to the intended recipient of the electronic file.

14. The method of claim 1, further comprising:
combining by at least one processor of the at least one processor created electronic file element into the electronic file; and
transmitting by at least one processor of the electronic file resulting from the combining to the intended recipient of the electronic file.

15. The method of claim 1 wherein the stored electronic file is a Web page source file, and wherein creating by at least one processor at least one electronic file element with appointment availability information includes creating the at least one electronic file element with instructions to cause the at least one appointment availability indication to be displayed in a window associated with a browser program executed by a processor of an end user device.

16. The method of claim 1 wherein determining by at least one processor at least one locality characteristic for an intended recipient of a stored electronic file includes determining at least one of a geographic location associated with a number of previous requests by the intended recipient, a geographic location associated with an IP address of the intended recipient, a geographic location specified by the intended recipient, a geographic location indicated by a device of the intended recipient, and a geographic location associated with a geographic location served by an electronic content publisher that provides the stored electronic file.

17. The method of claim 1 wherein creating by at least one processor at least one electronic file element with appointment availability information includes creating the at least one electronic file element with instructions to cause the at least one appointment availability indication to be displayed in an electronic calendar of the intended recipient of the electronic file, and incorporating instructions into the file element that cause the electronic calendar to display at least one user selectable book appointment control selection of which is indicative of an attempt to book the respective appointment.

18. A computer-readable medium containing instructions that when executed by a computer system cause the computer system to provide appointment availability, by:
determining at least one locality characteristic for an intended recipient of a stored electronic file, each of the at least one locality characteristic indicative of a respective possible geographic location of the intended recipient;
determining at least one service provider that services a geographic area, the geographic area encompassing at least one respective geographic location indicated by the at least one locality characteristic;
determining at least one appointment availability that is designated as currently available for the at least one service provider; and
creating at least one electronic file element with appointment availability information that includes at least one appointment availability indication for the at least one service provider that is indicative of the at least one appointment availability for the at least one service provider.

19. The computer-readable medium of claim 18 wherein determining at least one appointment availability that is designated as currently available for the at least one service provider includes transmitting a query by a server computer system to a service provider computer system and receiving a response at the server computer system from the service provider computer system, where the server computer system is operated by a different entity than an entity that operates the service provider computer system.

20. The computer-readable medium of claim 18 wherein determining at least one appointment availability that is designated as currently available for the at least one service provider includes querying a database maintained by a server computer system, and wherein the instructions cause the computer system to provide appointment availability further by:
providing appointment availability selection information to a service provider computer system, the appointment availability selection information indicative of a selection of one of the at least one appointment availability by a client or a prospective client of the service provider.

21. The computer-readable medium of claim 18 wherein determining at least one appointment availability that is designated as currently available for the at least one service provider includes determining a start date and time of the at least one appointment availability, an end date and time of the at least one appointment availability, and wherein creating an electronic file element with appointment availability information that includes at least one appointment availability indication for the at least one service provider that is indicative of the at least one appointment availability for the at least one service provider includes creating the electronic file element with the appointment availability information that is indicative of the start date and time and the end date and time for the respective appointment availability.

22. The computer-readable medium of claim 18 wherein the computer-readable medium is a memory of a computer system.

23. A computer system, comprising:
at least one processor; and
at least one computer-readable storage memory communicatively coupled to the at least one processor, the at least one computer-readable storage memory storing processor executable instructions that cause the at least one processor to:
determine at least one locality characteristic for an intended recipient of a stored electronic file, each of the at least one locality characteristic indicative of a respective possible geographic location of the intended recipient;
determine at least one service provider that services a geographic area, the geographic area encompassing at least one respective geographic location indicated by the at least one locality characteristic;
determine multiple appointment availabilities that are designated as currently available for the at least one service provider; and
create at least one electronic file element with appointment availability information that includes at least one appointment availability indication for the at least one service provider that is indicative of at least one of the multiple appointment availabilities for the at least one service provider.

24. The computer system of claim 23 wherein the instructions further cause the at least one processor to create at least one electronic file element with appointment availability information by incorporating the at least one of the multiple appointment availabilities into a stored advertisement message file to be transmitted and displayed on an end user device.

25. The computer system of claim 24 wherein the instructions further cause the at least one processor to, when incorporating the at least one of the multiple appointment availabilities into a stored advertisement message file to be transmitted and displayed on an end user device, incorporate instructions into the stored advertisement message file that cause a processor of the end user device to display at least one user selectable book appointment control, selection of which is indicative of an attempt to book the respective at least one of the multiple appointment availabilities by an end user of the end user device and which instructions cause the processor of the end user device to transmit an electronic message indicative of selection of the respective user selectable book appointment control.

26. The computer system of claim 23 wherein the instructions further cause the at least one processor to transmit the electronic file element to the intended recipient of the electronic file.

27. The computer system of claim 23 wherein the instructions further cause the at least one processor to transmit the electronic file element to a third party server computer system that forwards the electronic file element and the electronic file to the intended recipient of the electronic file.

28. The computer system of claim 23 wherein the instructions further cause the at least one processor to combine the at least one electronic file element into the electronic file, and transmit the electronic file to the intended recipient of the electronic file.

29. The computer system of claim 23 wherein the stored electronic file is a Web page source file, and wherein the instructions further cause the at least one processor to, when creating at least one electronic file element with appointment availability information, create the at least one electronic file element with instructions to cause the at least one appointment availability indication to be displayed by a browser program of an end user device.

30. A method of operating at least one computing system in a networked computing environment including client computing systems and server computing systems, the method comprising:
providing by at least one processor at least a portion of a set of processor executable instructions executable by a processor of an end user device to display a set of available appointment opportunities that have been determined to be currently available for a set of service providers that have been determined to be local to a current or prospective client of the service providers;
receiving by at least one processor at least one indication of a respective selection of at least one of the appointment opportunities from at least one of the current or prospective clients of the service providers, the selection indicative of a request by the at least one current or prospective client to book the respective appointment opportunity with the service provider; and
updating by at least one processor an electronic schedule of the service provider indicated by the selection of the request by the current or prospective client of the request by the current or prospective client to book the respective appointment opportunity, such that the respective appointment opportunity is booked for the client based on the updating by at least one processor an electronic schedule of the service provider.

31. The method of claim 30 wherein updating by at least one processor an electronic schedule of the service provider of the request by the current or prospective client to book the respective appointment opportunity includes sending an email notification to a network address logically associated with the service provider.

32. The method of claim 30 wherein updating by at least one processor an electronic schedule of the service provider of the request by the current or prospective client to book the respective appointment opportunity includes sending an email notification with a user selectable appointment acceptance control, selection of which indicates an acceptance by the service provider of the request by the current or prospective client too book the appointment opportunity.

33. The method of claim 32, further comprising:
transmitting an electronic acceptance notification by at least one processor to the current or prospective client in response to the acceptance by the service provider of the request by the current or prospective client to book the appointment opportunity.

34. The method of claim 30 wherein updating by at least one processor an electronic schedule of the service provider of the request by the current or prospective client to book the respective appointment opportunity includes updating a service provider calendar stored on a service provider computer system of the request by the current or prospective client to book the respective appointment opportunity.

35. The method of claim 30 wherein updating by at least one processor an electronic schedule of the service provider of the request by the current or prospective client to book the respective appointment opportunity includes updating a service provider calendar stored on a server computer system that stores service provider calendars for a plurality of the service providers of the request by the current or prospective client to book the respective appointment opportunity.

36. The method of claim 30, further comprising:
transmitting an electronic reminder notification to the current or prospective client in response to an approach of at least one of a date or a time of the appointment opportunity with the service provider selected by the respective current or prospective client.

37. The method of claim 30 wherein providing at least a portion of a set of processor executable instructions executable by a processor of an end user device to display a set of available appointment opportunities that have been determined to be currently available for a set of service providers that have been determined to be local to a current or prospective client of the service providers includes providing indications of at least three available appointment opportunities with at least one service provider in an advertisement configured as an HTML file executable by the processor of the end user device for display to an end user.

38. The method of claim 30 wherein providing at least a portion of a set of processor executable instructions executable by a processor of an end user device to display a set of available appointment opportunities that have been determined to be currently available for a set of service providers that have been determined to be local to a current or prospective client of the service providers includes providing indications of at least some of the available appointment opportunities with at least some of the service providers in an interactive advertisement for display by the processor of the end user device, wherein the indications include user-selectable controls corresponding to each of the at least some of the available appoint opportunities, selection of which is indicative of an attempt to book the respective appointment availability.

39. The method of claim 30 wherein providing at least a portion of a set of processor executable instructions executable by a processor of an end user device to display a set of available appointment opportunities that have been determined to be currently available for a set of service providers that have been determined to be local to a current or prospective client of the service providers includes providing the at least a portion of the set of instructions in a placement configured for display with other content in a context of a Web page, the executable instructions further including additional instructions that when executed allow an end user of the end user device to interactively book the respective appointment availability within the context of the Web page.

40. The method of claim 30 wherein providing at least a portion of a set of processor executable instructions executable by a processor of an end user device to display a set of available appointment opportunities that have been determined to be currently available for a set of service providers that have been determined to be local to a current or prospective client of the service providers includes providing the at least a portion of the set of instructions in a placement configured for display with other content in a context of a first Web page, the executable instructions further including additional instructions that when executed redirect the end user device to a second Web page that provides one or more interactions for an end user to interactively book the respective appointment availability.

41. The method of claim 30 wherein the set of available appointment opportunities that have been determined to be currently available for the set of service providers is determined based at least in part on information obtained from a plurality electronic schedules that are each maintained by a corresponding service provider of the set of service providers, and wherein updating by at least one processor an electronic schedule of the service provider indicated by the selection of the request by the current or prospective client to book the respective appointment opportunity includes updating one of the plurality of electronic schedules that is maintained by service provider indicated by the selection to indicate that the respective appointment opportunity has been booked by the current or prospective client.

42. The method of claim 41 wherein the plurality of electronic schedules is provided by an electronic network-based scheduling service that is available for the set of service providers to manage appointments.

43. A computer-readable medium containing instructions that when executed by a computer system cause the computer system to provide appointment availability, by:
providing by at least one processor at least a portion of a set of processor executable instructions executable by a processor of an end user device to display a set of available appointment opportunities that have been determined to be currently available for a set of service providers that have been determined to be local to a current or prospective client of the service providers;
receiving by at least one processor at least one indication of a respective selection of at least one of the appointment opportunities from at least one of the current or prospective clients of the service providers, the selection indicative of a request by the at least one current or prospective client for the respective appointment opportunity with the service provider; and
updating by at least one processor an electronic schedule of the service provider indicated by the selection of the request by the current or prospective client of the request by the current or prospective client for the respective appointment opportunity.

44. The computer-readable medium of claim 43, wherein updating by at least one processor an electronic schedule of the service provider of the request by the current or prospective client for the respective appointment opportunity includes sending an email notification to a network address logically associated with the service provider.

45. The computer-readable medium of claim 43 wherein updating by at least one processor an electronic schedule of the service provider of the request by the current or prospective client for the respective appointment opportunity includes sending an email notification with a user selectable appointment acceptance control, selection of which indicates an acceptance by the service provider of the request by the current or prospective client for the appointment opportunity.

46. The computer-readable medium of claim 45, wherein the instructions cause the computer system to provide appointment availability further by:
transmitting an electronic acceptance notification by at least one processor to the current or prospective client in response to the acceptance by the service provider of the request by the current or prospective client for the appointment opportunity.

47. The computer-readable medium of claim 43 wherein updating by at least one processor an electronic schedule of the service provider of the request by the current or prospective client for the respective appointment opportunity includes updating a service provider calendar stored on a service provider computer system of the request by the current or prospective client for the respective appointment opportunity.

48. The computer-readable medium of claim 43 wherein updating by at least one processor an electronic schedule of the service provider of the request by the current or prospective client for the respective appointment opportunity includes updating a service provider calendar stored on a server computer system that stores service provider calendars for a plurality of the service providers of the request by the current or prospective client for the respective appointment opportunity.

49. The computer-readable medium of claim 43, wherein the instructions cause the computer system to provide appointment availability further by:
transmitting an electronic reminder notification to the current or prospective client in response to an approach of at least one of a date or a time of the appointment opportunity with the service provider selected by the respective current or prospective client.

50. The computer-readable medium of claim 43 wherein the set of available appointment opportunities that have been determined to be currently available for the set of service providers is determined based at least in part on information obtained from a plurality electronic schedules that are each maintained by a corresponding service provider of the set of service providers, and wherein updating by at least one processor an electronic schedule of the service provider indicated by the selection of the request by the current or prospective client for the respective appointment opportunity includes updating one of the plurality of electronic schedules that is maintained by service provider indicated by the selection to indicate that the respective appointment opportunity has been booked by the current or prospective client.

51. The computer-readable medium of claim 43 wherein the computer-readable medium is a memory of a computer system.

52. A computer system, comprising:
at least one processor; and
at least one computer-readable storage memory communicatively coupled to the at least one processor, the at least one computer-readable storage memory storing processor executable instructions that cause the at least one processor to:
provide at least a portion of a set of processor executable instructions executable by a processor of an end user device to display a set of available appointment opportunities that have been determined to be currently available for a set of service providers that have been determined to be local to a current or prospective client of the service providers;
receive at least one indication of a respective selection of at least one of the appointment opportunities from at least one of the current or prospective clients of the service providers, the selection indicative of a request by the at least one current or prospective client to book the respective appointment opportunity with the service provider; and
updating the service provider indicated by the selection of the request by the current or prospective client of the request by the current or prospective client to book the respective appointment opportunity.

53. The computer system of claim 52 wherein the instructions further cause the at least one processor to, when the module provides at least a portion of a set of processor executable instructions executable by a processor of an end user device to display a set of available appointment opportunities that have been determined to be currently available for a set of service providers that have been determined to be local to a current or prospective client of the service providers, provide indications of at least three available appointment opportunities with at least one service provider in an advertisement configured as an HTML file executable by the processor of the end user device for display to an end user.

54. A method of operating at least one computing system in a networked computing environment including client computing systems and server computing systems, the method comprising:
determining at least one optimizing factor that is indicative of an increased likelihood of a currently available appointment opportunity of a service provider to be booked;
determining by at least one processor at least one locality characteristic for an intended recipient of a stored electronic file, each of the at least one locality characteristic indicative of a respective possible geographic location of the intended recipient;
determining by at least one processor at least one preferred appointment opportunity from a set of multiple currently available appointment opportunities for services from at least one service provider based at least in part on the at least one determined optimizing factor and the determined at least one locality characteristic for the intended recipient; and
providing by at least one processor at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

55. The method of claim 54 wherein the determined at least one optimizing factor is indicative of an increased likelihood for a currently available appointment opportunity of a service provider to be booked if an appointment opportunity that is offered for booking is available at one or more corresponding times, and wherein determining at least one preferred appointment opportunity further includes determining the at least one preferred appointment opportunity is currently available at the one or more corresponding times.

56. The method of claim 55 wherein the one or more corresponding times includes at least one of a start time for the appointment opportunity, an end time for the appointment opportunity, and a duration of the appointment opportunity.

57. The method of claim 55 wherein the one or more corresponding times includes at least one of a corresponding time of the day, a corresponding day of the week, and a corresponding month of the year.

58. The method of claim 55 wherein the determined at least one optimizing factor is indicative of an increased likelihood for a currently available appointment opportunity of a service provider to be booked if an appointment opportunity that is offered for booking includes an amount of time between the one or more corresponding times and a time at which providing by at least one processor at least a portion of a set of instructions executable by a device of the intended recipient to cause the device to display information and selectable controls to the intended recipient occurs.

59. The method of claim 58 wherein the amount of time is based on an amount of advanced notice.

60. The method of claim 54 wherein the determined at least one optimizing factor is indicative of an increased likelihood of a currently available appointment opportunity of a service provider to be booked if an appointment opportunity that is offered for booking is available for one or more corresponding prices, and wherein determining at least one preferred appointment opportunity further includes determining the at least one preferred appointment opportunity is available for the one or more corresponding prices.

61. The method of claim 54 wherein the determined at least one optimizing factor is indicative of an increased likelihood of a currently available appointment opportunity of a service provider to be booked if multiple appointment opportunities are simultaneously offered to the intended recipient, wherein determining at least one preferred appointment opportunity further includes determining a group of multiple preferred appointment opportunities from the set of multiple currently available appointment opportunities, and wherein the at least a portion of the set of instructions further includes information indicative of multiple offers for the intended recipient to book at least some of the determined group of multiple preferred appointment opportunities.

62. The method of claim 61 wherein the determined multiple preferred appointment opportunities include at least one of multiple currently available appointment opportunities for the same service provided by a single service provider that are available at different times, multiple currently available appointment opportunities for at least some different services provided by a single service provider, and multiple currently available appointment opportunities for services from multiple different service providers.

63. The method of claim 61 wherein the multiple, further comprising:
determining a preferred number corresponding to how many appointment opportunities to simultaneously offer based on the optimizing factor, wherein the group of multiple preferred appointment opportunities includes a total number of appointment opportunities that is at least equivalent to the determined preferred number, and wherein the information indicative of multiple offers is information indicative of a number of offers that is equivalent to the determined preferred number.

64. The method of claim 54 wherein the at least one optimizing factor is determined based at least in part on information provided from a publisher of electronic content, the information provided from the publisher including information indicative of at least one of a type of content provided by the publisher, a user profile of users of the publisher, and a geographical location served by the publisher, and wherein determining at least one preferred appointment opportunity further includes determining the at least one preferred appointment opportunity based at least in part on the information provided by the publisher, and wherein the intended recipient is a user of the publisher of electronic content.

65. The method of claim 54, further comprising:
determining the information indicative of the offer for the intended recipient to book the determined at least one preferred appointment opportunity based at least in part on the at least one determined optimizing factor.

66. The method of claim 65 wherein the information includes instructions to cause the device to display one or more graphical indications of details related to the offer for the intended recipient to book the determined at least one preferred appointment opportunity, and wherein determining the information indicative of the offer for the intended recipient to book the determined at least one preferred appointment opportunity based at least in part on the at least one determined optimizing factor, further includes determining the one or more graphical indications of details based at least in part on the at least one determined optimizing factor.

67. The method of claim 65 wherein determining the information indicative of the offer for the intended recipient to book the determined at least one preferred appointment opportunity based at least in part on the at least one determined optimizing factor further includes determining whether or not to include information related to the price of the at least one preferred appointment opportunity.

68. The method of claim 54 wherein the at least one optimizing factor is determined based at least in part on historical data accumulated from previously providing at least a portion of a set of instructions including information indicative of offers for intended recipients to book appointment opportunities.

69. The method of claim 54 wherein the at least one optimizing factor is determined based at least in part on one of multi-variate testing and NB testing.

70. The method of claim 54 wherein determining at least one preferred appointment opportunity further includes determining at least one appointment opportunity for a first service that was recently booked by the intended recipient and determining the at least one preferred appointment opportunity based at least in part on the at least one preferred appointment opportunity being for a second service that is different than the first service.

71. The method of claim 54 wherein providing at least a portion of a set of instructions executable by a device of the intended recipient to cause the device to display information and selectable controls to the intended recipient includes providing the at least a portion of the set of instructions for display with content provided by a publisher of electronic content.

72. The method of claim 71, further comprising:
receiving a request for the portion of the set of instructions for display with content provided by a publisher of electronic content from the publisher of electronic content, and wherein the placement is provided in response to the request.

73. The method of claim 71, further comprising:
receiving a request for the portion of the set of instructions for display with content provided by a publisher of electronic content from an advertisement serving network, and wherein the placement is provided in response to the request.

74. The method of claim 71 wherein providing the at least a portion of the set of instructions includes providing the at least a portion of the set of instructions as at least part of an electronic advertisement.

75. The method of claim 54 wherein the set of multiple currently available appointment opportunities for services from at least one service provider is provided by an online scheduling service that is available for the at least one service provider to manage appointments, and wherein the set of multiple currently available appointment opportunities are determined based at least in part on availability parameters set by the at least one service provider.

76. A computer-readable medium containing instructions that when executed by a computer system cause the computer system to provide appointment availability, by:
determining at least one optimizing factor that is indicative of an increased likelihood of a currently available appointment opportunity of a service provider to be booked;
determining by at least one processor at least one locality characteristic for an intended recipient of a stored electronic file, each of the at least one locality characteristic indicative of a respective possible geographic location of the intended recipient;
determining by at least one processor at least one preferred appointment opportunity from a set of multiple currently available appointment opportunities for services from at least one service provider based at least in part on the at least one determined optimizing factor and the determined at least one locality characteristic for the intended recipient; and
providing by at least one processor at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

77. The computer-readable medium of claim 76 wherein the determined at least one optimizing factor is indicative of an increased likelihood for a currently available appointment opportunity of a service provider to be booked if an appointment opportunity that is offered for booking is available at one or more corresponding times, and wherein determining at least one preferred appointment opportunity further includes determining the at least one preferred appointment opportunity is currently available at the one or more corresponding times.

78. The computer-readable medium of claim 77 wherein the one or more corresponding times includes at least one of a start time for the appointment opportunity, an end time for the appointment opportunity, and a duration of the appointment opportunity.

79. The computer-readable medium of claim 55 wherein the determined at least one optimizing factor is indicative of an increased likelihood for a currently available appointment opportunity of a service provider to be booked if an appointment opportunity that is offered for booking includes a particular amount of time between the one or more corresponding times and a time at which providing by at least one processor at least a portion of a set of instructions executable by a device of the intended recipient to cause the device to display information and selectable controls to the intended recipient occurs.

80. The computer-readable medium of claim 76 wherein the determined at least one optimizing factor is indicative of an increased likelihood of a currently available appointment opportunity of a service provider to be booked if an appointment opportunity that is offered for booking is available for one or more corresponding prices, and wherein determining at least one preferred appointment opportunity further includes determining the at least one preferred appointment opportunity is available for the one or more corresponding prices.

81. The computer-readable medium of claim 76 wherein the determined at least one optimizing factor is indicative of an increased likelihood of a currently available appointment opportunity of a service provider to be booked if multiple appointment opportunities are simultaneously offered to the intended recipient, wherein determining at least one preferred appointment opportunity further includes determining multiple preferred appointment opportunities from the set of multiple currently available appointment opportunities for services from at least one service provider, and wherein the at least a portion of the set of instructions further includes information indicative of multiple offers for the intended recipient to book at least some of the determined multiple preferred appointment opportunities.

82. The computer-readable medium of claim 81 wherein the determined multiple preferred appointment opportunities include at least one of multiple currently available appointment opportunities for the same service provided by a single service provider that are available at different times, multiple currently available appointment opportunities for at least some different services provided by a single service provider, and multiple currently available appointment opportunities for services from multiple different service providers.

83. The computer-readable medium of claim 76 wherein the at least one optimizing factor is determined based at least in part on information provided from a publisher of electronic content, the information provided from the publisher including information indicative of at least one of a type of content provided by the publisher, a user profile of users of the publisher, and a geographical location served by the publisher, and wherein determining at least one preferred appointment opportunity further includes determining the at least one preferred appointment opportunity based at least in part on the information provided by the publisher, and wherein the intended recipient is a user of the publisher of electronic content.

84. The computer-readable medium of claim 76, wherein the instructions cause the computer system to provide appointment availability further by:
determining the information indicative of the offer for the intended recipient to book the determined at least one preferred appointment opportunity based at least in part on the at least one determined optimizing factor.

85. The computer-readable medium of claim 84 wherein the information includes instructions to cause the device to display one or more graphical indications of details related to the offer for the intended recipient to book the determined at least one preferred appointment opportunity, and wherein determining the information indicative of the offer for the intended recipient to book the determined at least one preferred appointment opportunity based at least in part on the at least one determined optimizing factor, further includes determining the one or more graphical indications of details based at least in part on the at least one determined optimizing factor.

86. The computer-readable medium of claim 76 wherein the at least one optimizing factor is determined based at least in part on historical data accumulated from previously providing at least a portion of a set of instructions including information indicative of offers for intended recipients to book appointment opportunities.

87. The computer-readable medium of claim 76 wherein the at least one optimizing factor is determined based at least in part on one of multi-variate testing and A/B testing.

88. The computer-readable medium of claim 76 wherein determining at least one preferred appointment opportunity further includes determining at least one appointment opportunity for a first service that was recently booked by the intended recipient and determining the at least one preferred appointment opportunity based at least in part on the at least one preferred appointment opportunity being for a second service that is different than the first service.

89. The computer-readable medium of claim 76 wherein the set of multiple currently available appointment opportunities for services from at least one service provider is provided by an online scheduling service that is available for the at least one service provider to manage appointments, and wherein the set of multiple currently available appointment opportunities are determined based at least in part on availability parameters set by the at least one service provider and based at least in part on each of the multiple currently available appointment opportunities not being currently booked by a client of the service provider.

90. The computer-readable medium of claim 76 wherein the computer-readable medium is a memory of a computer system.

91. A computer system, comprising:
at least one processor; and
at least one computer-readable storage memory communicatively coupled to the at least one processor, the at least one computer-readable storage memory storing processor executable instructions that cause the at least one processor to:
determine at least one optimizing factor that is indicative of an increased likelihood of a currently available appointment opportunity of a service provider to be booked;
determine at least one locality characteristic for an intended recipient of a stored electronic file, each of the at least one locality characteristic indicative of a respective possible geographic location of the intended recipient;
determine at least one preferred appointment opportunity from a set of multiple currently available appointment opportunities for services from at least one service provider based at least in part on the at least one determined optimizing factor and the determined at least one locality characteristic for the intended recipient; and
provide at least a portion of a set of instructions executable by a device of the intended recipient to cause the device to display information and selectable controls to the intended recipient, the at least a portion of the set of instructions including information indicative of an offer for the intended recipient to book the determined at least one preferred appointment opportunity.

92. The computer system of claim 91 wherein the instructions further cause the at least one processor to, when providing at least a portion of a set of instructions executable by a device of the intended recipient to cause the device to display information and selectable controls to the intended recipient, provide the at least a portion of the set of instructions in a placement configured for display with content provided by a publisher of electronic content.

93. The computer system of claim 92 wherein the instructions further cause the at least one processor to:
receive a request for the placement configured for display with content provided by the publisher of electronic content from the publisher of electronic content, and wherein the placement is provided in response to the request.

94. The computer system of claim 92 wherein the instructions further cause the at least one processor to:
receive a request for the placement configured for display with content provided by a publisher of electronic content from an advertisement serving network, and wherein the placement is provided in response to the request.

95. The computer system of claim 92 wherein the instructions further cause the at least one processor to, when providing the at least a portion of the set of instructions in a placement, provide the at least a portion of the set of instructions as an electronic advertisement.

96. A method of operating at least one computing system in a networked computing environment including client computing systems and server computing systems, the method comprising:
determining by at least one processor at least one locality characteristic for a user, each of the at least one locality characteristic indicative of a respective possible geographic location of the user;
determining by at least one processor a plurality of service providers that service a geographic area, the geographic area encompassing at least one respective geographic location indicated by the processor determined at least one locality characteristic;
determining by at least one processor a group of multiple distinct appointment opportunities by determining, for each of at least some of the plurality of service providers, at least one appointment opportunity that is currently available for booking by the user for at least one service of the service provider; and
providing by at least one processor at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

97. The method of claim 96 wherein the at least the portion of the set of instructions executable by a processor of a device of the user include, for each of the subset of the determined group of multiple distinct appointment opportunities, an indication of the at least one service provider, an indication of the at least one service, and an indication of at least one time that the appointment opportunity that is currently available for booking is to occur.

98. The method of claim 97 wherein the at least one time that the appointment opportunity that is currently available for booking is to occur includes at least one of a start time for the appointment opportunity, an end time for the appointment opportunity, and a duration for the appointment opportunity.

99. The method of claim 97 wherein determining by at least one processor the group of multiple distinct appointment opportunities by determining, for each of at least some of the plurality of service providers, at least one appointment opportunity that is currently available for booking by the user for at least one service of the service provider further includes determining the at least one time that the appointment opportunity that is currently available for booking is to occur.

100. The method of claim 96 wherein determining by at least one processor a group of multiple distinct appointment opportunities further includes determining the group of multiple distinct appointment opportunities based at least in part on a type of the at least one service corresponding to each of the multiple distinct appointment opportunities in the group.

101. The method of claim 100 wherein the determining the group of multiple distinct appointment opportunities based at least in part on a type of the at least one service corresponding to each of the multiple distinct appointment opportunities in the group includes determining a group of multiple distinct appoint opportunities for services of a similar type.

102. The method of claim 96 wherein determining by at least one processor a plurality of service providers that service a geographic area further includes determining the plurality of service providers based at least in part on a type of one or more services offered by each of the service providers.

103. The method of claim 96 wherein the method is provided as part of an electronic marketplace for services of local service providers, and wherein the at least the portion of the set of instructions executable by a processor of a device of the user further includes instructions to display information indicative of multiple of the subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity, such that the multiple of the subset of the determined group of multiple distinct appointment opportunities is available for viewing and selection by the user interacting with the electronic marketplace.

104. The method of claim 96 wherein providing by at least one processor at least a portion of a set of instructions executable by a processor of a device of the user further includes providing the at least a portion of the set of instructions directly to the device of the user based on a request received from the device of the user.

105. The method of claim 96 wherein providing by at least one processor at least a portion of a set of instructions executable by a processor of a device of the user further includes providing the at least a portion of the set of instructions to a computing system of a third party that provides the portion of the set of instructions to the device of the user.

106. The method of claim 96 wherein determining by at least one processor the group of multiple distinct appointment opportunities by determining, for each of at least some of the plurality of service providers, at least one appointment opportunity that is currently available for booking by the user for at least one service of the service provider further includes determining the group of distinct appointment opportunities based at least in part on availability parameters set by the plurality of service providers.

107. The method of claim 96 wherein the plurality of service providers are users of an electronic scheduling service that is available for local service providers to manage appointments, and wherein determining by at least one processor the group of multiple distinct appointment opportunities by determining, for each of at least some of the plurality of service providers, at least one appointment opportunity that is currently available for booking by the user for at least one service of the service provider, is based at least in part on availability information for the group of multiple distinct appoint opportunities obtained from the electronic scheduling service.

108. The method of claim 96, further comprising:
determining at least one optimizing factor that is indicative of an increased likelihood for the user to book an appointment opportunity from a service provider.

109. The method of claim 108 wherein determining by at least one processor a plurality of service providers that service the geographic area includes determining the service providers based at least in part on the determined at least one optimizing factor.

110. The method of claim 108 wherein determining by at least one processor a group of multiple distinct appointment opportunities by determining, for each of at least some of the determined multiple service providers, at least one appointment opportunity that is currently available for booking by the user for at least one service of the service provider, includes determining the group of multiple distinct appointment opportunities based at least in part on the determined at least one optimizing factor.

111. A computer-readable medium containing instructions that when executed by a computer system cause the computer system to provide appointment availability, by:
determining by at least one processor at least one locality characteristic for a user, each of the at least one locality characteristic indicative of a respective possible geographic location of the user;
determining by at least one processor a plurality of service providers that service a geographic area, the geographic area encompassing at least one respective geographic location indicated by the processor determined at least one locality characteristic;
determining by at least one processor a group of multiple distinct appointment opportunities by determining, for each of at least some of the plurality of service providers, at least one appointment opportunity that is currently available for booking by the user for at least one service of the service provider; and
providing by at least one processor at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

112. The computer-readable medium of claim 111 wherein the at least the portion of the set of instructions executable by a processor of a device of the user include, for each of the subset of the determined group of multiple distinct appointment opportunities, an indication of the at least one service provider, an indication of the at least one service, and an indication of at least one time that the appointment opportunity that is currently available for booking is to occur.

113. The computer-readable medium of claim 112 wherein the at least one time that the appointment opportunity that is currently available for booking is to occur includes at least one of a start time for the appointment opportunity, an end time for the appointment opportunity, and a duration for the appointment opportunity.

114. The computer-readable medium of claim 112 wherein determining by at least one processor the group of multiple distinct appointment opportunities by determining, for each of at least some of the plurality of service providers, at least one appointment opportunity that is currently available for booking by the user for at least one service of the service provider further includes determining the at least one time that the appointment opportunity that is currently available for booking is to occur.

115. The computer-readable medium of claim 111 wherein the method is provided as part of an electronic marketplace for services of local service providers, and wherein the at least the portion of the set of instructions executable by a processor of a device of the user further includes instructions to display information indicative of multiple of the subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity,
such that the multiple of the subset of the determined group of multiple distinct appointment opportunities is available for viewing and selection by the user interacting with the electronic marketplace.

116. The computer-readable medium of claim 111 wherein providing by at least one processor at least a portion of a set of instructions executable by a processor of a device of the user further includes providing the at least a portion of the set of instructions directly to the device of the user based on a request received from the device of the user.

117. The computer-readable medium of claim 111 wherein providing by at least one processor at least a portion of a set of instructions executable by a processor of a device of the user further includes providing the at least a portion of the set of instructions to a computing system of a third party that provides the portion of the set of instructions to the device of the user.

118. The computer-readable medium of claim 111 wherein determining by at least one processor the group of multiple distinct appointment opportunities by determining, for each of at least some of the plurality of service providers, at least one appointment opportunity that is currently available for booking by the user for at least one service of the service provider further includes determining the group of distinct appointment opportunities based at least in part on availability parameters set by the plurality of service providers.

119. The computer-readable medium of claim 111 wherein the plurality of service providers are users of an electronic scheduling service that is available for local service providers to manage appointments, and wherein determining by at least one processor the group of multiple distinct appointment opportunities by determining, for each of at least some of the plurality of service providers, at least one appointment opportunity that is currently available for booking by the user for at least one service of the service provider, is based at least in part on availability information for the group of multiple distinct appoint opportunities obtained from the electronic scheduling service.

120. A computer system, comprising:
at least one processor; and
at least one computer-readable storage memory communicatively coupled to the at least one processor, the at least one computer-readable storage memory storing processor executable instructions that cause the at least one processor to:
determine at least one locality characteristic for a user, each of the at least one locality characteristic indicative of a respective possible geographic location of the user;
determine a plurality of service providers that service a geographic area, the geographic area encompassing at least one respective geographic location indicated by the processor determined at least one locality characteristic;
determine a group of multiple distinct appointment opportunities by determining, for each of at least some of the plurality of service providers, at least one appointment opportunity that is currently available for booking by the user for at least one service of the service provider; and
provide at least a portion of a set of instructions executable by at least one processor of a device of the user to display information indicative of at least a subset of the determined group of multiple distinct appointment opportunities and indicative of user-selectable controls corresponding to each of the subset of the determined group of multiple distinct appointment opportunities selection of which is indicative of an attempt by the user to book the corresponding appointment opportunity.

121. The computer system of claim 120 wherein the plurality of service providers are users of an electronic scheduling service that is available for local service providers to manage appointments, and wherein the instructions further cause the at least one processor to, when determining the group of multiple distinct appointment opportunities by determining, determine the group of multiple distinct appointment opportunities based at least in part on availability information for the group of multiple distinct appoint opportunities obtained from the electronic scheduling service.

122. The computer system of claim 120 wherein the instructions further cause the at least one processor to:
determine at least one optimizing factor that is indicative of an increased likelihood for the user to book an appointment opportunity from a service provider.

123. The computer system of claim 122 wherein the instructions further cause the at least one processor to, when determining a plurality of service providers that service the geographic area, determine the service providers based at least in part on the determined at least one optimizing factor.

124. The computer system of claim 122 wherein the instructions further cause the at least one processor to, when determining a group of multiple distinct appointment opportunities, determine the group of multiple distinct appointment opportunities based at least in part on the determined at least one optimizing factor.
